(19) United States
(12) Patent Application Publication
(10) Pub. No.: US 2013/0156277 A1
(43) Pub. Date: Jun. 20, 2013

(54) INFORMATION PROCESSING APPARATUS, INFORMATION PROCESSING METHOD AND PROGRAM

(71) Applicant: SONY CORPORATION, Tokyo (JP)

(72) Inventor: Natsuko Sasaki, Tokyo (JP)

(73) Assignee: SONY CORPORATION, Tokyo (JP)

(21) Appl. No.: 13/707,054

(22) Filed: Dec. 6, 2012

(30) Foreign Application Priority Data
Dec. 16, 2011 (JP) 2011-275269

(51) Int. Cl. G06K 9/00

(52) U.S. Cl. CPC G06K 9/00302; G06K 9/00885
USPC 382/118; 382/115

(57) ABSTRACT

Disclosed herein is an information processing apparatus, including: an acquisition section configured to acquire personal identification information for identifying a person relating to first image information and image evaluation information produced by evaluating the first image information in accordance with an image of a main imaging object detected based on the first image information; and a setting section configured to set an evaluation condition for evaluating second image information based on the personal identification information and the image evaluation information.

### BACKGROUND

The present technology relates to an information processing apparatus, an information processing method and a program, and particularly to an information processing apparatus and so forth wherein an evaluation condition for a smile or the like is set.

A digital camera wherein a facial expression of a person is detected to determine whether or not an image of the person should be recorded is known and disclosed, for example, in Japanese Patent Laid-Open No. 2010-178259. In the digital still camera of the patent document, recording of an image of a facial expression of a person of an imaging object which is not favorable to an imaging person is prevented. In particular, in the digital still camera mentioned, such a condition that ‘image recording is permitted with regard to a person A if one of the “degree of smile of 10%,” “delight,” “anger,” “surprise” and “wink” except “sadness” is detected and besides the line of sight is directed to the camera’ is inputted in advance. Then, only when the condition is satisfied, imaging is carried out.

### SUMMARY

In the digital camera disclosed in the patent document mentioned hereinabove, it is necessary for a user to input an imaging condition by some method. Further, in the digital camera, if an estimated value with regard to the same person varies depending upon the physical condition, makeup, hairstyle, illumination condition and so forth, then it is necessary for the user to re-input an imaging condition. Further, the digital camera cannot adapt to a difference in accuracy in facial expression recognition by a person. Also in smile recognition, there sometimes is a tendency that the smile degree is liable to exhibit a high value or liable to exhibit a low value depending upon the person. Further, in the digital camera, the imaging condition is closed in the apparatus, and cooperation with another apparatus is not taken into consideration.

Therefore, it is desirable to provide an image processing apparatus, an image processing method and a program wherein an evaluation condition for a smile and so forth is automatically optimized for each user.

According to an embodiment of the present technology, there is provided an information processing apparatus including an acquisition section configured to acquire personal identification information for identifying a person relating to first image information and image evaluation information produced by evaluating the first image information in accordance with an image of a main imaging object detected based on the first image information, and a setting section configured to set an evaluation condition for evaluating second image information based on the personal identification information and the image evaluation information.

In the information processing apparatus, the acquisition section acquires personal identification information and image evaluation information. The personal identification information is information for identifying a person relating to first image information. The image evaluation information is produced by evaluating the first image information in accordance with an image of a main imaging object detected based on the first image information. The setting section sets an evaluation condition for evaluating second image information based on the personal identification information and the image evaluation information.

The image evaluation information may be information for evaluating a facial expression of the person specified by the personal identification information. Or, the image evaluation information may be information for evaluating a composition associated with the person specified by the personal identification information. Or else, the image evaluation information may be information for evaluating an interest degree in displayed content of the person specified by the personal identification information. In this manner, in the present technology, the evaluation condition is set based on image evaluation information associated with a person. Therefore, the evaluation condition can be automatically optimized for each user.

The information processing apparatus may be configured such that the image evaluation information acquired by the acquisition section has environment information upon evaluation added thereto, and the setting section sets an evaluation condition for evaluating the second image information based on the image evaluation information produced by evaluation in a predetermined environment selected based on the environment information. In this instance, it is possible to set an evaluation condition which complies with an environment such as the brightness when the second image information is evaluated.

The information processing apparatus may be configured such that the image evaluation information is information for evaluating a facial expression of the person specified by the personal identification information when the person is viewing displayed content; the image evaluation information acquired by the acquisition section has added thereto content identification information for identifying displayed content upon evaluation; and the setting section sets an evaluation condition for evaluating the second image information based on the image evaluation information and the content identification information.

In this instance, when an evaluation condition is set based on image evaluation information, it is possible to suppress the dispersion in image evaluation information caused by a difference in displayed content, and the accuracy of the evaluation condition can be enhanced. Further, in this instance, also it is possible to selectively use only image evaluation information when particular display content is being viewed to set an evaluation condition.

The information processing apparatus may further include a conversion section configured to convert the image evaluation information acquired by the acquisition section in accordance with an evaluation engine upon the evaluation and an evaluation engine for evaluating the second image information, the setting section setting an evaluation condition for evaluating the second image information based on the image evaluation information obtained by the conversion by the conversion section. In this instance, also when the two evaluation engines are different from each other, it is possible to appropriately carry out setting of an evaluation condition. Here, the term “evaluation engine” signifies a mechanism, a function or a program for evaluating an inputted image using a predetermined image process.

The information processing apparatus may further include a conversion section configured to convert the image evaluation information acquired by the acquisition section in accordance with an environment upon the evaluation and an environment for evaluating the second image information, the setting section setting an evaluation condition for evaluating the second image information based on the image evaluation information obtained by the conversion by the conversion section. In this instance, also when the two environments are different from each other, setting of an evaluation condition can be carried out appropriately.

According to another embodiment of the present technology, there is provided an information processing apparatus including an evaluation section configured to evaluate second image information based on an evaluation condition, and a processing section configured to be controlled based on a result of the evaluation, the evaluation condition being set based on personal identification information for identifying a person relating to first image information and image evaluation information produced by evaluating the first image information in accordance with an image of a main imaging object detected based on the first image information.

In the information processing apparatus, the evaluation section evaluates second image information based on an evaluation condition. Then, the processing section is controlled based on a result of the evaluation. Here, the evaluation condition is set based on personal identification information for identifying a person relating to first image information and image evaluation information produced by evaluating the first image information in accordance with an image of a main imaging object detected based on the first image information.

The information processing apparatus may be configured such that the processing section is an imaging section; the second image information is obtained by the imaging section; and a shutter timing of the imaging section is controlled based on a result of the evaluation. Here, the image evaluation information may be information for evaluating a facial expression of the person specified by the personal identification information. Or, the image evaluation information may be information for evaluating a composition associated with the person specified by the personal identification information. The information processing apparatus may be configured such that the processing section is a display section; the second image information is image information of displayed content which can be displayed on the display section; and display of recommended content on the display section is controlled based on a result of the evaluation.

In this manner, in the information processing apparatus, evaluation of the second image information is carried out in accordance with an evaluation condition automatically optimized for each user, and the processing section is controlled based on a result of the evaluation. Therefore, an appropriate evaluation result can be obtained for each user, and control of the processing section is carried out appropriately.

According to a further embodiment of the present technology, there is provided an information processing apparatus including an acquisition section configured to acquire personal identification information for identifying a person relating to first sound information and sound evaluation information produced by evaluating the first sound information, and a setting section configured to set an evaluation condition for evaluating second sound information based on the personal identification information and the sound evaluation information.

In the information processing apparatus, the acquisition section acquires personal identification information and sound evaluation information. Here, the personal identification information is information for identifying a person relating to first sound information. The sound evaluation information is produced by evaluating the first sound information. Then, the setting section sets an evaluation condition for evaluating second sound information based on the personal identification information and the sound evaluation information. In this manner, in the information processing apparatus, since an evaluation condition is set based on sound evaluation information associated with a person, the evaluation condition can be automatically optimized for each user.

According to a still further embodiment of the present technology, there is provided an information processing apparatus including an evaluation section configured to evaluate second sound information based on an evaluation condition, and a processing section configured to be controlled based on a result of the evaluation, the evaluation condition being set based on personal identification information for identifying a person relating to first sound information and sound evaluation information produced by evaluating the first sound information.

In the information processing apparatus, the evaluation section evaluates second sound information based on an evaluation condition. Then, the processing section is controlled based on a result of the evaluation. Here, the evaluation condition is set based on personal identification information for identifying a person relating to first sound information and sound evaluation information produced by evaluating the first sound information.

In this manner, in the present technology, evaluation of second sound information is carried out in accordance with an evaluation condition automatically optimized for each user. Then, the processing is controlled based on a result of the evaluation. Therefore, an appropriate evaluation result can be obtained for each user, and control of the processing section is carried out appropriately.

With the information processing apparatus according to the various embodiments of the present technology, an evaluation condition such as a smile can be automatically optimized for each user.

The above and other features and advantages of the present technology will become apparent from the following description and the appended claims, taken in conjunction with the accompanying drawings in which like parts or elements denoted by like reference characters.

### BRIEF DESCRIPTION OF THE DRAWINGS

FIG. 1 is a diagram showing an example of a configuration of an information processing system according to an embodiment of the present technology;

FIG. 2 is a block diagram showing an example of a block configuration of components of the information processing system in the case where an evaluation condition is set by a decision execution apparatus;

FIG. 3 is a block diagram showing an example of a block configuration of the components of the information processing system in the case where an evaluation condition is set by a server apparatus;

FIG. 4 is a block diagram showing an example of a block configuration of the components of the information processing system in the case where an evaluation condition is set by a log information collection apparatus;

FIG. 5 is a diagram showing an example of a configuration of the information processing system in the case where the log information collection apparatus is a television receiver (TV) and the decision execution apparatus is a digital still camera (DSC);

FIG. 6 is a block diagram showing an example of a block configuration of the components of the information processing system;

FIG. 7 is a view illustrating an example of log information of the smile degree stored in an associated relationship with personal identification information in a database;

FIG. 8 is a view illustrating addition not only of date and time information but also of environment information such as indoor/outdoor distinction information and dark/bright distinction information to the smile degree;

FIG. 9 is a view illustrating addition not only of date and time information but also of content identification information representative of a type of displayed content to the smile degree;

FIG. 10 is a flow chart illustrating an example of a processing flow of the television receiver;

FIG. 11 is a flow chart illustrating an example of a processing flow of the server apparatus;

FIG. 12 is a flow chart illustrating an example of a processing flow of the digital still camera;

FIGS. 13, 14, 15 and 16 are block diagrams showing different examples of a block configuration of the information processing system;

FIG. 17 is a diagram showing an example of a configuration of the information processing system wherein the log information collection apparatus is a television receiver (TV) and the decision execution apparatus is another television receiver (TV);

FIG. 18 is a block diagram showing an example of a block configuration of components of the information processing system of FIG. 17;

FIG. 19 is a flow chart illustrating an example of a processing flow of the television receivers shown in FIG. 17;

FIG. 20 is a flow chart illustrating an example of a processing flow of a server apparatus shown in FIG. 17;

FIG. 21 is a flow chart illustrating an example of a processing flow of the television receivers shown in FIG. 17;

FIG. 22 is a diagram showing an example of a configuration of the information processing system wherein the log information collection apparatus is a personal computer (PC) and the decision execution apparatus is a digital still camera (DSC);

FIG. 23 is a block diagram showing an example of a block configuration of the components of the information processing system of FIG. 22;

FIG. 24 is a flow chart illustrating an example of a processing flow of the personal computer shown in FIG. 22;

FIG. 25 is a flow chart illustrating an example of a processing flow of a server apparatus shown in FIG. 22;

FIG. 26 is a flow chart illustrating an example of a processing flow of the digital still camera shown in FIG. 22;

FIG. 27 is a diagram showing an example of a configuration of the information processing system wherein the log information collection apparatus is a personal computer (PC) and the decision execution apparatus is a television receiver (TV);

FIG. 28 is a block diagram showing an example of a block configuration of the components of the information processing system of FIG. 27;

FIG. 29 is a flow chart illustrating an example of a processing flow of the personal computer shown in FIG. 27;

FIG. 30 is a flow chart illustrating an example of a processing flow of a server apparatus shown in FIG. 27;

FIG. 31 is a flow chart illustrating an example of a processing flow of the television receiver shown in FIG. 27;

FIG. 32 is a diagram showing an example of a configuration of the information processing system wherein the log information collection apparatus and the decision execution apparatus are the same single apparatus which is a digital still camera (DSC);

FIG. 33 is a block diagram showing an example of a block configuration of the components of the information processing system of FIG. 32;

FIG. 34 is a diagram showing an example of a configuration of the information processing system wherein the log information collection apparatus is two television receivers (TV) and the decision execution apparatus is a digital still camera (DSC);

FIG. 35 is a block diagram showing an example of a configuration of the information processing system wherein evaluation information, which may be image evaluation information and/or sound evaluation information, is converted into and used as an appropriate value based on information of an evaluation engine, environment information and so forth by the decision execution apparatus;

FIG. 36 is a diagram illustrating an example of a configuration of an evaluation information conversion section shown in FIG. 35;

FIGS. 37A and 37B are views illustrating an example of a conversion process of converting evaluation information based on image evaluation engine information;

FIGS. 38A and 38B are views illustrating an example of a conversion process of converting evaluation information based on brightness information; and

FIG. 39 is a block diagram showing an example of a configuration of the information processing system wherein the evaluation information correction section is provided on the log information collection apparatus side.

### DETAILED DESCRIPTION OF THE PREFERRED EMBODIMENT

In the following, an embodiment of the present disclosure is described with reference to the drawings. It is to be noted that the description is given in the following order.
1. Embodiment
2. Modification

### 1. Embodiment

### Information Processing System

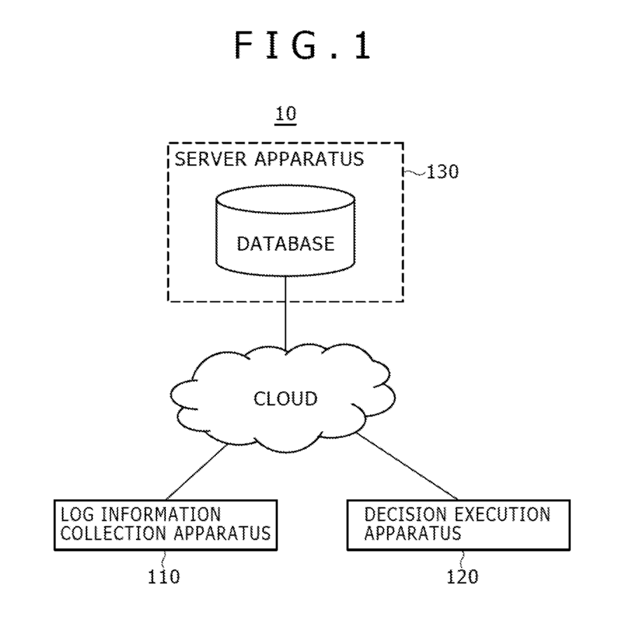

FIG. 1 shows an example of a configuration of an information processing system 10 according to an embodiment of the present technology. Referring to FIG. 1, the information processing system 10 shown includes a log information collection apparatus 110, a decision execution apparatus 120 and a server apparatus 130. The server apparatus 130 exists on a cloud, namely, on a network. The log information collection apparatus 110 and the decision execution apparatus 120 can individually communicate with the server apparatus 130 on the cloud.

The log information collection apparatus 110 collects log information. The log information is image evaluation information or sound evaluation information associated with personal identification information. The image evaluation information includes information for evaluating the expression of the face of a person specified based on the personal identification information, and information for evaluating a composition associated with the person specified based on the personal identification information. The image evaluation information further includes information for evaluating the degree of interest in displayed content of the person specified based on the personal identification information and like information.

The log information collection apparatus 110 sends the collected evaluation information as log information to the server apparatus 130 on the cloud. The server apparatus 130 stores the evaluation information sent thereto from the log information collection apparatus 110 together with the personal identification information in an associated relationship with the personal identification information into a database.

The decision execution apparatus 120 receives the log information of the evaluation information associated with predetermined personal identification information from the server apparatus 130 and analyzes the log information to set an evaluation condition. Then, the decision execution apparatus 120 uses the set evaluation condition to carry out evaluation of image information or sound information and controls processing based on a result of the evaluation.

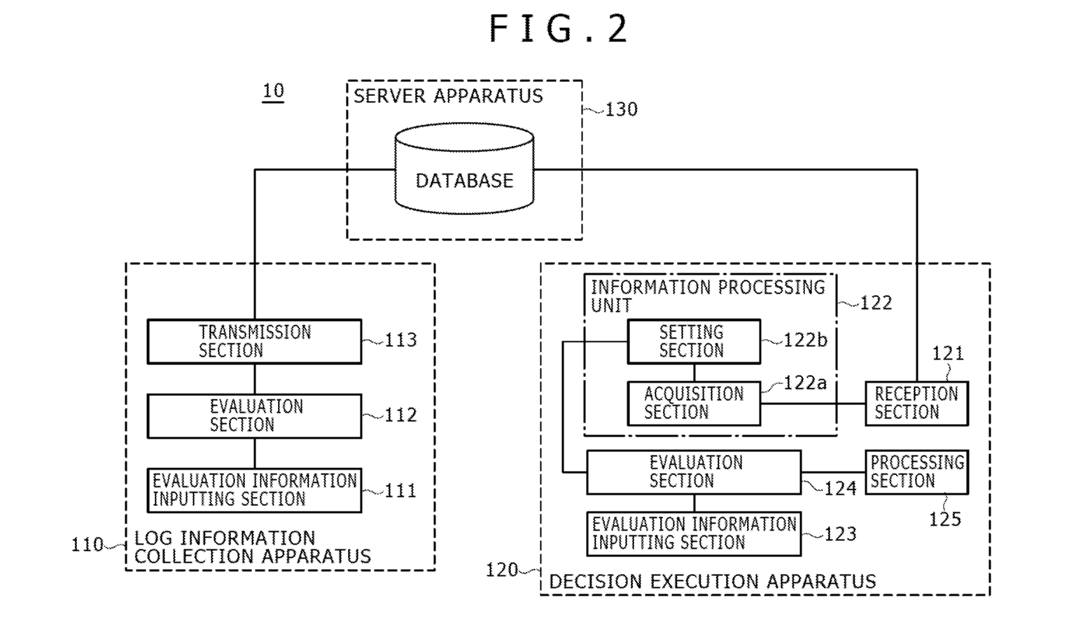

FIG. 2 shows an example of a block configuration of the components of the information processing system 10. Referring to FIG. 2, the log information collection apparatus 110 includes an evaluation information inputting section 111, an evaluation section 112, and a transmission section 113. The evaluation information inputting section 111 inputs image information or sound information which becomes an evaluation target. In the case where the evaluation target is image information, the evaluation information inputting section 111 is configured from an imaging portion, an image reproduction portion, an image inputting terminal and so forth. On the other hand, in the case where the evaluation target is sound information, the evaluation information inputting section 111 is configured from a microphone, a sound reproduction portion, a sound inputting terminal and so forth.

The evaluation section 112 evaluates image information or sound information of an evaluation target inputted thereto from the evaluation information inputting section 111 to produce image evaluation information or sound evaluation information. The production of evaluation information by the evaluation section 112 is carried out in response to an explicit operation of the user or automatically after every predetermined interval of time. The transmission section 113 sends the evaluation information produced by the evaluation section 112 as log information to the server apparatus 130 together with the personal identification information so as to be stored into the database.

The decision execution apparatus 120 includes a reception section 121, an information processing unit 122, an evaluation information inputting section 123, an evaluation section 124, and a processing section 125. The reception section 121 receives predetermined personal identification information and log information of evaluation information associated with the personal identification information from the server apparatus 130. The information processing unit 122 sets an evaluation condition based on the log information of the evaluation information received by the reception section 121.

The information processing unit 122 is configured from an acquisition section 122a and a setting section 122b. The acquisition section 122a acquires the log information of the evaluation information received by the reception section 121 and associated with the personal identification information. The setting section 122b sets an evaluation condition corresponding to a person specified from the personal identification information based on the log information acquired by the acquisition section 122a.

The evaluation information inputting section 123 inputs image information or sound information which becomes an evaluation target. If the evaluation target is image information, then the evaluation information inputting section 123 is configured from an imaging portion, an image reproduction portion, an image inputting terminal and so forth. On the other hand, if the evaluation target is sound information, then the evaluation information inputting section 123 is configured from a microphone, a sound reproduction portion, a sound inputting terminal and so forth.

The evaluation section 124 evaluates image information or sound information of an evaluation target inputted from the evaluation information inputting section 123 using an evaluation condition set by the information processing unit 122. The processing section 125 is controlled based on a result of the evaluation by the evaluation section 124. The processing section 125 is an imaging section, an image displaying section, a sound outputting section or the like.

In the foregoing description, it is described that an evaluation condition is set by the decision execution apparatus 120. However, the setting of an evaluation condition may possibly be carried out by the server apparatus 130 or the log information collection apparatus 110.

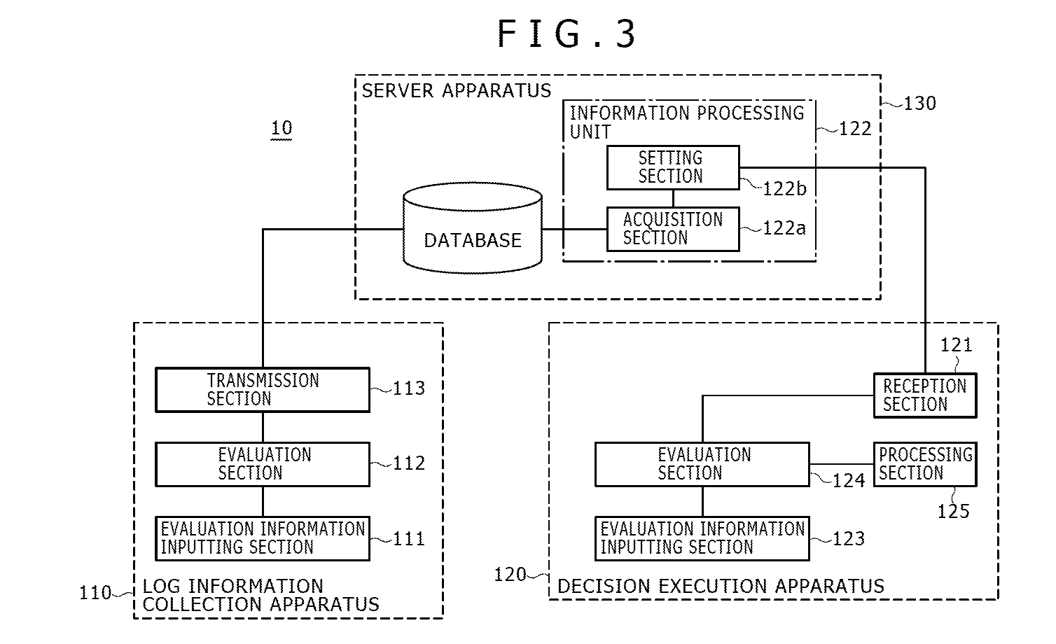

FIG. 3 shows an example of a block configuration of the components of the information processing system 10 in the case where an evaluation condition is set by the server apparatus 130.

The log information collection apparatus 110 is configured similarly to the log information collection apparatus 110 in the information processing system 10 of FIG. 2. The server apparatus 130 includes an information processing unit 122 in addition to a database. The information processing unit 122 sets an evaluation condition based on log information of evaluation information.

The information processing unit 122 is configured from an acquisition section 122a and a setting section 122b similarly to the information processing unit 122 of the decision execution apparatus 120 shown in FIG. 2. The acquisition section 122a acquires log information of evaluation information associated with predetermined personal identification information from the database. The setting section 122b sets an evaluation condition corresponding to a person specified from the personal identification information based on the log information acquired by the acquisition section 122a.

The decision execution apparatus 120 includes a reception section 121, an evaluation information inputting section 123, an evaluation section 124, and a processing section 125. The reception section 121 receives an evaluation condition set corresponding to a person specified from predetermined personal identification information set by the information processing unit 122 of the server apparatus 130.

The evaluation information inputting section 123 inputs image information or sound information which becomes an evaluation target. The evaluation section 124 evaluates the image information or the sound information of the evaluation target inputted from the evaluation information inputting section 123 using the evaluation condition received by the reception section 121. The processing section 125 is controlled based on a result of the evaluation of the evaluation section 124.

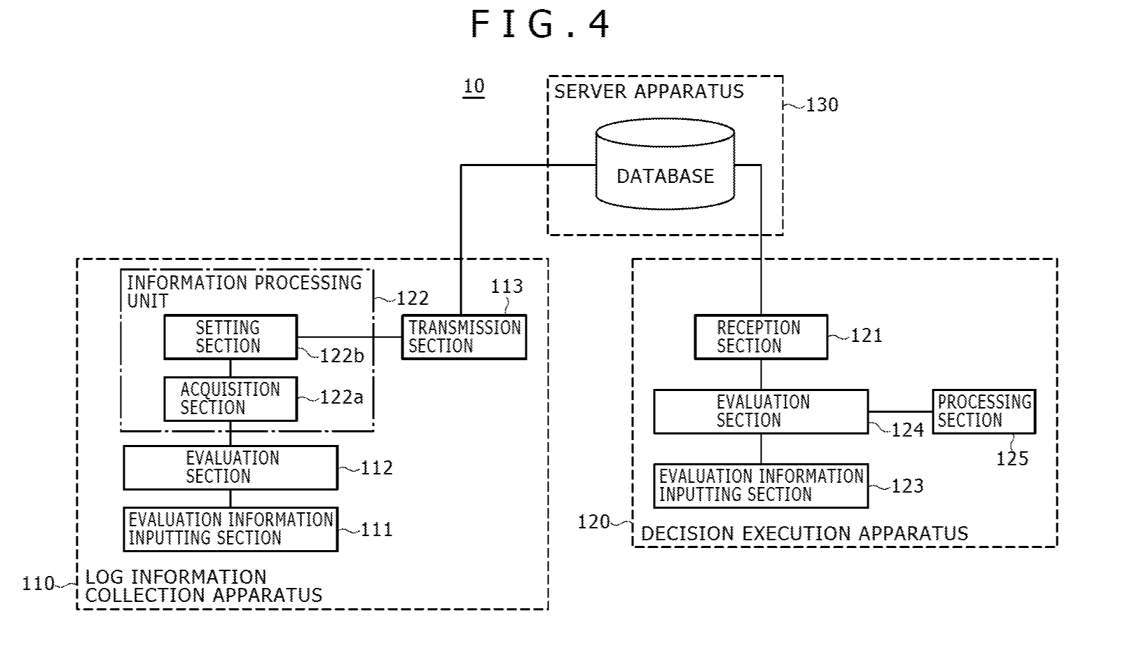

FIG. 4 shows an example of a block configuration of the components of the information processing system 10 in the case where an evaluation condition is set by the log information collection apparatus 110.

Referring to FIG. 4, the server apparatus 130 is configured similarly to the server apparatus 130 of the information processing system 10 of FIG. 2. Meanwhile, the decision execution apparatus 120 is configured similarly to the decision execution apparatus 120 of the information processing system 10 of FIG. 3. The log information collection apparatus 110 includes an evaluation information inputting section 111, an evaluation section 112, an information processing unit 122 and a transmission section 113.

The evaluation information inputting section 111 inputs image information or sound information which becomes an evaluation target. The evaluation section 112 evaluates the image information or the sound information inputted from the evaluation information inputting section 111 to produce image evaluation information or sound evaluation information. The information processing unit 122 sets an evaluation condition based on log information of the evaluation information. The information processing unit 122 is configured from an acquisition section 122a and a setting section 122b similarly to the information processing unit 122 of the decision execution apparatus 120 shown in FIG. 2 or the information processing unit 122 of the server apparatus 130 shown in FIG. 3.

The acquisition section 122a acquires log information of evaluation information associated with predetermined personal identification information from the evaluation section 112. The information processing unit 122 sets an evaluation condition corresponding to a person specified from the personal identification information based on the log information acquired by the acquisition section 122a. The transmission section 113 sends the evaluation condition set by the information processing unit 122 to the server apparatus 130 together with the personal identification information so as to be stored into the database.

### Particular Example 1 of Information Process System

### Evaluation of Expression of Face

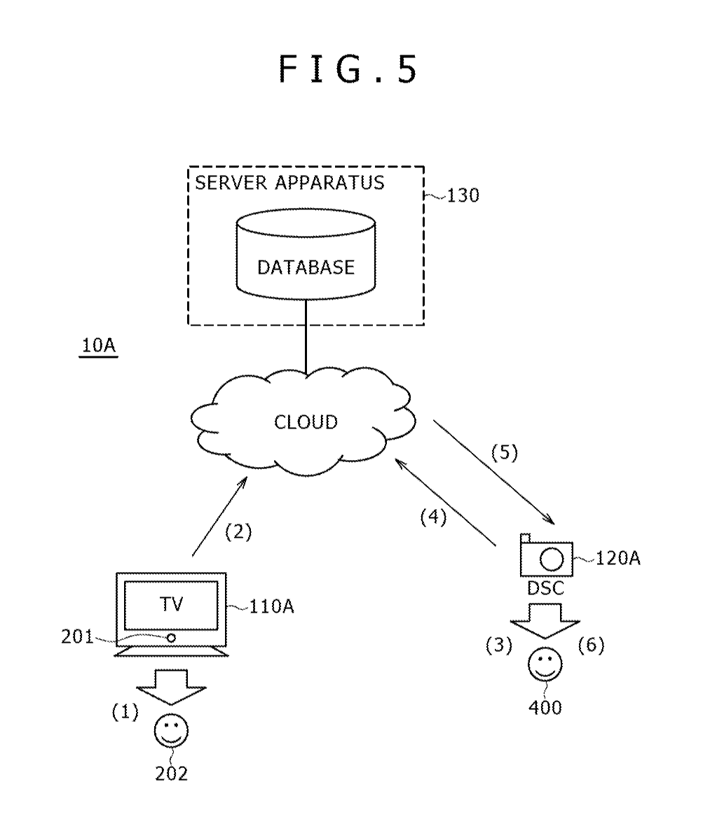

Now, a particular example 1 of the information processing system 10 is described. FIG. 5 shows an example of a configuration of an information processing system 10A wherein the log information collection apparatus is a television receiver (TV) 110A and the decision execution apparatus is a digital still camera (DSC) 120A. Further, in the information processing system 10A, the evaluation information is image information, and the image evaluation information is information of the expression of the face of a person or individual, here, information for evaluating a smile.

The information processing system 10A includes a television receiver 110A, a digital still camera 120A and a server apparatus 130. The server apparatus 130 exists on a cloud, namely, on a network. The television receiver 110A and the digital still camera 120A can individually communicate with the server apparatus 130 on the cloud.

The television receiver 110A collects log information of a degree of smile associated with personal identification information. In the television receiver 110A, (1) a camera 201 serving as an imaging section images a person 202 to obtain image information. The television receiver 110A detects a face image from the image information and carries out a personal identification process for the face image to obtain personal identification information. Further, the television receiver 110A carries out a smile recognition process for the face image to determine a degree of smile. (2) The television receiver 110A sends the degree of smile to the server apparatus 130 on the cloud together with the personal identification information. The server apparatus 130 stores the degree of smile sent thereto from the television receiver 110A into the database in an associated relationship with the personal identification information.

The digital still camera 120A (3) images a person 400 as an imaging object to obtain image information. The digital still camera 120A detects the face from the image information and carries out a personal identification process for the face image to obtain personal identification information. (4) The digital still camera 120A sends the personal identification information to the server apparatus 130 and (5) receives log information of the degree of smile stored in an associated relationship with the personal identification information from the server apparatus 130.

The digital still camera 120A analyzes the log information to set an evaluation condition, namely, a threshold value for the smile. The digital still camera 120A carries out a smile recognition process for the face image described above to obtain a degree of smile. Then, the digital still camera 120A evaluates the degree of smile obtained in this manner based on the evaluation condition. (6) The digital still camera 120A decides that the face is a smiling face when the degree of smile is higher than the threshold value, and renders the shutter operative to carry out pickup of a still image of the person 400.

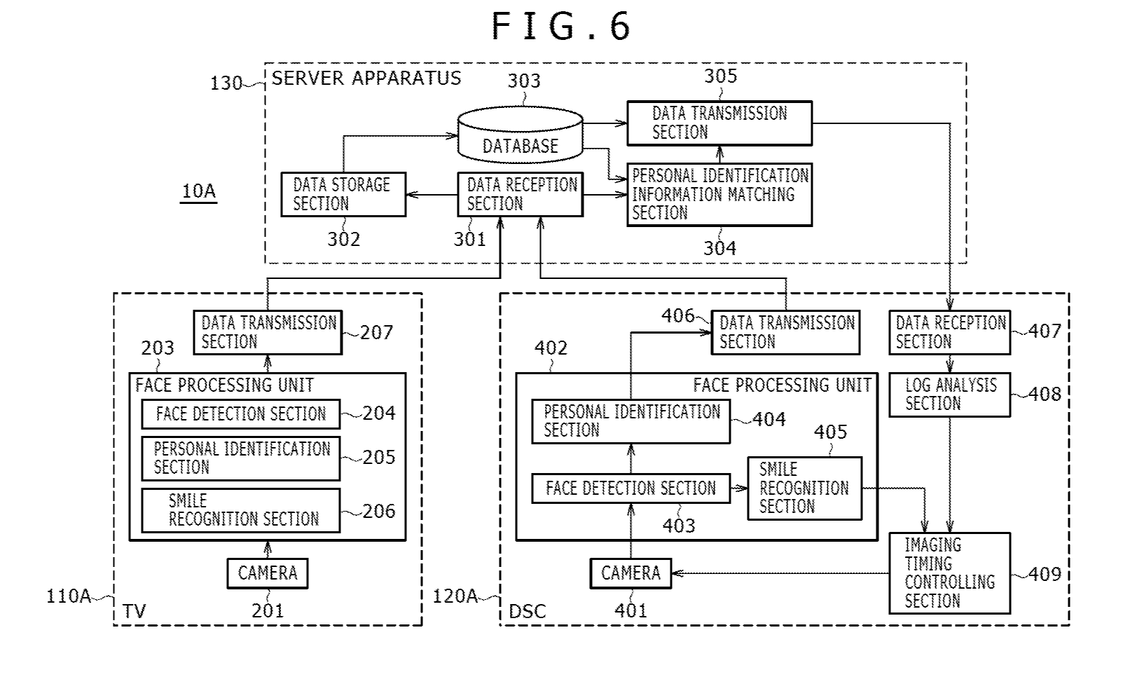

FIG. 6 shows an example of a block configuration of the components of the information processing system 10A. Referring to FIG. 6, the television receiver 110A includes a camera 201 which serves as an imaging section, a face processing unit 203, and a data transmission section 207. The camera 201 images a person 202 to obtain image information as an evaluation target as described hereinabove.

The face processing unit 203 includes a face detection section 204, a personal identification section 205 and a smile recognition section 206. The face processing unit 203 detects, by the face detection section 204 thereof, the face from image information obtained by imaging by the camera 201. This face detection can be carried out using a method which is used in a general camera. For example, an example of a face detection method is disclosed in Japanese Patent Laid-Open No. 2008-42319.

Further, in the face processing unit 203, the personal identification section 205 carries out a personal identification process for a face image to obtain personal identification information. The personal identification section 205 outputs a feature value with which a person can be identified, for example, as personal identification information. This personal identification can be carried out using a popular method as is used in the field of securities or by a function of a camera of identifying a person. For example, an example of the personal identification information is disclosed in Japanese Patent Laid-Open No. 2010-61465.

In the face processing unit 203, the smile recognition section 206 carries out a smile recognition process for the face image to obtain a degree of smile, namely, a smile score. This degree of smile is defined, for example, as a value within a range from 0 to 100. This smile recognition can be carried out by a general method which is used by a function of a camera of imaging when a smile is detected. For example, an example of the smile recognition method is disclosed in Japanese Patent Laid-Open No. 2008-42319 or No. 2008-311819.

The data transmission section 207 sends the degree of smile obtained by the smile recognition section 206 as log information to the server apparatus 130 together with the personal identification information obtained by the personal identification section 205 so as to be stored into the database. The series of processes from the imaging of the person 202 described above to the transmission of the degree of smile to the server apparatus 130 together with the personal identification information by the television receiver 110A is carried out in response to an explicit operation of the user or automatically after every predetermined interval of time.

The server apparatus 130 includes a data reception section 301, a data storage section 302, a database 303, a personal identification information matching section 304 and a data transmission section 305. The data reception section 301 receives the personal identification information and the degree of smile sent thereto from the television receiver 110A and receives the personal identification information sent thereto from the digital still camera 120A.

The data storage section 302 stores, when the data reception section 301 receives the personal identification information and the degree of smile from the television receiver 110A, the degree of smile as log information into the database 303 in an associated relationship with the personal identification information. The personal identification information matching section 304 carries out, when the data reception section 301 receives the personal identification information from the digital still camera 120A, a matching process of the personal identification information with the personal identification information stored in the database 303.

Then, the personal identification information matching section 304 carries out a matching process to detect whether or not log information of the degree of smile corresponding to the personal identification information from the digital still camera 120A exists in the database 303. When the log information of the degree of smile corresponding to the personal identification information from the digital still camera 120A exists in the database 303, the data transmission section 305 transmits the log information of the degree of smile to the digital still camera 120A together with the personal identification information.

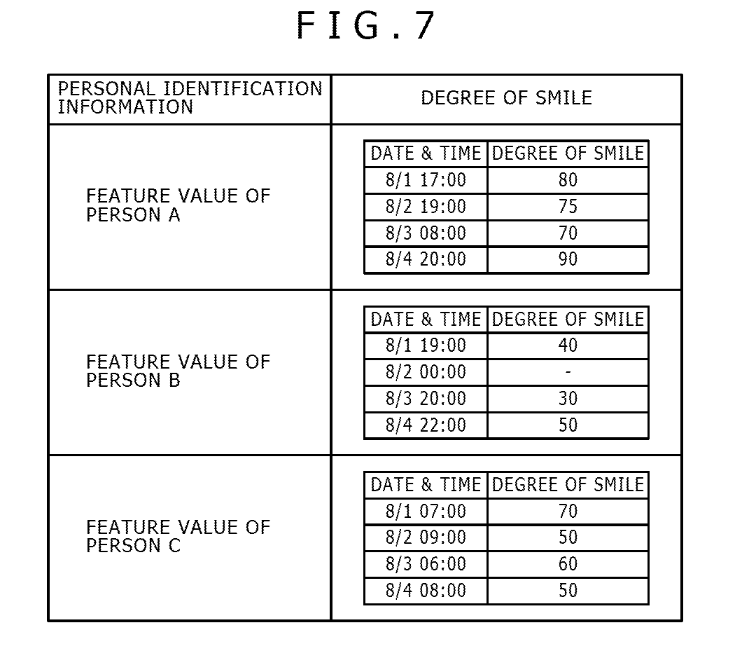

FIG. 7 illustrates an example of log information of the degree of smile stored in the database 303 in an associated relationship with personal identification information. A feature value and a degree of smile for personal identification are stored in a paired relationship with each other. In the example illustrated in FIG. 7, the degree of smile, namely, the smile score, is time series information.

For example, as regards a person A, it is stored that, on August 1, the person A views the television receiver 110A at 17 o'clock and is captured by the camera 201, and the maximum value of the degree of smile in the time zone is 80. Also it is stored that the maximum value of the degree of smile is 75 on August 2, 70 on August 3, and 90 on August 4. Here, the degrees of smile to be stored may not be maximum values but be all values or average values. Further, the number of values to be stored may not be one for one day. Similarly, log information of the degree of smile is stored also with regard to another person B and a further person C.

When the personal identification information from the digital still camera 120A is, for example, a feature value of the person A, log information of the degree of smile of the person A is searched out from the database 303 by a matching process by the personal identification information matching section 304. Then, the searched out log information of the degree of smile is transmitted to the digital still camera 120A from the data transmission section 305 together with the feature value, namely, the personal identification information, of the person A.

The digital still camera 120A includes a camera 401 serving as an imaging section, a face processing unit 402, a data transmission section 406, a data reception section 407, a log analysis section 408, and an imaging timing controlling section 409. The camera 401 images a person 400 to obtain image information as an evaluation target as described hereinabove.

The face processing unit 402 includes a face detection section 403, a personal identification section 404 and a smile recognition section 405. In the face processing unit 402, the face detection section 403 detects the face from image information obtained by imaging by the camera 401. The face detection section 403 is configured similarly to the face detection section 204 of the television receiver 110A described hereinabove and carries out face detection using a method which is used by a general camera.

Further, in the face processing unit 402, the personal identification section 404 carries out a personal identification process for the face image to obtain personal identification information. The personal identification section 404 is configured similarly to the personal identification section 205 of the television receiver 110A described hereinabove and carries out the personal identification using a popular method which is used in the field of securities or by a function of a camera of identifying a person.

Further, in the face processing unit 402, the smile recognition section 405 carries out a smile recognition process for the face image to obtain a degree of smile, namely, a smile score. The smile recognition section 405 is configured similarly to the smile recognition section 206 in the television receiver 110A described hereinabove and carries out the smile recognition using a general method which is used by a function of a camera of imaging when a smile is detected.

The data transmission section 406 sends the personal identification information obtained by the personal identification section 404 to the server apparatus 130. The data reception section 407 receives the personal identification information and the log information of the degree of smile sent thereto from the server apparatus 130 as described hereinabove. The log analysis section 408 analyzes the log information of the degree of smile to set an evaluation condition, here, an optimum threshold value for the smile.

Here, as the threshold value, for example, an average value of the degree of smile stored for each person can be utilized. For example, if an average value is used, the threshold value with regard to the person A in FIG. 7 is (80+75+70+90)/4=78.75; the threshold value with regard to the person B is (40+30+50)/3=40; and the threshold value with regard to the person C is (70+50+60+50)/4=57.5. Or, an average value of degrees of smile which satisfy such a specific condition as dates close to each other or same time zone or a maximum value may be used.

Further, not only information of the date and time but also environment information such as whether the place at which imaging is carried out is indoors or outdoors or is bright or dark may be added to the smile degree. In this instance, also it is possible to use, upon setting of a threshold value, only degrees of smile in similar environments to set a threshold value conforming to an imaging environment.

Or, it is a possible idea to add, to the degree of smile, not only information of the date and time but also content identification information representative of a type of displayed content displayed on the television receiver 110A when the degree of smile is obtained. In this instance, it is possible to adjust, upon setting of a threshold value, the value of the degree of smile in response to the type of the content and use the adjusted value of the degree of smile.

For example, if the type of the content is the comedy, then since it is considered that generally the degree of smile is high, the weighting coefficient is set to a comparatively low value. It is to be noted that also it is considerable to mainly utilize degrees of smile obtained in the case where the type of the content is the comedy.

The imaging timing controlling section 409 carries out shutter control of the camera 401 such that, when the degree of smile obtained by the smile recognition section 405 exceeds the threshold value for the smile determined by the log analysis section 408, imaging of a still image is carried out. In this instance, the camera 401 images the person 400 as a still image and stores image information of the still image.

It is to be noted that a person or individual who becomes an imaging object may be one of persons which has the largest face or is positioned near to the center or may be a person designated by the user or else may be a plurality of persons in an imaging frame. In the case where a plurality of persons are set as an imaging object, it may be used as a condition that the threshold value is exceeded with regard to all of the persons. Or, it may be used as a condition that, where a plurality of persons are set as an imaging object, the threshold value is exceeded with regard to a majority of the persons.

It is to be noted that, as information to be added to image evaluation information such as the degree of smile to be stored as log information, not only such information of the date, environment and displayed content as described hereinabove, but also scene information, GPS (global positioning system) information (position information) and so forth may be used. Further, although detailed description is omitted, as the environment information to be added to the image evaluation information, such metadata of the Exif (Exchangeable image file format) as given below may be used.

Imaging date and time: date and time when an evaluation image is produced by imaging

Imaging apparatus maker name: evaluation apparatus make name

Imaging apparatus model name: evaluation apparatus model name

Resolution of entire image: resolution of evaluation image

Resolution per unit in horizontal and vertical directions: resolution of evaluation image

Imaging direction: imaging direction when evaluation image is produced by imaging

Shutter speed: shutter speed when evaluation image is produced by imaging

Iris (F value): iris when evaluation image is produced by imaging

ISO sensitivity: ISO sensitivity when evaluation image is produced by imaging

Photometry mode: photometry mode when evaluation image is produced by imaging

Presence or absence of flashlight: presence or absence of flashlight when evaluation image is produced by imaging

Exposure light correction step value: exposure light correction step value when evaluation image is produced by imaging

Focal length: focal length when evaluation image is produced by imaging

Color space: color space when evaluation image is produced by imaging

GPS information (in case of camera with GPS function, latitude, longitude, elevation, etc.): GPS information when evaluation image is produced by imaging

Further, as the environment information to be added to the image evaluation information, also such information as given below may be used.

Image evaluation engine ID: environment information when “evaluated”

Information of content displayed upon image evaluation (content ID, genre of content, favorable degree of content to user): environment information when imaged

Evaluation apparatus ID: environment information when “evaluated”

Brightness of imaging object (evaluation target)

Brightness of imaging environment (brightness of evaluation environment)

Light source Information

Color balance (white balance)

Size of imaging object (evaluation target)

Direction of imaging object (evaluation target)

Movement (speed) of imaging object (valuation target): because it is estimated that, when imaging object is moving, accuracy in evaluation drops and evaluation value may be calculated lower

Blurring degree of imaging apparatus (camera shake degree): because it is estimated that, similarly as in case of movement of imaging object described above, when camera shake occurs, accuracy in evaluation drops and evaluation value may be calculated lower

It is to be noted that it seems a possible idea to intentionally produce, contrary to addition of environment information when image evaluation information such as the degree of smile is obtained or like information to the environment information as described hereinabove, a predetermined environment and take a log. For example, it is possible to issue an instruction to an imaging object person to smile to measure the degree of smile so that the imaging object person may produce a smile. At this time, also it is possible to control the illumination condition and so forth. As a result, image evaluation information in a required environment can be obtained efficiently.

Operation of the information processing system 10A shown in FIG. 6 is described. First, operation upon log information collection is described. An image of a person 202 who is viewing predetermined displayed content is picked up by the camera 201 of the television receiver 110A, and thereupon, image information as an evaluation target is obtained. This image information is supplied to the face processing unit 203.

In the face processing unit 203, the face is detected from the image information by the face detection section 204. Then, a personal identification process is carried out for the face image by the personal identification section 205 to obtain personal identification information. Further, a smile recognition process is carried out for the face image by the smile recognition section 206 to obtain a degree of smile, namely, a smile score. Then, the degree of smile is sent as log information to the server apparatus 130 together with the personal identification information by the data transmission section 207.

It is to be noted that the series of processes after an image of the person 202 is picked up until log information of the degree of smile is transmitted to the server apparatus 130 together with the personal identification information described above by the television receiver 110A is carried out in response to an explicit operation of the user or automatically after every predetermined interval of time. In this instance, environment information, identification information representative of the type of the displayed content or the like may be added to the degree of smile in addition to information of the date and time.

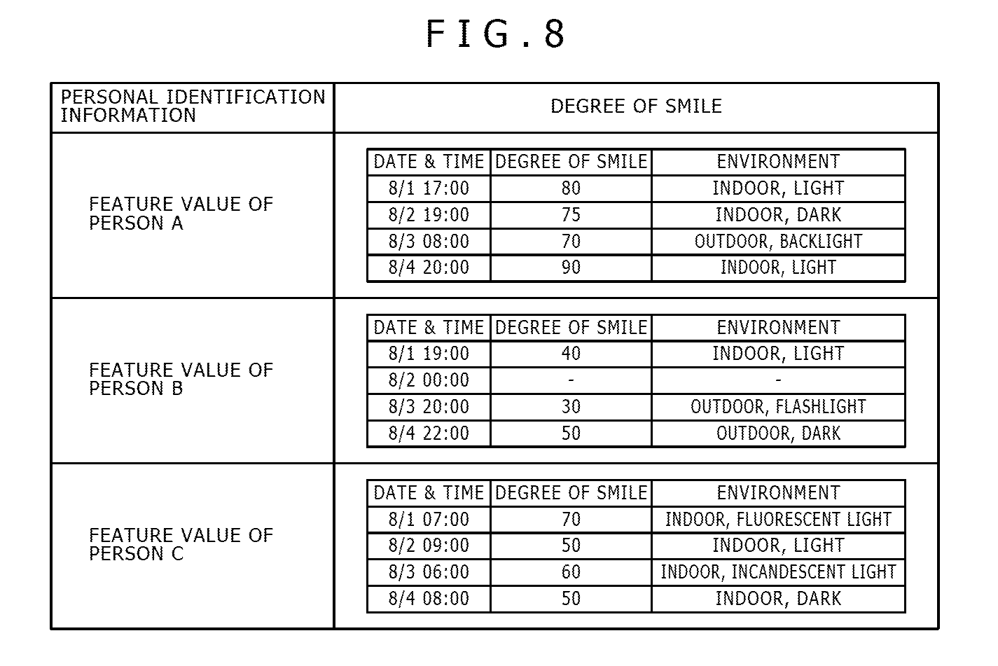

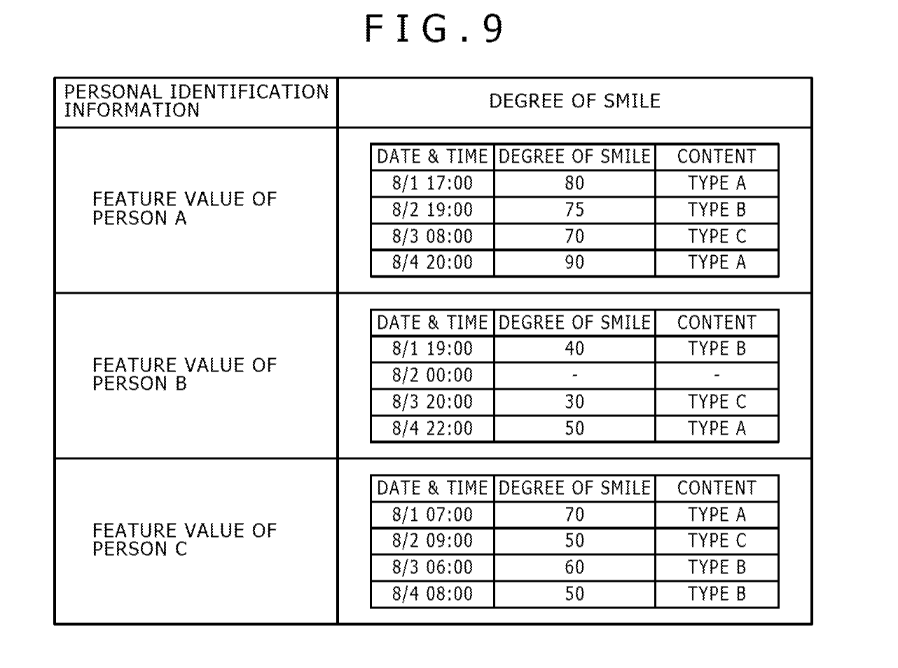

The personal identification information and the log information of the degree of smile sent from the television receiver 110A are received by the data reception section 301 of the server apparatus 130. The server apparatus 130 stores the log information of the degree of smile received in this manner in an associated relationship with the personal identification information into the database 303. In this manner, log information of the degree of smile corresponding to a predetermined number of persons is identifiably stored in an associated relationship with their personal identification information in the database 303 of the server apparatus 130 (refer to FIGS. 7 to 9).

It is to be noted that the number of pieces of the log information of the degree of smile of persons stored in the database 303 gradually increases in the server apparatus 130. In this instance, those pieces of the log information which are old in time may be successively deleted or may otherwise be left as an average value when the number of the pieces of the log information exceeds a predetermined number.

Now, operation upon utilization of log information is described. An image of a person 400 as an imaging object is picked up by the camera 401 of the digital still camera 120A to obtain image information as an evaluation target. This image information is supplied to the face processing unit 402. In the face processing unit 402, the face is detected from the image information by the face detection section 403. Then, a personal identification process is carried out for the face image by the personal identification section 404 to obtain personal identification information. This personal identification information is sent to the server apparatus 130 by the data transmission section 406.

The personal identification information sent from the digital still camera 120A is received by the data reception section 301 of the server apparatus 130 and sent to the personal identification information matching section 304. The personal identification information matching section 304 searches the database 303 to detect whether or not log information of a degree of smile corresponding to the personal identification information from the digital still camera 120A exists in the database 303. If the log information of the degree of smile exists, then it is extracted from the database 303 and transmitted to the digital still camera 120A together with the personal identification information by the data transmission section 305.

The log information of the degree of smile sent together with the personal identification information from the server apparatus 130 is received by the data reception section 407 of the digital still camera 120A and supplied to the log analysis section 408. The log analysis section 408 analyzes the log information of the degree of smile to set an optimum threshold value for the smile corresponding to the person 400 as an imaging object as an evaluation condition.

This threshold value for the smile is supplied to the imaging timing controlling section 409. Further, in the face processing unit 402, a smile recognition process is carried out for the face image to obtain a degree of smile, namely, a smile score, by the smile recognition section 405. This degree of smile is supplied to the imaging timing controlling section 409. It is to be noted that, upon utilization of the log information, image information is successively outputted from the camera 401, and a degree of smile is successively repetitively obtained by the smile recognition section 405.

The imaging timing controlling section 409 carries out shutter control of the camera 401 so that pickup of a still image is carried out when the degree of smile obtained by the smile recognition section 405 exceeds the threshold value set by the log analysis section 408. In this instance, the camera 401 carries out still imaging of the person 400 as an imaging object, and image information of the still image is stored.

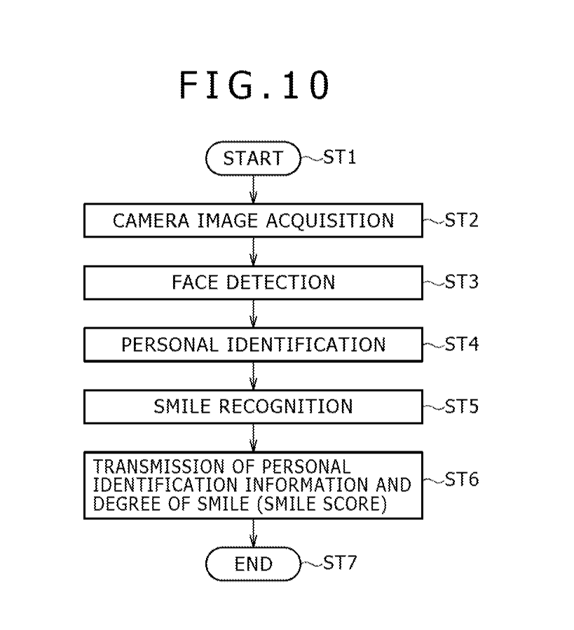

FIG. 10 illustrates an example of a processing flow of the television receiver 110A. Referring to FIG. 10, first at step ST1, the television receiver 110A starts processing. Thereafter, the processing advances to step ST2. In this instance, the processing is started in response to an explicit operation of the user or automatically in response to recognition of the person 202. At step ST2, the television receiver 110A images the person 202 to acquire a camera image or image information by the camera 201.

Then at step ST3, the television receiver 110A detects the face from the image information by the face detection section 204 of the face processing unit 203. Then at step ST4, the television receiver 110A carries out a personal identification process for the face image by the personal identification section 205 of the face processing unit 203 to obtain personal identification information (feature value). Further, at step ST5, the television receiver 110A carries out a smile recognition process for the face image by the smile recognition section 206 of the face processing unit 203 to obtain a degree of smile, namely, a smile score. It is to be noted that the order of the processes at steps ST4 and ST5 may be reversed.

Then at step ST6, the television receiver 110A transmits the personal identification information obtained at step ST4 and the degree of smile obtained at step ST5 in a paired relationship with each other to the server apparatus 130 by the data transmission section 207. Then, after the process at step ST6, the television receiver 110A ends the processing at step ST7.

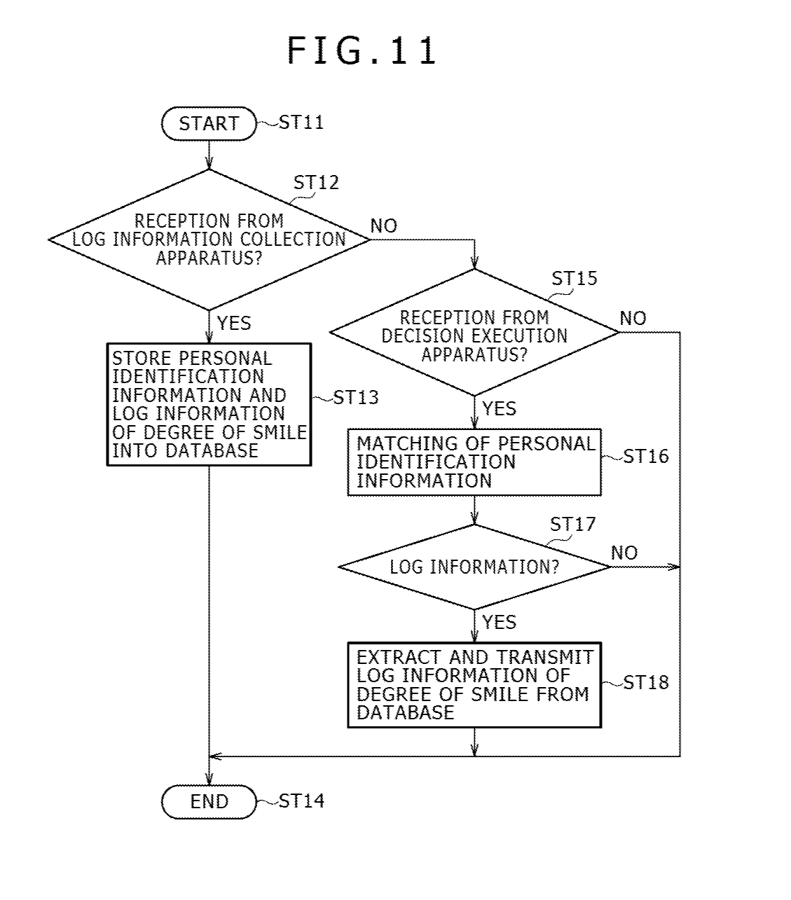

FIG. 11 illustrates an example of a processing flow of the server apparatus 130. The server apparatus 130 repetitively executes the processing flow in a predetermined period. Referring to FIG. 11, the server apparatus 130 starts processing at step ST11 and then advances the processing to step ST12. At step ST12, the server apparatus 130 decides whether or not data is received from a log information collection apparatus, namely, from the television receiver 110A, by the data reception section 301.

If data is received, then the server apparatus 130 stores, at step ST13, the received personal identification information and log information of a degree of smile into the database 303 by the data storage section 302. After the process at step ST13, the server apparatus 130 ends the processing at step ST14.

However, if data is not received at step ST12 described above, then the server apparatus 130 advances the processing to step ST15. At step ST15, the server apparatus 130 decides whether or not data is received from a decision execution apparatus, namely, from the digital still camera 120A, by the data reception section 301. If data is not received, then the server apparatus 130 immediately ends the processing at step ST14.

On the other hand, if data is received at step ST15, then the server apparatus 130 advances the processing to step ST16. At step ST16, the server apparatus 130 carries out a matching process by the personal identification information matching section 304 between the received personal identification information and the personal identification information stored in the database 303 to search the database 303 to detect whether or not the log information of a degree of smile corresponding to the personal identification information exists in the database 303.

Then at step ST17, the server apparatus 130 decides whether or not the log information of the degree of smile corresponding to the received personal identification information is stored in the database 303 based on a result of the search at step ST16. If the log information is detected, then the server apparatus 130 extracts the log information from the database 303 and transmits the log information to the digital still camera 120A by the data transmission section 305 at step ST18.

After the process at step ST18, the server apparatus 130 ends the processing at step ST14. On the other hand, if the log information is not detected at step ST17, then the server apparatus 130 immediately ends the processing at step ST14.

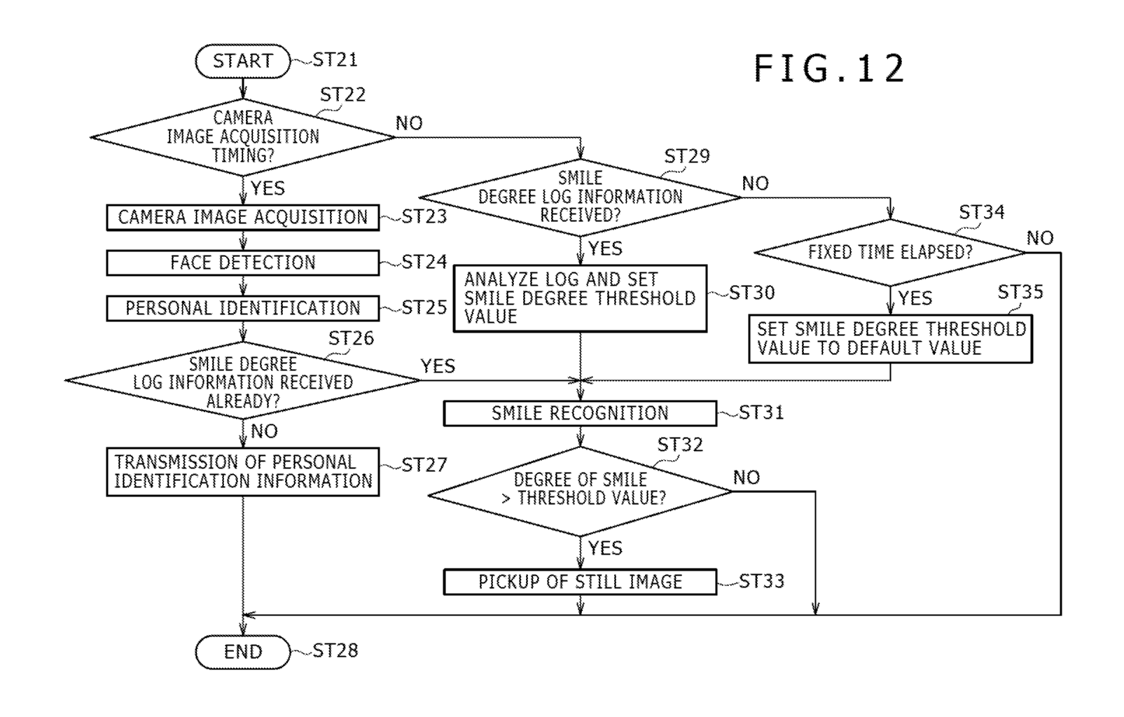

FIG. 12 illustrates an example of a processing flow of the digital still camera 120A. The digital still camera 120A repetitively executes this processing flow in a predetermined period. Referring to FIG. 12, the digital still camera 120A starts processing at step ST21 and then advances the processing to step ST22.

At step ST22, the digital still camera 120A decides whether or not the present point of time is an acquisition timing of a camera image, namely, image information. The acquisition timing is repetitively provided, for example, automatically in a predetermined period after a shutter operation of the user. If the present point of time is an acquisition timing, then the digital still camera 120A carries out imaging of the person 400 as an imaging object by the camera 401 to obtain a camera image, namely, image information at step ST23.

Then at step ST24, the digital still camera 120A detects the face from the image information by the face detection section 403 of the face processing unit 402. Then at step ST25, the digital still camera 120A carries out a personal identification process for the face image by the personal identification section 404 of the face processing unit 402 to obtain personal identification information, namely, a feature value.

Then at step ST26, the digital still camera 120A decides whether or not log information of a degree of smile corresponding to the personal identification information obtained at step ST25 is received already from the server apparatus 130. If the log information is not received, then the digital still camera 120A transmits the personal identification information obtained at step ST25 to the server apparatus 130 at step ST27 by the data transmission section 406. After the process at step ST27, the digital still camera 120A ends the processing at step ST28.

On the other hand, if the present point of time is not an acquisition timing for a camera image at step ST22, then the digital still camera 120A decides at step ST29 whether or not log information of a degree of smile associated with the personal identification information transmitted at step ST27 is received by the data reception section 407. If the log information is received, then the digital still camera 120A analyzes the log information of the degree of smile to set an optimum threshold value for the smile at step ST30 by the log analysis section 408.

After the process at step ST30, the digital still camera 120A advances the processing to step ST31. Also when log information is received already at step ST26 described hereinabove, the processing advances to step ST31. At step ST31, the digital still camera 120A carries out a smile recognition process for the face image by the smile recognition section 405 of the face processing unit 402 to obtain a smile degree, namely, a smile score.

Then at step ST32, the digital still camera 120A decides whether or not the degree of smile obtained at step ST31 exceeds the set threshold value for the smile. If the degree of smile exceeds the threshold value, then the digital still camera 120A controls the shutter of the camera 401 by the imaging timing controlling section 409 to carry out imaging of a still image of the person 400 at step ST33. After the process at step ST33, the digital still camera 120A ends the processing at step ST28. On the other hand, if the degree of smile does not exceed the threshold value at step ST32, then the digital still camera 120A immediately ends the processing at step ST28.

On the other hand, if the log information is not received at step ST29, the digital still camera 120A decides at step ST34 whether or not a fixed period of time elapses after the personal identification information is transmitted at step ST27. If the fixed period of time does not elapse, then the digital still camera 120A immediately ends the processing at step ST28.

On the other hand, if the fixed period of time elapses at step ST34, then the digital still camera 120A sets the threshold value for the smile to a default value at step ST35 and then advances the processing to step ST31. In particular, the lapse of the fixed period of time signifies that log information of a degree of smile associated with the personal identification information is not stored in the database 303, and setting of a threshold value for the smile by analysis of the log information of the degree of smile is impossible. Therefore, in this instance, the threshold value for the smile is set to the default value, and then succeeding processes are executed.

It is to be noted that, in the information processing system 10A of FIG. 6, the digital still camera 120A analyzes the log information of the degree of smile to set a threshold value for the smile for a person or individual specified by the personal identification information. However, also another configuration may be used wherein setting of a threshold value for the smile is carried out by the server apparatus 130 or the television receiver 110A which is a log information collection apparatus.

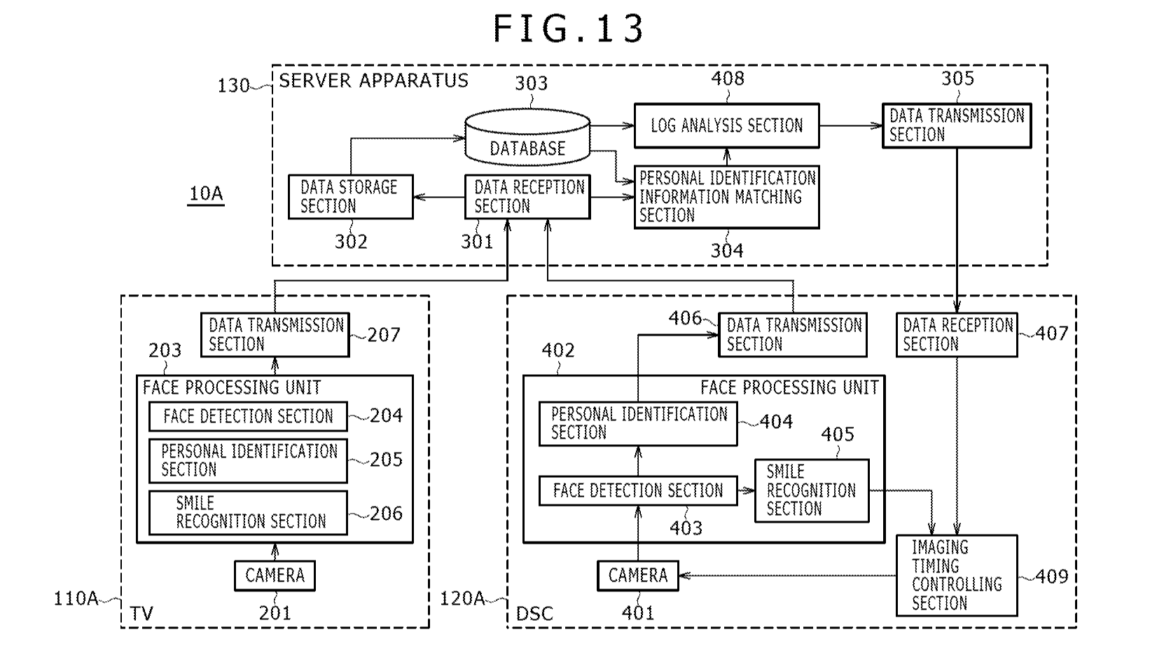

FIG. 13 shows another example of a block configuration of the information processing system 10A. In the configuration, setting of a threshold value for the smile is carried out by the server apparatus 130. The information processing system 10A shown in FIG. 13 includes several components common to those of the information processing system 10A described hereinabove with reference to FIG. 6, and overlapping description of the common components is omitted herein to avoid redundancy. Referring to FIG. 13, the television receiver 110A shown is configured similarly to the television receiver 110A of the information processing system 10A shown in FIG. 6.

The server apparatus 130 includes a data reception section 301, a data storage section 302, a database 303, a personal identification information matching section 304, a log analysis section 408, and a data transmission section 305. The log analysis section 408 extracts log information of a degree of smile corresponding to personal identification information obtained from the digital still camera 120A from the database 303 and analyzes the log information to set a threshold value for the smile as an evaluation condition. The data transmission section 305 transmits the threshold value for the smile set by the log analysis section 408 to the digital still camera 120A together with the personal identification information. The other components of the server apparatus 130 are configured similarly to those of the server apparatus 130 of the information processing system 10A of FIG. 6.

The digital still camera 120A includes a camera 401 serving as an imaging section, a face processing unit 402, a data transmission section 406, a data reception section 407 and an imaging timing controlling section 409. The data reception section 407 receives the personal identification information and the threshold value for the smile sent thereto from the server apparatus 130 as described hereinabove. The imaging timing controlling section 409 controls the shutter of the camera 401 so that, when the degree of smile obtained by the smile recognition section 405 exceeds the threshold value for the smile received by the data reception section 407, pickup of a still image is carried out. In this instance, a still image pickup of the person 400 is carried out and image information of the still image is stored. The digital still camera 120A is configured similarly to the digital still camera 120A of the information processing system 10A described hereinabove with reference to FIG. 6.

Operation of the information processing system 10A shown in FIG. 13 is described. Operation of the information processing system 10A upon log information collection is similar to that of the information processing system 10A described hereinabove with reference to FIG. 6, and therefore, overlapping description of the same is omitted herein to avoid redundancy.

Operation upon log information utilization is described. An image of a person 400 as an imaging object is picked up by the camera 401 of the digital still camera 120A to obtain image information as an evaluation target. This image information is supplied to the face processing unit 402. The face processing unit 402 detects the face from the image information by the face detection section 403. Then, the personal identification section 404 carries out a personal identification process for the face image to obtain personal identification information. The personal identification information is sent to the server apparatus 130 by the data transmission section 406.

The personal identification information sent from the digital still camera 120A is received by the data reception section 301 of the server apparatus 130 and sent to the personal identification information matching section 304. The personal identification information matching section 304 searches the database 303 to detect whether or not log information of a degree of smile corresponding to the personal identification information from the digital still camera 120A is stored in the database 303.

If corresponding log information of a degree of smile is stored in the database 303, the log analysis section 408 extracts and analyzes the log information of the degree of smile to set a threshold value for the smile as an evaluation condition. Then, the data transmission section 305 transmits the set threshold value for the smile to the digital still camera 120A together with the personal identification information.

The personal identification information and the threshold value for the smile sent from the server apparatus 130 are received by the data reception section 407 of the digital still camera 120A and supplied to the imaging timing controlling section 409. Further, in the face processing unit 402, a smile recognition process is carried out for the face image by the smile recognition section 405 to obtain a degree of smile, namely, a smile score. The degree of smile is supplied to the imaging timing controlling section 409. It is to be noted that the smile recognition section 405 repetitively carries out the operation for obtaining a degree of smile.

The smile recognition section 405 controls the shutter of the camera 401 so that, when the degree of smile obtained by the smile recognition section 405 exceeds the threshold value for the smile received by the data reception section 407, pickup of a still image is carried out. In this instance, the camera 401 carries out pickup of a still image of the person 400 as an imaging object and stores the image information of the still image.

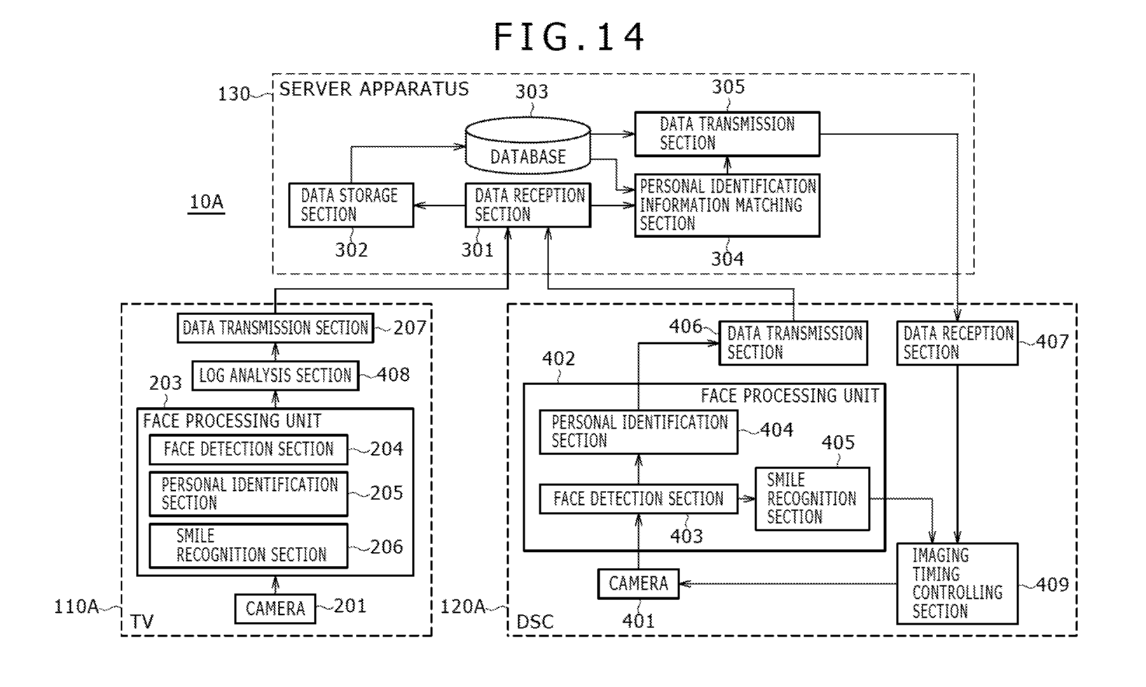

FIG. 14 shows a further example of the block configuration of the information processing system 10A. In the present configuration example, setting of a threshold value for the smile is carried by the television receiver 110A. The information processing system 10A shown in FIG. 14 includes several components common to those of the information processing systems 10A described hereinabove with reference to FIGS. 6 and 13, and overlapping description of the common components is omitted herein to avoid redundancy. Referring to FIG. 14, the digital still camera 120A shown is configured similarly to the digital still camera 120A of the information processing system 10A described hereinabove with reference to FIG. 13.

The television receiver 110A includes a camera 201 serving as an imaging section, a face processing unit 203, a log analysis section 408, and a data transmission section 207. The log analysis section 408 analyzes log information of a degree of smile for each piece of personal identification information obtained by the face processing unit 203 and sets a threshold value for the smile as an evaluation condition. The data transmission section 207 transmits the threshold value for the smile set by the log analysis section 408 to the server apparatus 130 together with the personal identification information. The other part of the television receiver 110A is configured similarly to that of the television receiver 110A of the information processing system 10A described hereinabove with reference to FIG. 6.

The server apparatus 130 includes a data reception section 301, a data storage section 302, a database 303, a personal identification information matching section 304 and a data transmission section 305. The data reception section 301 receives the personal identification information and the threshold value for the smile sent thereto from the television receiver 110A and receives the personal identification information sent thereto from the digital still camera 120A.

The data storage section 302 stores, when the data reception section 301 receives the personal identification information and the threshold value for the smile from the television receiver 110A, the threshold value for the smile in an associated relationship with the personal identification information into the database 303. The personal identification information matching section 304 carries out, when the data reception section 301 receives the personal identification information from the digital still camera 120A, a matching process between the received personal identification information and the personal identification information stored in the database 303.

Then, the personal identification information matching section 304 searches the database 303 to detect whether or not a threshold value for the smile corresponding to the personal identification information from the digital still camera 120A is stored in the database 303. If a threshold value for the smile corresponding to the personal identification information from the digital still camera 120A is stored in the database 303, then the data transmission section 305 transmits the threshold value for the smile to the digital still camera 120A together with the personal identification information. The other part of the server apparatus 130 is configured similarly to that of the server apparatus 130 of the information processing system 10A described hereinabove with reference to FIG. 6.

Operation of the information processing system 10A shown in FIG. 14 is described. First, operation upon collection of log information is described. An image of a person 202 who is viewing predetermined displayed content is picked up by the camera 201 of the television receiver 110A to obtain image information as an evaluation target. This image information is supplied to the face processing unit 203.

In the face processing unit 203, the face detection section 204 detects the face from the image information. Then, the personal identification section 205 carries out a personal identification process for the face image to obtain personal identification information, and the smile recognition section 206 carries out a smile recognition process for the face image to obtain a degree of smile, namely, a smile score. The log analysis section 408 analyzes the log information of the degree of smile for each piece of the personal identification information obtained by the face processing unit 203 to set a threshold value for the smile as an evaluation condition. Then, the data transmission section 207 sends the threshold value for the smile set by the log analysis section 408 to the server apparatus 130 together with the personal identification information.

The personal identification information and the threshold value for the smile sent from the television receiver 110A are received by the data reception section 301 of the server apparatus 130. Then, the server apparatus 130 stores the received threshold value for the smile in an associated relationship with the personal identification information into the database 303. In this manner, threshold values for the smile corresponding to a predetermined number of persons are identifiably stored into the database 303 of the server apparatus 130.

Now, operation upon utilization of log information is described. An image of a person 400 as an imaging object is picked up by the camera 401 of the digital still camera 120A to obtain image information as an evaluation target. This image information is supplied to the face processing unit 402. In the face processing unit 402, the face detection section 403 detects the face from the image information. Then, the personal identification section 404 carries out a personal identification process for the face image to obtain personal identification information. The personal identification information is sent to the server apparatus 130 by the data transmission section 406.

The personal identification information sent from the digital still camera 120A is received by the data reception section 301 of the server apparatus 130 and sent to the personal identification information matching section 304. The personal identification information matching section 304 searches the database 303 to detect whether or not a threshold value for the smile corresponding to the personal identification information from the digital still camera 120A is stored in the database 303. If a corresponding threshold value for the smile is stored, then the data transmission section 305 transmits the threshold value for the smile to the digital still camera 120A together with the personal identification information.

The personal identification information and the threshold value for the smile sent from the server apparatus 130 are received by the data reception section 407 of the digital still camera 120A and supplied to the imaging timing controlling section 409. Further, in the face processing unit 402, the smile recognition section 405 carries out a smile recognition process for the face image to obtain a degree of smile, namely, a smile score. This degree of smile is supplied to the imaging timing controlling section 409. It is to be noted that the smile recognition section 405 repetitively carries out the process for obtaining a degree of smile.

The imaging timing controlling section 409 controls the shutter of the camera 401 so that, when the degree of smile obtained by the smile recognition section 405 exceeds the threshold value for the smile received by the data reception section 407, imaging of a still image is carried out. In this instance, the camera 401 carries out pickup of a still image of the person 400 as an imaging object and stores image information of the still image.

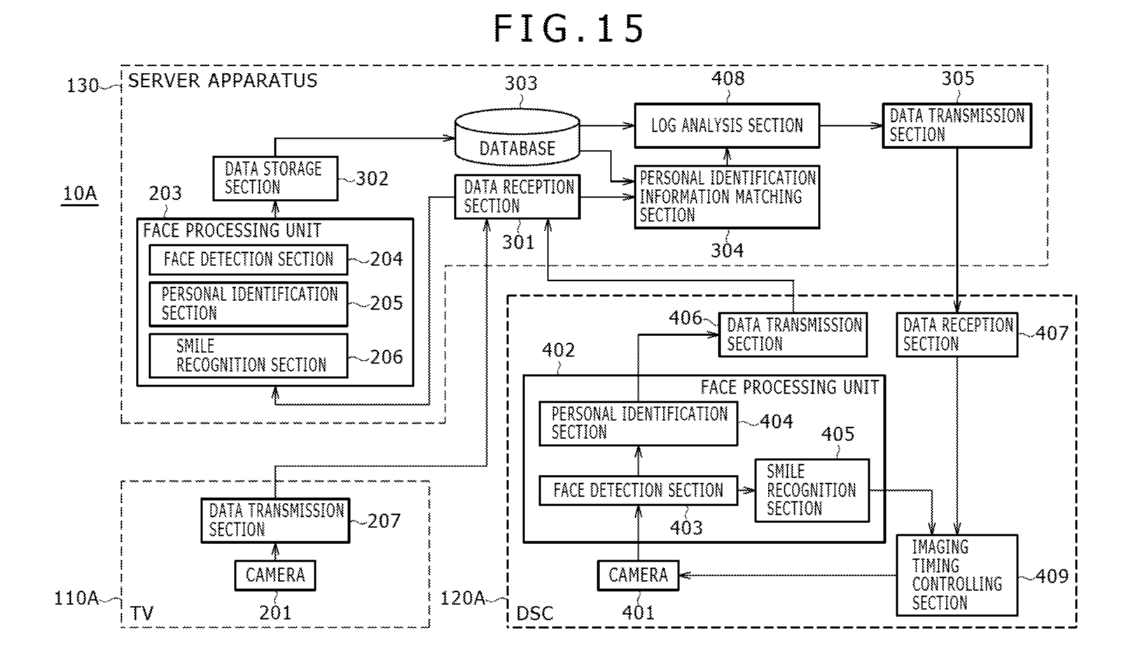

FIG. 15 shows a still further example of the block configuration of the information processing system 10A. In this configuration example, the server apparatus 130 carries out a face process upon log information collection and carries out setting of a threshold value for the smile. The information processing system 10A shown in FIG. 15 includes several components common to those of the information processing systems 10A described hereinabove with reference to FIGS. 6, 13 and 14, and overlapping description of the common components is omitted herein to avoid redundancy. The digital still camera 120A shown in FIG. 15 is configured similarly to the digital still camera 120A of the information processing system 10A described hereinabove with reference to FIG. 13.

Referring to FIG. 15, the television receiver 110A includes a camera 201 serving as an imaging section, and a data transmission section 207. The data transmission section 207 sends image information as an evaluation target obtained by picking up an image of the person 202 by the camera 201 to the server apparatus 130. The other part of the television receiver 110A is configured similarly to that of the television receiver 110A of the information processing system 10A described hereinabove with reference to FIG. 6.

The server apparatus 130 includes a data reception section 301, a face processing unit 203, a data storage section 302, a database 303, a personal identification information matching section 304, a log analysis section 408, and a data transmission section 305. The data reception section 301 receives image information sent thereto from the television receiver 110A and receives the personal identification information sent thereto from the digital still camera 120A.

The face processing unit 203 includes a face detection section 204, a personal identification section 205 and a smile recognition section 206. In the face processing unit 203, the face detection section 204 detects the face from image information obtained by imaging by the camera 201. Further, in the face processing unit 203, the personal identification section 205 carries out a personal identification process for the face image to obtain personal identification information. Further, in the face processing unit 203, the smile recognition section 206 carries out a smile recognition process for the face image to obtain a degree of smile, namely, a smile score.

The data storage section 302 stores the degree of smile obtained by the face processing unit 203 as log information into the database 303 in an associated relationship with the personal identification information obtained similarly by the face processing unit 203. The other part of the server apparatus 130 is configured similarly to the server apparatus 130 of the information processing system 10A described hereinabove with reference to FIG. 13.

Operation of the information processing system 10A shown in FIG. 15 is described below. Since operation upon utilization of log information is similar to operation of the information processing system 10A shown in FIG. 13, overlapping description of the operation is omitted herein.

Operation upon log information collection is described. An image of a person 202 who is viewing predetermined displayed content is picked up by the camera 201 of the television receiver 110A to obtain image information as an evaluation target. This image information is sent to the server apparatus 130 by the data transmission section 207. The image information sent from the television receiver 110A in this manner is received by the data reception section 301 of the server apparatus 130 and supplied to the face processing unit 203.

In the face processing unit 203, the face detection section 204 detects the face from the image information. Then, the personal identification section 205 carries out a personal identification process for the face image to obtain personal identification information, and the smile recognition section 206 carries out a smile recognition process for the face image to obtain a degree of smile, namely, a smile score. The data storage section 302 stores the degree of smile obtained by the face processing unit 203 into the database 303 in an associated relationship with the personal identification information obtained similarly by the face processing unit 203 as log information. In this manner, threshold values for the smile corresponding to a predetermined number of persons are stored identifiably into the database 303 of the server apparatus 130.

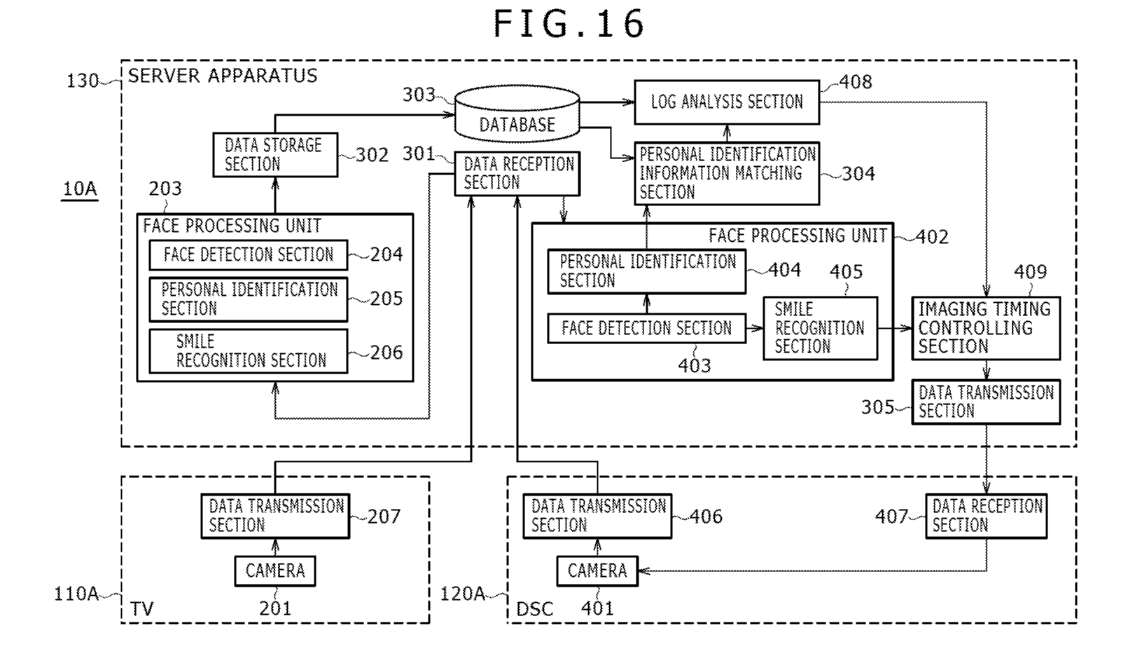

FIG. 16 shows a yet further example of the block configuration of the information processing system 10A. In the present configuration example, the server apparatus 130 carries out a face process upon log information collection and log information utilization and further carries out a production process of an imaging timing controlling signal and setting of a threshold value for the smile. The information processing system 10A shown in FIG. 16 includes several components common to those of the information processing systems 10A described hereinabove with reference to FIGS. 6, 13, 14 and 15, and overlapping description of the common components is omitted herein to avoid redundancy. The television receiver 110A shown in FIG. 16 is configured similarly to the television receiver 110A of the information processing system 10A described hereinabove with reference to FIG. 15.

Referring to FIG. 16, the server apparatus 130 includes a data reception section 301, a face processing unit 203, a data storage section 302, a database 303, a face processing unit 402, a personal identification information matching section 304, a log analysis section 408, an imaging timing controlling section 409 and a data transmission section 305. The data reception section 301 receives image information sent thereto from the television receiver 110A and receives image information sent thereto from the digital still camera 120A.

The face processing unit 402 includes a face detection section 403, a personal identification section 404 and a smile recognition section 405. In the face processing unit 402, the face detection section 403 detects the face from the image information from the camera 401 received by the data reception section 301. Further, in the face processing unit 402, the personal identification section 404 carries out a personal identification process for the face image to obtain personal identification information. Furthermore, in the face processing unit 402, the smile recognition section 405 carries out a smile recognition process for the face image to obtain a degree of smile, namely, a smile score.

The personal identification information matching section 304 searches the database 303 to detect whether or not log information of a degree of smile corresponding to the personal identification information obtained by the face processing unit 402 is stored in the database 303. If log information of a degree of smile corresponding to the personal identification information obtained by the face processing unit 402 is stored in the database 303, then the log analysis section 408 extracts log information of a degree of smile corresponding to the personal identification information obtained by the face processing unit 402 from the database 303 and analyzes the log information to set a threshold value for the smile as an evaluation condition.

The imaging timing controlling section 409 generates, when the degree of smile obtained by the smile recognition section 405 exceeds the threshold value for the smile set by the log analysis section 408, an imaging timing controlling signal for carrying out pickup of a still image. The data transmission section 305 transmits the imaging timing controlling signal to the digital still camera 120A. The other part of the server apparatus 130 is configured similarly to the server apparatus 130 of the information processing system 10A described hereinabove with reference to FIG. 15.

The digital still camera 120A includes a camera 401 serving as an imaging section, a data transmission section 406, and a data reception section 407. The data transmission section 406 sends image information as an evaluation target obtained by imaging of the person 400 by the camera 401 to the server apparatus 130. The data reception section 407 receives an imaging timing controlling signal sent thereto from the server apparatus 130 and supplies the imaging timing controlling signal to the camera 401. In this instance, the camera 401 carries out a process of picking up a still image of the person 400 and storing image information of the still image. The other part of the digital still camera 120A is configured similarly to that the digital still camera 120A of the information processing system 10A described hereinabove with reference to FIG. 6.

Operation of the information processing system 10A shown in FIG. 16 is described. Operation of the information processing system 10A upon log information collection is similar to that of the information processing system 10A described hereinabove with reference to FIG. 15, and therefore, overlapping description of the same is omitted herein to avoid redundancy.

Operation upon log information utilization is described. An image of a person 400 as an imaging object is picked up by the camera 401 of the digital still camera 120A to obtain image information as an evaluation target. This image information is sent to the server apparatus 130 by the data transmission section 406. The image information sent from the digital still camera 120A in this manner is received by the data reception section 301 of the server apparatus 130 and supplied to the face processing unit 402.

In the face processing unit 402, the face detection section 403 detects the face from the image information. Then, the personal identification section 404 carries out a personal identification process for the face image to obtain personal identification information. This personal identification information is supplied to the personal identification information matching section 304. The personal identification information matching section 304 searches the database 303 to detect whether or not log information of a degree of smile corresponding to the personal identification information from the face processing unit 402 is stored in the database 303.

If corresponding log information of a degree of smile is stored in the database 303, then the log analysis section 408 extracts and analyzes the log information of the degree of smile to set a threshold value for the smile as an evaluation condition. This threshold value for the smile is supplied to the imaging timing controlling section 409. Further, in the face processing unit 402, the smile recognition section 405 carries out a smile recognition process for the face image to obtain a degree of smile, namely, a smile score. This degree of smile is supplied to the imaging timing controlling section 409. It is to be noted that the smile recognition section 405 repetitively carries out the process of obtaining a degree of smile.

When the degree of smile obtained by the smile recognition section 405 exceeds the threshold value for the smile obtained by the log analysis section 408, the imaging timing controlling section 409 generates an imaging timing controlling signal for carrying out pickup of a still image. This imaging timing controlling signal is sent to the digital still camera 120A by the data transmission section 305.

The imaging timing controlling signal sent from the server apparatus 130 is received by the data reception section 407 of the digital still camera 120A and supplied to the camera 401 so that shutter control of the camera 401 is carried out. Consequently, the camera 401 carries out still imaging of the person 400 as an imaging object and stores image information of the still image.

In the information processing system 10A shown in FIG. 5, since a threshold value for the smile is set based on log information of a degree of smile associated with a person, the threshold value for the smile is automatically optimized for each user. Accordingly, imaging by a smile detection shutter can be carried out favorably without depending upon the personal difference in facial expression recognition. It is to be noted that this similarly applies also when not a smile but another facial expression such as an angry or sad expression or an apparent age is detected to carry out shutter control.

### Particular Example 2 of Information Processing System

### Evaluation of Interest Degree in Displayed Content

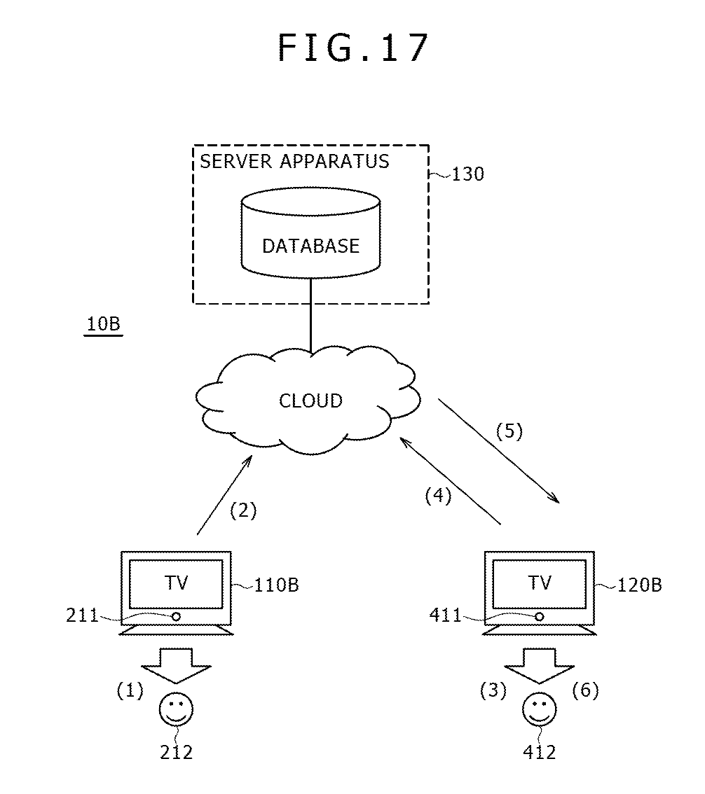

Now, a particular example 2 of the information processing system 10 is described. FIG. 17 shows an example of a configuration of an information processing system 10B wherein the log information collection apparatus is a television receiver (TV) 110B and the decision execution apparatus is another television receiver (TV) 120B. Further, in the information processing system 10B, the evaluation information is image information, and the image evaluation information is information for evaluation of the degree of interest of a person or individual in displayed content.

Referring to FIG. 17, the information processing system 10B includes a television receiver 110B, a television receiver 120B and a server apparatus 130. The server apparatus 130 exists on a cloud, namely, on a network. The television receiver 110B and the television receiver 120B can individually communicate with the server apparatus 130 on the cloud.

The television receiver 110B collects log information of information representative of an interest degree in displayed content associated with personal identification information. The television receiver 110B (1) images a person 212 by a camera 211 serving as an imaging section to obtain image information in a state in which content of a predetermined type is displayed.

The television receiver 110B detects a face image from the image information and carries out a personal identification process for the face image to obtain personal identification information. Further, the television receiver 110B determines information representative of an interest degree in the displayed content from the image information, here, an attention time period such as, for example, a period of time during which the person 212 watches the displayed content when the time length of the displayed content is standardized per unit time period.

(2) The television receiver 110B sends the attention time period to the server apparatus 130 on the cloud together with the personal identification information with content identification information, which represents a type of the displayed content, added thereto. The server apparatus 130 stores the attention time period sent thereto from the television receiver 110B into the database in an associated relationship with the personal identification information.

The television receiver 120B (3) images a person 412 to obtain image information. The television receiver 120B detects the face from the image information and carries out a personal identification process for the face image to obtain personal identification information. (4) The television receiver 120B sends the personal identification information to the server apparatus 130 and (5) receives log information of the attention time period stored in an associated relationship with the personal identification information from the server apparatus 130.

The television receiver 120B analyzes the log information to set, for example, an interest degree coefficient as an evaluation condition for each content type. As the interest degree coefficient of a predetermined content type, for example, a difference between an average value of the attention time period among all types of content and an average value of the attention time period of the predetermined content type or a like value can be used. (6) The television receiver 120B uses the interest degree coefficient for each content type to refer to, for example, EPG (Electronic Program guide) information to select a recommended program or content and displays the recommended program so as to be presented to the person 412.

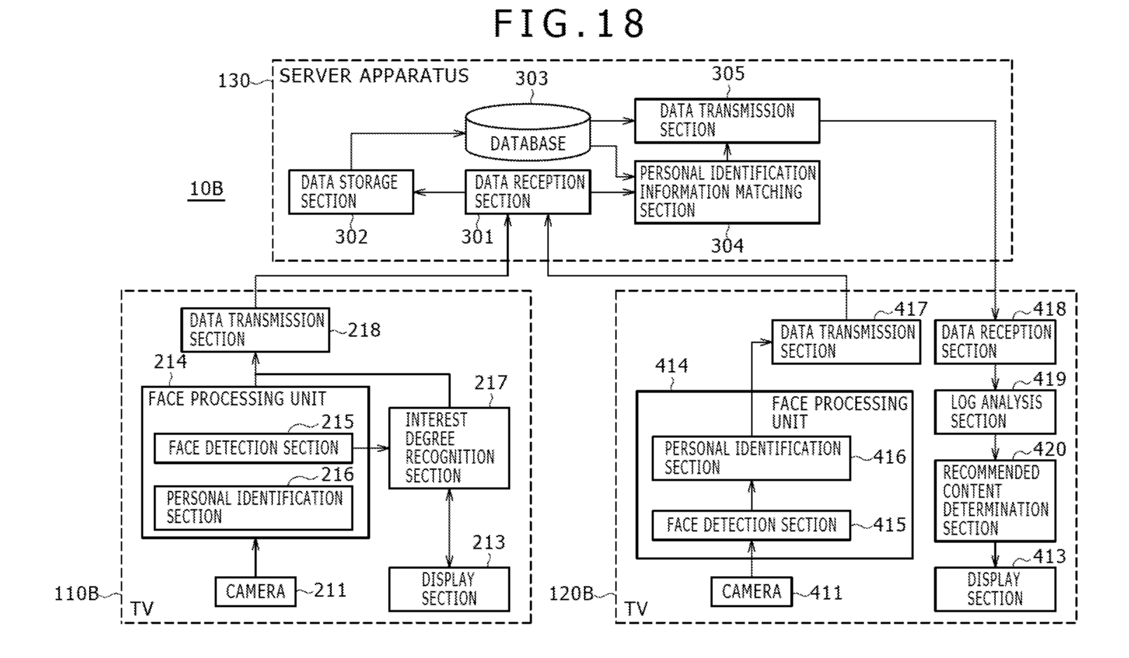

FIG. 18 shows an example of a block configuration of the components of the information processing system 10B. Referring to FIG. 18, the television receiver 110B includes a camera 211 serving as an imaging section, a display section 213, a face processing unit 214, an interest degree recognition section 217, and a data transmission section 218. The camera 211 images a person 212 in a state in which content of a predetermined type is displayed on the display section 213 to obtain image information as an evaluation target as described hereinabove.

The face processing unit 214 includes a face detection section 215 and a personal identification section 216. In the face processing unit 214, the face detection section 215 detects the face from image information obtained by imaging by the camera 211. This face detection can be carried out using a method which is popularly used in various cameras. For example, an example of a face detection method is disclosed in Japanese Patent Laid-Open No. 2008-42319.

Further, in the face processing unit 214, the personal identification section 216 carries out a personal identification process for the face image to obtain personal identification information. The personal identification section 216 outputs, for example, a feature value with which a person can be identified as the personal identification information. This personal identification can be carried out using a general method as is used in the security field or by a function of a camera of identifying a person. An example of a personal identification method is disclosed, for example, in Japanese Patent Laid-Open No. 2010-61465.

The interest degree recognition section 217 decides based on the face image whether or not the person 212 is viewing the displayed content on the display section 213 to obtain an attention time period as information representative of an interest degree. The interest degree recognition section 217 adds content identification information representative of the type of the displayed content to the attention time period. The data transmission section 218 sends the attention time period obtained by the interest degree recognition section 217 to the server apparatus 130 together with the personal identification information obtained by the personal identification section 216 so as to be stored into the database. In this manner, the series of processes from the imaging of the person 212 described to the transmission of the attention time period to the server apparatus 130 in the television receiver 110B is carried out in response to an explicit operation of the user or automatically after every predetermined interval of time.

The server apparatus 130 includes a data reception section 301, a data storage section 302, a database 303, a personal identification information matching section 304 and a data transmission section 305. The data reception section 301 receives personal identification information and an attention time period, to which the content identification information is added, sent thereto from the television receiver 110B and receives personal identification information sent thereto from the television receiver 120B.

When the data reception section 301 receives personal identification information and an attention time period from the television receiver 110B, the data storage section 302 stores the attention time period as log information in an associated relationship with the personal identification information into the database 303. When the data reception section 301 receives the personal identification information from the television receiver 120B, the personal identification information matching section 304 carries out a matching process between the received personal identification information and the personal identification information stored in the database 303.

Then, the personal identification information matching section 304 searches the database 303 to detect whether or not log information of an attention time period corresponding to the personal identification information from the television receiver 120B is stored in the database 303. If log information of the attention time period corresponding to the personal identification information from the television receiver 120B is stored in the database 303, then the data transmission section 305 transmits the log information of the attention time period, to which the content identification information is added, to the television receiver 120B together with the personal identification information.

The television receiver 120B includes a camera 411 serving as an imaging section, a display section 413, a face processing unit 414, a data transmission section 417, a data reception section 418, a log analysis section 419 and a recommended content determination section 420. The camera 411 images a person 412 to obtain image information as an evaluation target as described hereinabove.

The face processing unit 414 includes a face detection section 415 and a personal identification section 416. In the face processing unit 414, the face detection section 415 detects the face from the image information obtained by imaging by the camera 411. The face detection section 415 is configured similarly to the face detection section 215 of the television receiver 110B described hereinabove and carries out face detection using a method which is used in a general camera.

Further, in the face processing unit 414, the personal identification section 416 carries out a personal identification process for the face image to obtain personal identification information. The personal identification section 416 is configured similarly to the personal identification section 216 in the television receiver 110B described hereinabove and carries out the personal identification using such a popular method as is used in the security field or by a function of a camera of identifying a person.

The data transmission section 417 sends the personal identification information obtained by the personal identification section 416 to the server apparatus 130. The data reception section 418 receives the personal identification information and the log information of the attention time period, to which the content identification information is added, sent thereto from the server apparatus 130 as described hereinabove. The log analysis section 419 analyzes the log information of the attention time period and sets an interest degree coefficient as an evaluation condition for each content type.

In this instance, the log analysis section 419 determines, as the interest degree coefficient of a predetermined content type, for example, a difference between an average value of the attention time period of all types of content and an average value of the attention time period of the predetermined content type. The interest degree coefficient of each content type determined in this manner correctly indicates the interest degree in content of each content type irrespective of whether the person is of the type who usually watches the television for a comparatively long period of time or glances at the television infrequently.

The recommended content determination section 420 refers, for example, to EPG information using the interest degree coefficient of each content type to select a recommended program or content and controls the display section 413 so as to display the selected program or content on the display screen. Here, the recommended content determination section 420 selects a program of a content type having a high interest degree coefficient as a recommended program.

Operation of the information processing system 10B shown in FIG. 18 is described. First, operation upon log information collection is described. The camera 211 of the television receiver 110B images a person 212 who is viewing content or a program of a predetermined type displayed on the display section 213 to obtain image information as an evaluation target. This image information is supplied to the face processing unit 214.

In the face processing unit 214, the face detection section 215 detects the face from the image information. Then, the personal identification section 216 carries out a personal identification process for the face image to obtain personal identification information. Further, the interest degree recognition section 217 decides based on the face image whether or not the person 212 is viewing the displayed content of the display section 213 to obtain an attention time period as information indicative of an interest degree. Then, the data transmission section 218 sends the attention time period, to which the content identification information is added, as log information to the server apparatus 130 together with the personal identification information.

It is to be noted that the series of processes by the television receiver 110B after the imaging of the person 212 described above until the transmission of the log information of the attention time period, to which the content identification information is added, to the server apparatus 130 together with the personal identification information is carried out in response to an explicit operation of the user or automatically after every predetermined interval of time. It is to be noted that, to the attention time period, not only information of date and time but also environment information and so forth may be added.

The personal identification information and the log information of the attention time period having the content identification information added thereto, which are sent from the television receiver 110B, are received by the data reception section 301 of the server apparatus 130. Then, the server apparatus 130 stores the log information of the attention time period received in this manner into the database 303 in an associated relationship with the personal identification information. The database 303 of the server apparatus 130 identifiably stores log information of attention time periods corresponding to a predetermined number of persons.

Now, operation upon log information utilization is described. The camera 411 of the television receiver 120B images a person 412 as a viewer to obtain image information as an evaluation target. This image information is supplied to the face processing unit 414. In the face processing unit 414, the face detection section 415 detects the face from the image information. Then, the personal identification section 416 carries out a personal identification process for the face image to obtain personal identification information. This personal identification information is sent to the server apparatus 130 by the data transmission section 417.

The personal identification information sent from the television receiver 120B is received by the data reception section 301 of the server apparatus 130 and sent to the personal identification information matching section 304. The personal identification information matching section 304 searches the database 303 to detect whether or not log information of an attention time period corresponding to the personal identification information from the television receiver 120B is stored in the database 303. If log information of the corresponding attention time period is stored, then the data transmission section 305 transmits the log information of the attention time period, to which the content identification information is added, to the television receiver 120B together with the personal identification information.

The personal identification information and the log information of the attention time period having the content identification information added thereto, which are sent from the server apparatus 130, are received by the data reception section 418 of the television receiver 120B. The personal identification information and the log information of the attention time period are supplied to the log analysis section 419. The log analysis section 419 analyzes the log information of the attention time period to set an interest degree coefficient as an evaluation condition for each content type and supplies the interest degree coefficient to the recommended content determination section 420.

The recommended content determination section 420 uses the interest degree coefficient for each content type to refer, for example, to EPG information to select a recommended program or content. Then, the recommended content determination section 420 controls the display section 413 to display the recommended content to the person 412 of the viewer on the display screen of the display section 413.

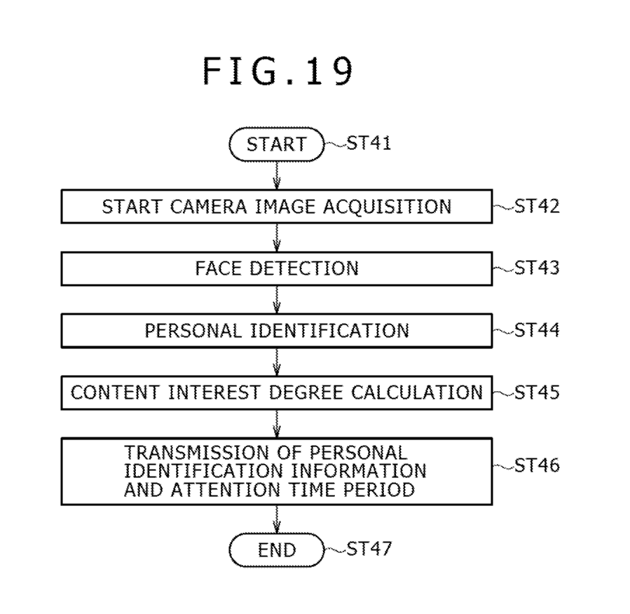

FIG. 19 illustrates an example of a processing flow of the television receiver 110B. Referring to FIG. 19, the television receiver 110B starts processing at step ST41 and then advances the processing to step ST42. In this instance, the processing is started, for example, in response to an explicit operation of the user. At step ST42, the television receiver 110B starts imaging of the person 212 who is viewing content or a program of a predetermined type displayed on the display section 213 by the camera 211.

Then at step ST43, the television receiver 110B detects the face from the image information by the face detection section 215 of the face processing unit 214. Then at step ST44, the television receiver 110B carries out a personal identification process for the face image to obtain personal identification information, namely, a feature value, by the personal identification section 216 of the face processing unit 214.

Then at step ST45, the television receiver 110B calculates an attention time period as a content interest degree by the interest degree recognition section 217. In this instance, the television receiver 110B decides whether or not the person 212 is viewing the displayed content of the display section 213 to obtain an attention time period based on the face image.

Then at step ST46, the television receiver 110B transmits the personal identification information obtained at step ST44 and the attention time period obtained at step ST45 and having the content identification information added thereto in a paired relationship with each other to the server apparatus 130 by the data transmission section 218. The television receiver 110B ends the processing at step ST47 after the process at step ST46.

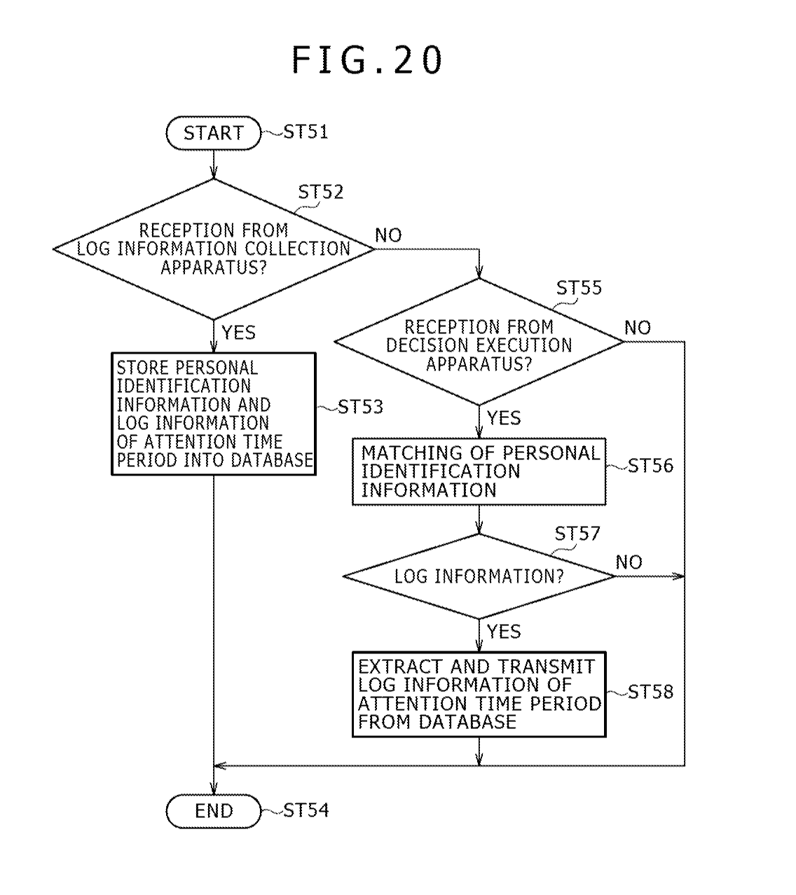

FIG. 20 illustrates an example of a processing flow of the server apparatus 130. The server apparatus 130 repetitively executes the processing flow after every predetermined interval of time. Referring to FIG. 20, the server apparatus 130 starts processing at step ST51 and then advances the processing to step ST52. At step ST52, the server apparatus 130 decides whether or not data is received from a log information collection apparatus, namely, from the television receiver 110B, by the data reception section 301.

If data is received, then the server apparatus 130 stores received personal identification information and log information of an attention time period, to which the content identification information is added, into the database 303 by the data storage section 302 at step ST53. The server apparatus 130 ends the processing at step ST54 after the process at step ST53.

If data is not received at step ST52 described hereinabove, the server apparatus 130 advances the processing to step ST55. At step ST55, the server apparatus 130 decides whether or not data is received from a decision execution apparatus, namely, from the television receiver 120B, by the data reception section 301. If data is not received, then the server apparatus 130 immediately ends the processing at step ST54.

On the other hand, if data is received, then the server apparatus 130 advances the processing to step ST56. At step ST56, the server apparatus 130 carries out a matching process between the received personal identification information and personal identification information stored in the database 303 by the personal identification information matching section 304 to search the database 303 to detect whether or not log information of an attention time period corresponding to the personal identification information is stored in the database 303.

Then at step ST57, the server apparatus 130 decides based on a result of the search at step ST56 whether or not the log information of the attention time period corresponding to the received personal identification information is stored in the database 303. If the log information is stored, then the server apparatus 130 extracts the log information from the database 303 and transmits the log information to the television receiver 120B by the data transmission section 305 at step ST58.

The server apparatus 130 ends the processing at step ST54 after the process at step ST58. On the other hand, when the log information is not found at step ST57, the server apparatus 130 immediately ends the processing at step ST54.

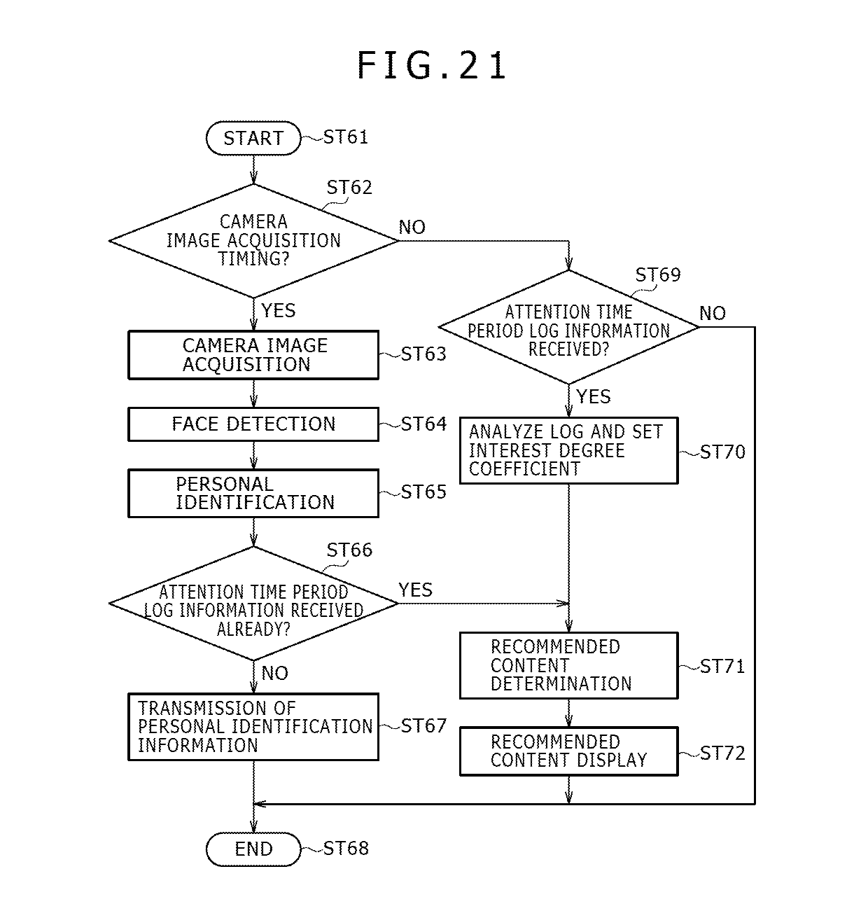

FIG. 21 illustrates an example of a processing flow of the television receiver 120B. The television receiver 120B repetitively executes this processing flow after every predetermined interval of time. Referring to FIG. 21, the television receiver 120B starts processing at step ST61 and advances the processing to step ST62.

At step ST62, the television receiver 120B decides whether or not the present point of time is an acquisition timing of a camera image. The acquisition timing is given by an explicit operation of the user or automatically. For example, that the user, namely, the person 412, starts viewing of the television receiver 120B is automatically detected to determine the current point of time as an acquisition timing. When the present point of time is an acquisition timing, the television receiver 120B images the person 412 as a viewer by the camera 411 to acquire a camera image or image information at step ST63.

Then at step ST64, the television receiver 120B detects the face from the image information by the face detection section 415 of the face processing unit 414. Then at step ST65, the personal identification section 416 of the face processing unit 414 carries out a personal identification process for the face image to obtain personal identification information, namely, a feature value.

Then at step ST66, the television receiver 120B decides whether or not log information of an attention time period corresponding to the personal identification information obtained at step ST65 is received already from the server apparatus 130. If such log information is not received, then the television receiver 120B transmits the personal identification information obtained at step ST65 to the server apparatus 130 by the data transmission section 417 at step ST67. The television receiver 120B ends the processing at step ST68 after the process at step ST67.

On the other hand, if the present point of time is not an acquisition timing of a camera image at step ST62, then the television receiver 120B decides at step ST69 whether or not log information of an attention time period associated with the personal identification information transmitted at step ST67 is received by the data reception section 418. If such log information is not received, then the television receiver 120B immediately ends the processing at step ST68.

On the other hand, if log information is received at step ST69, then the television receiver 120B analyzes, at step ST70, the log information of the attention time period added to the content identification information to set an interest degree coefficient as an evaluation condition for each content type by the log analysis section 419. After the process at step ST70, the television receiver 120B advances the processing to step ST71. Also when log information is received already at step ST66 described hereinabove, the processing advances to step ST71.

At step ST71, the television receiver 120B uses the interest degree coefficient of each content type to refer, for example, to EPG information to select a recommended program or content by the recommended content determination section 420. Then at step ST72, the television receiver 120B displays the recommended content selected at step ST71 on the display section 413 so as to be presented to the person 412 of the viewer. The television receiver 120B ends the processing at step ST68 after the process at step ST72.

It is to be noted that, in the information processing system 10B of FIG. 18, the television receiver 120B analyzes log information of an attention time period to set an interest degree coefficient for each content type of a person or individual specified by the personal identification information. However, although detailed description is omitted herein, it is possible to use another configuration wherein such setting of an interest degree coefficient is carried out by the server apparatus 130 or by the television receiver 110B which is a log information collection apparatus similarly as in the case of the setting of a threshold value for the smile by the information processing system 10A described hereinabove (refer to FIGS. 13 to 16).

In the information processing system 10B shown in FIG. 17, an interest degree coefficient for each content type is set based on log information of the attention time period, to which the content identification information is added, associated with a person. Therefore, the interest degree coefficient for each content type is automatically optimized for each user. Accordingly, optimum content or program can be recommended for each user.

### Particular Example 3 of Information Process System

### Evaluation of Composition

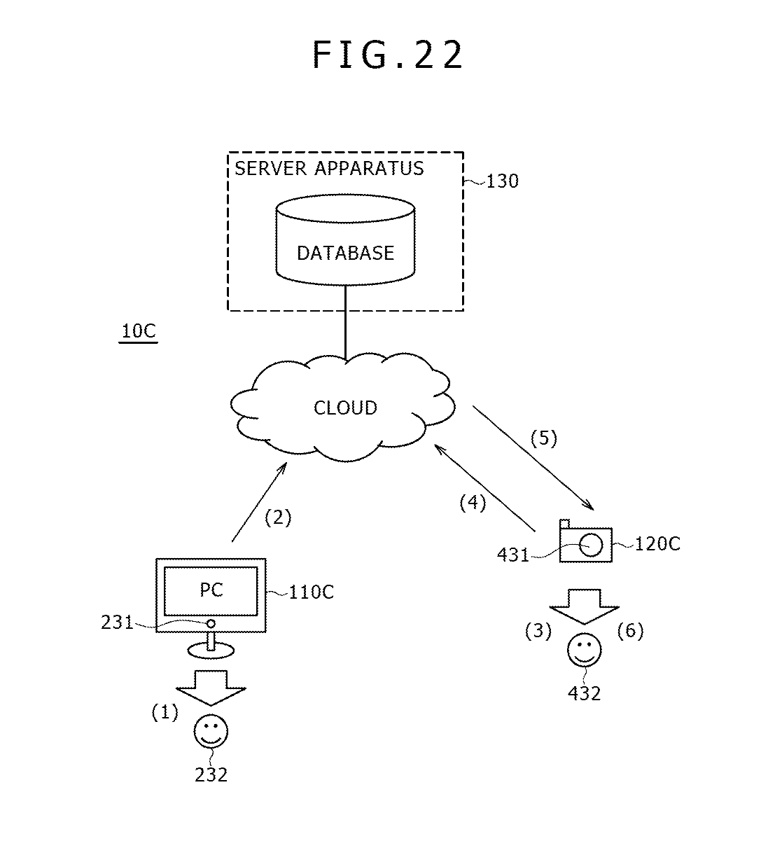

Now, a particular example 3 of the information processing system 10 is described. FIG. 22 shows an example of a configuration of an information processing system 10C wherein the log information collection apparatus is a personal computer (PC) 110C and the decision execution apparatus is a digital still camera (DSC) 120C. Further, in the information processing system 10C, the evaluation information is image information and the image evaluation information is information for the evaluation of a composition associated with a person.

Referring to FIG. 22, the information processing system 10C is configured from a personal computer 110C, a digital still camera 120C, and a server apparatus 130. The server apparatus 130 exists on a cloud, namely, on a network. The personal computer 110C and the digital still camera 120C can individually communicate with the server apparatus 130 on the cloud.

The personal computer 110C collects log information of a composition evaluation value associated with personal identification information. It is to be noted that, since the composition is involved, the composition evaluation value is not necessarily a simple one-dimensional numerical value. The personal computer 110C (1) images a person 232 by a camera 231 serving as an imaging section to obtain image information. The personal computer 110C detects a face image from the image information and carries out a personal identification process for the face image to obtain personal identification information.

Further, the personal computer 110C evaluates a composition of a main imaging object in image information downloaded from the Internet or the like or image information set as a favorite to obtain a composition evaluation value. (2) The personal computer 110C sends the composition evaluation value to the server apparatus 130 on the cloud together with the personal identification information. The server apparatus 130 stores the composition evaluation value sent thereto from the personal computer 110C into a database in an association with the personal identification information.

The digital still camera 120C (3) images a person 432 to obtain image information. The digital still camera 120C detects the face from the image information and carries out a personal identification process for the face image to obtain personal identification information. (4) The digital still camera 120C sends the personal identification information to the server apparatus 130 and (5) receives log information of a composition evaluation value stored in an associated relationship with the personal identification information in the server apparatus 130 from the server apparatus 130.

The digital still camera 120C analyzes the log information to set an evaluation condition, namely, a threshold value for the decision regarding whether or not the composition is acceptable. The digital still camera 120C evaluates the composition of a main imaging object in the image information described above to obtain a composition evaluation value. Then, the digital still camera 120C compares the composition evaluation value obtained in this manner with the decision threshold value to decide whether or not the composition is acceptable. (6) The digital still camera 120C operates the shutter to carry out still imaging of the person 432 when it decides that the composition is acceptable.

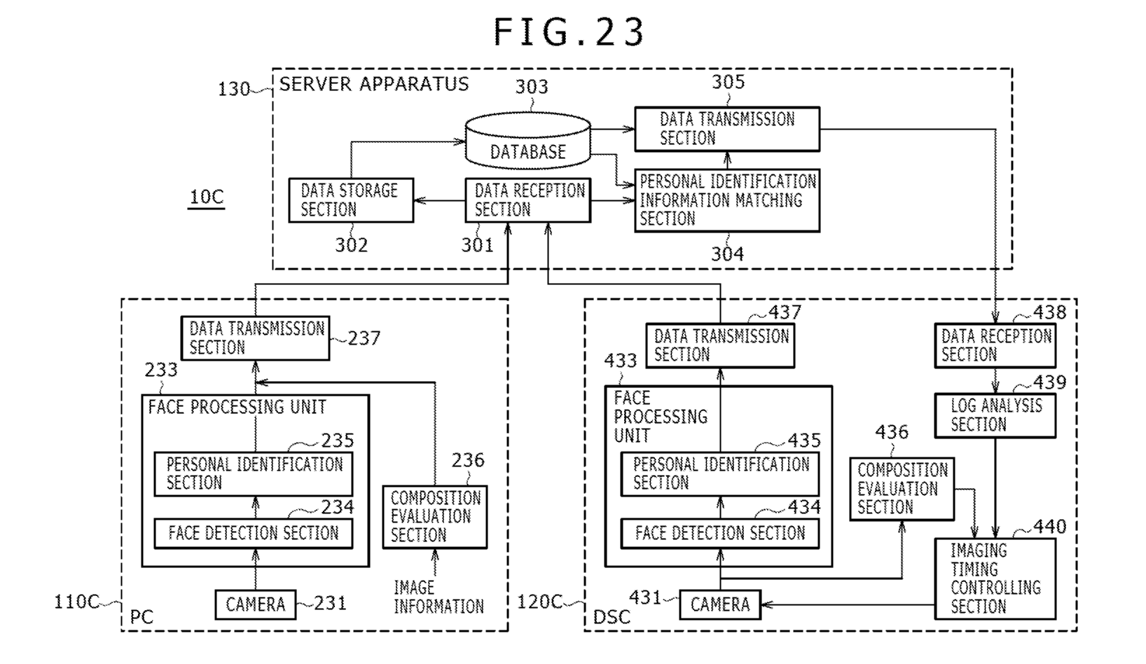

FIG. 23 shows an example of a block configuration of the components of the information processing system 10C. Referring to FIG. 23, the personal computer 110C includes a camera 231 serving as an imaging section, a face processing unit 233, a composition evaluation section 236, and a data transmission section 237. The camera 231 images the person 232 to obtain image information as described hereinabove.

The face processing unit 233 includes a face detection section 234 and a personal identification section 235. In the face processing unit 233, the face detection section 234 detects the face from image information obtained by imaging by the camera 231. This face detection can be carried out using a method used in a general camera. An example of the face detection method is disclosed, for example, in Japanese Patent Laid-Open No. 2008-42319.

The face processing unit 233 carries out a personal identification process for the face image to obtain personal identification information by the personal identification section 235. The personal identification section 235 outputs, for example, a feature value with which a person can be distinguished as personal identification information. This personal identification can be carried out using a popular method as is used in the security field or in a function of a camera for identifying a person. An example of a personal identification method is disclosed, for example, in Japanese Patent Laid-Open No. 2010-61465.

The composition evaluation section 236 evaluates the composition of a main imaging object in image information downloaded from the Internet or the like or image information set as a favorite to obtain a composition evaluation value. An example of the composition decision method is disclosed, for example, in Japanese Patent Laid-Open No. 2009-100300. The data transmission section 237 sends the composition evaluation value obtained by the composition evaluation section 236 as log information to the server apparatus 130 together with the personal identification information obtained by the personal identification section 235 so as to be stored into a database. In this manner, the series of processes of the personal computer 110C after the imaging of the person 232 until the composition evaluation value is transmitted to the server apparatus 130 together with the personal identification information is carried out, for example, in response to an explicit operation of the user.

The server apparatus 130 includes a data reception section 301, a data storage section 302, a database 303, a personal identification information matching section 304 and a data transmission section 305. The data reception section 301 receives personal identification information and a composition evaluation value sent thereto from the personal computer 110C and receives personal identification information sent thereto from the digital still camera 120C.

When the data reception section 301 receives personal identification information and a composition evaluation value from the personal computer 110C, the data storage section 302 stores the composition evaluation value as log information into the database 303 in an associated relationship with the personal identification information. When the data reception section 301 receives personal identification information from the digital still camera 120C, the personal identification information matching section 304 carries out a matching process between the received personal identification information and the personal identification information stored in the database 303.

Then, the personal identification information matching section 304 searches the database 303 to detect whether or not log information of a composition evaluation value corresponding to the personal identification information from the digital still camera 120C is stored in the database 303. If log information of a composition evaluation value corresponding to the personal identification information from the digital still camera 120C is stored in the database 303, then the data transmission section 305 transmits the log information of the composition evaluation value to the digital still camera 120C together with the personal identification information.

The digital still camera 120C includes a camera 431 serving as an imaging apparatus, a face processing unit 433, a composition evaluation section 436, a data transmission section 437, a data reception section 438, a log analysis section 439, and an imaging timing controlling section 440. The camera 431 images a person 432 to obtain image information as described hereinabove.

The face processing unit 433 includes a face detection section 434 and a personal identification section 435. In the face processing unit 433, the face detection section 434 detects the face from image information obtained by imaging of the camera 431. The face detection section 434 is configured similarly to the face detection section 234 of the personal computer 110C described hereinabove and carries out face detection using a method used in a general camera.

Further, in the face processing unit 433, the personal identification section 435 carries out a personal identification process for the image to obtain personal identification information. The personal identification section 435 is configured similarly to the personal identification section 235 of the personal computer 110C described hereinabove and carries out personal identification using a general method as is used in the security field or in a function of a camera of identifying a person.

The data transmission section 437 sends the personal identification information obtained by the personal identification section 435 to the server apparatus 130. The composition evaluation section 436 evaluates the composition of a main imaging object in image information obtained by imaging by the camera 431 to obtain a composition evaluation value. This composition evaluation section 436 is configured similarly to the composition evaluation section 236 of the personal computer 110C described hereinabove.

The data reception section 438 receives personal identification information and log information of a composition evaluation value sent thereto from the server apparatus 130 as described hereinabove. The log analysis section 439 analyzes the log information of the composition evaluation value to set an evaluation condition, namely, a decision threshold value representative of whether or not the composition is acceptable. Then, the imaging timing controlling section 440 compares the composition evaluation value obtained by the composition evaluation section 436 with the decision threshold value set by the log analysis section 439 to decide the acceptability of the composition.

If the imaging timing controlling section 440 decides that the composition is acceptable, then it carries out shutter control of the camera 431 so that pickup of a still image is carried out. In this instance, the camera 431 picks up a still image of the person 432 and stores image information of the still image. It is to be noted that a person or individual who becomes an imaging object may be one of persons which has the largest face or is positioned near to the center or may be a person designated by the user or else may be a plurality of persons in an imaging frame.

Operation of the information processing system 10C shown in FIG. 23 is described. First, operation upon log information collection is described. The camera 231 of the personal computer 110C images the person 232 to be associated to obtain image information.

In the face processing unit 233, the face detection section 234 detects the face from the image information. Then, the personal identification section 235 carries out a personal identification process for the face image to obtain personal identification information. Further, image information downloaded from the Internet or the like or image information set as a favorite is supplied to the composition evaluation section 236. The composition evaluation section 236 evaluates the composition of a main imaging object in the image information to obtain a composition evaluation value. Then, the data transmission section 237 sends the composition evaluation value obtained by the composition evaluation section 236 as log information to the server apparatus 130 together with the personal identification information obtained by the personal identification section 235.

It is to be noted that the series of processes of the personal computer 110C after the image of the person 232 is picked up until the log information of the composition evaluation value is transmitted to the server apparatus 130 together with the personal identification information is carried out, for example, in response to an explicit operation of the user. In this instance, not only information of the date and time but also environment information, information relating to the evaluated image information and so forth are added to the composition evaluation value.

The personal identification information and the log information of the composition evaluation value sent from the personal computer 110C are received by the data reception section 301 of the server apparatus 130. Then, the server apparatus 130 stores the log information of the composition evaluation value received in this instance in an associated relationship with the personal identification information into the database 303. In this manner, log information of the composition evaluation value corresponding to a predetermined number of persons is identifiably stored in the database 303 of the server apparatus 130.

Now, operation upon log information utilization is described. An image of the person 432 as an imaging object is picked up by the camera 431 of the digital still camera 120C to obtain image information as an evaluation target. This image information is supplied to the face processing unit 433. In the face processing unit 433, the face detection section 434 detects the face from the image information. Then, the personal identification section 435 carries out a personal identification process for the face image to obtain personal identification information. The personal identification information is sent to the server apparatus 130 by the data transmission section 437.

The personal identification information sent from the digital still camera 120C is received by the data reception section 301 of the server apparatus 130 and sent to the personal identification information matching section 304. The personal identification information matching section 304 searches the database 303 to detect whether or not log information of a composition evaluation value corresponding to the personal identification information from the digital still camera 120C is stored in the database 303. If such log information of a corresponding composition evaluation value is stored, then the data transmission section 305 transmits the log information of the composition evaluation value to the digital still camera 120C together with the personal identification information.

The personal identification information and the log information of the composition evaluation value sent from the server apparatus 130 are received by the data reception section 438 of the digital still camera 120C. The personal identification information and the log information of the composition evaluation value are supplied to the log analysis section 439. The log analysis section 439 analyzes the log information of the composition evaluation value to set a decision threshold value for the decision regarding whether or not the composition is acceptable as an evaluation condition. This decision threshold value is supplied to the imaging timing controlling section 440.

The image information obtained by the camera 431 is supplied to the composition evaluation section 436. The composition evaluation section 436 evaluates the composition of a main imaging object of the image information to obtain a composition evaluation value. It is to be noted that the composition evaluation section 436 repetitively carries out the process for obtaining a composition evaluation value. This composition evaluation value is supplied to the imaging timing controlling section 440.

The imaging timing controlling section 440 compares the composition evaluation value obtained by the composition evaluation section 436 with the decision threshold value set by the log analysis section 439 to decide whether or not the composition is acceptable. Then, if it is decided that the composition is acceptable, then the imaging timing controlling section 440 carries out shutter control of the camera 431 so that pickup of a still image is carried out. Consequently, the camera 431 picks up a still image of the person 432 and stores image information of the still image.

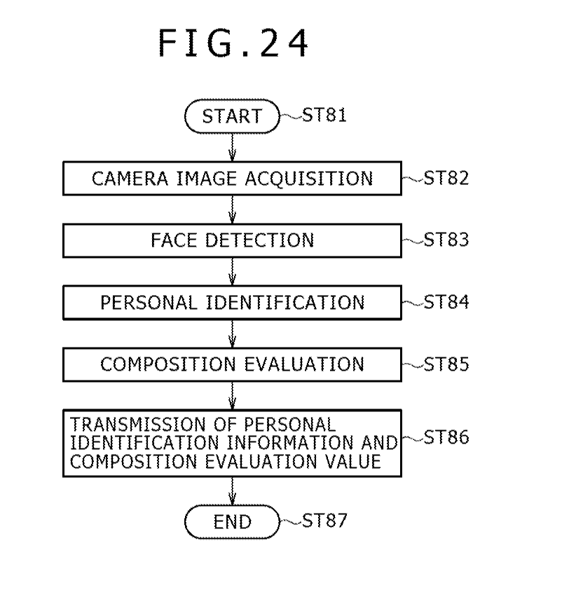

FIG. 24 illustrates an example of a processing flow of the personal computer 110C. Referring to FIG. 24, the personal computer 110C starts processing at step ST81 and then advances the processing to step ST82. In this instance, the processing is started in response to an explicit operation of the user. At step ST82, the personal computer 110C images the person 232 by the camera 231.

Then at step ST83, the personal computer 110C detects the face from the image information by the face detection section 234 of the face processing unit 233. Then at step ST84, the personal computer 110C carries out a personal identification process for the face image to obtain personal identification information, namely, a feature value, by the personal identification section 235 of the face processing unit 233.

Then at step ST85, the personal computer 110C evaluates the composition of a main imaging object in image information downloaded from the Internet or the like or in image information set as a favorite to obtain a composition evaluation value. Then at step ST86, the personal computer 110C transmits the personal identification information obtained at step ST84 and the composition evaluation value obtained at step ST85 in a paired relationship with each other to the server apparatus 130 by the data transmission section 237. The personal computer 110C ends the processing at step ST87 after the process at step ST86.

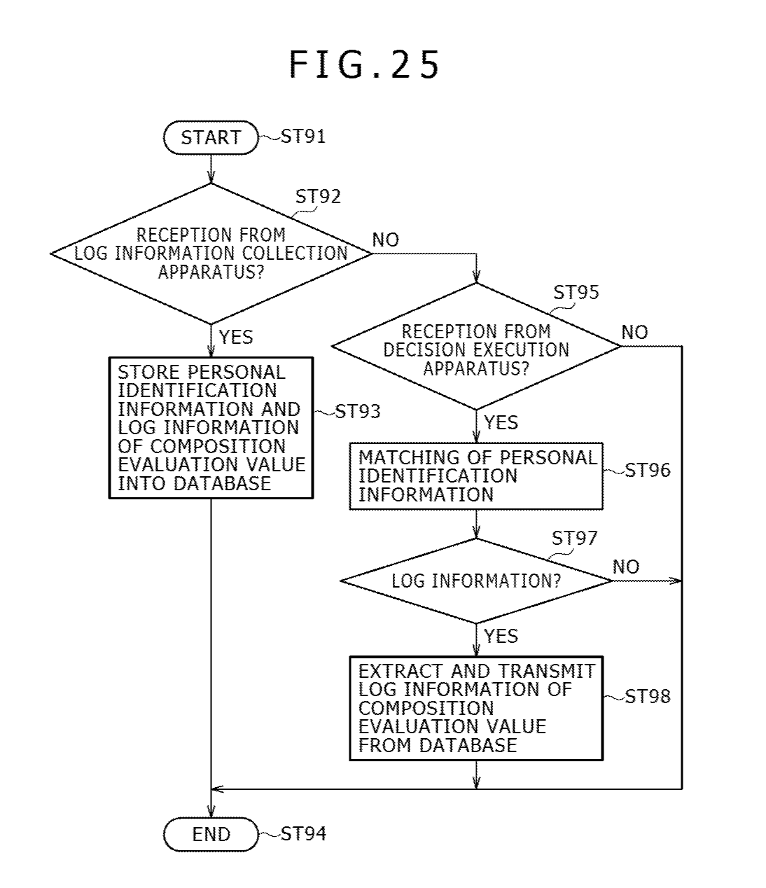

FIG. 25 illustrates an example of a processing flow of the server apparatus 130. The server apparatus 130 repetitively executes the processing flow after every predetermined interval of time. Referring to FIG. 25, the server apparatus 130 starts processing at step ST91 and then advances the processing to step ST92. At step ST92, the server apparatus 130 decides whether or not data is received from a log information collection apparatus, namely, from the personal computer 110C, by the data reception section 301.

If data is received, then the server apparatus 130 stores the received personal identification information and log information of the composition evaluation value into the database 303 by the data storage section 302 at step ST93. The server apparatus 130 ends the processing at step ST94 after the process at step ST93.

On the other hand, if data is not received at step ST92 described above, then the server apparatus 130 advances the processing to step ST95. At step ST95, the server apparatus 130 decides whether or not data is received from a decision execution apparatus, namely, from the digital still camera 120C, by the data reception section 301. If data is not received, then the server apparatus 130 immediately ends the processing at step ST94.

On the other hand, if data is received at step ST95, then the server apparatus 130 advances the processing to step ST96. At steps ST96, the server apparatus 130 carries out a matching process between the received personal identification information and the personal identification information stored in the database 303 by the personal identification information matching section 304 to decide whether or not log information of a composition evaluation value corresponding to the personal identification information is stored in the database 303.

Then at step ST97, the server apparatus 130 decides based on a result of the search at step ST96 whether or not log information of a composition evaluation value corresponding to the received personal identification information is stored in the database 303. If such log information is stored, then the server apparatus 130 extracts the log information from the database 303 and transmits the log information to the digital still camera 120C by the data transmission section 305 at step ST98.

The server apparatus 130 ends the processing at step ST94 after the process at step ST98. Further, when log information is not found at step ST97, the server apparatus 130 immediately ends the process at step ST94.

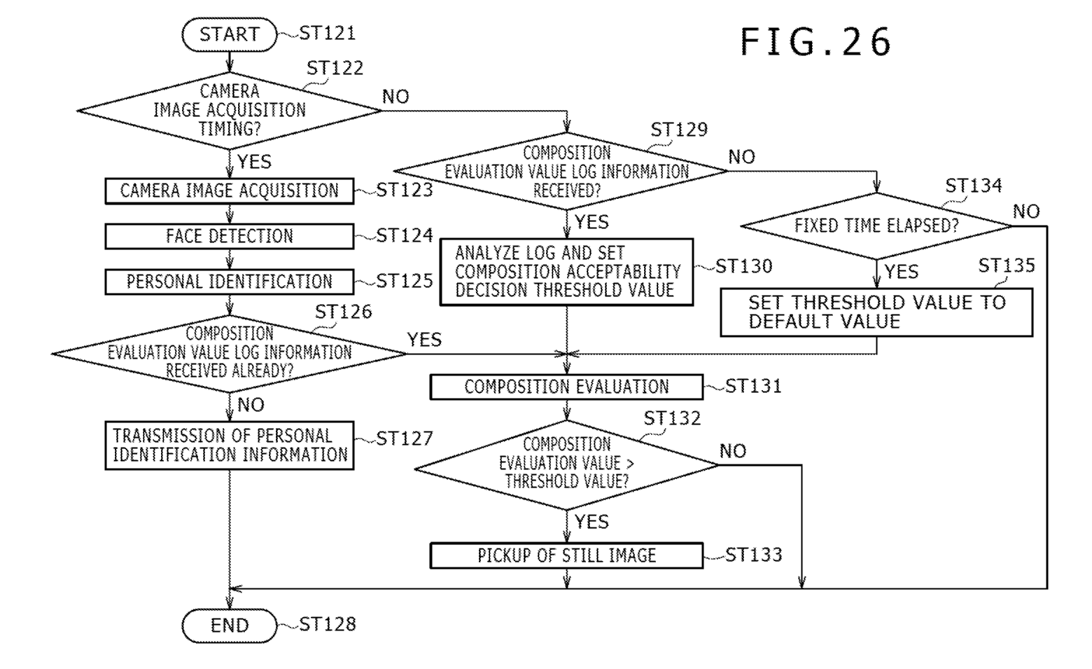

FIG. 26 illustrates an example of a processing flow of the digital still camera 120C. The digital still camera 120C repetitively executes this processing flow after every predetermined period. Referring to FIG. 26, the digital still camera 120C starts processing at step ST121 and then advances the processing to step ST122.

At step ST122, the digital still camera 120C decides whether or not the present point of time is an acquisition timing of a camera image, namely, of image information. The acquisition timing is given, for example, in response to an explicit operation of the user. If the present point of time is such acquisition timing, then the digital still camera 120C images a person 432 as an imaging object by the camera 431 to acquire a camera image, namely, image information, at step ST123.

Then at step ST124, the digital still camera 120C detects the face from the image information by the face detection section 434 of the face processing unit 433. Then at step ST125, the digital still camera 120C carries out a personal identification process for the face image to acquire personal identification information, namely, a feature value, by the personal identification section 435 of the face processing unit 433.

Then at step ST126, the digital still camera 120C decides whether or not log information of a composition evaluation value corresponding to the personal identification information obtained at step ST125 is received already from the server apparatus 130. When such log information is not received as yet, the digital still camera 120C transmits, at step ST127, the personal identification information obtained at step ST125 to the server apparatus 130 by the data transmission section 437. The digital still camera 120C ends the processing at step ST128 after the process at step ST127.

On the other hand, if the present point of time is not an acquisition timing of a camera image at step ST122, then the digital still camera 120C decides at step ST129 whether or not log information of a composition evaluation value associated with the personal identification information transmitted at step ST127 is received already by the data reception section 438. If such log information is received, then the digital still camera 120C analyzes the log information of the composition evaluation value by the log analysis section 439 to set a decision threshold value for the decision regarding whether or not the composition is acceptable at step ST130.

The digital still camera 120C advances the processing to step ST131 after the process at step ST130. Also when log information is received at step ST126 described above, the processing advances to step ST131. At step ST131, the digital still camera 120C evaluates, by the composition evaluation section 436, the composition of a main imaging object in the image information obtained by imaging by the camera 431 to obtain a composition evaluation value.

Then at step ST132, the digital still camera 120C decides whether or not the composition evaluation value obtained at step ST131 exceeds the set decision threshold value. If the composition evaluation value exceeds the set decision threshold value, then the digital still camera 120C controls, by the imaging timing controlling section 440, the shutter of the camera 431 to carry out pickup of a still image of the person 432 at step ST133. The digital still camera 120C ends the processing at step ST128 after the process at step ST133. On the other hand, if the composition evaluation value does not exceed the set decision threshold value at step ST132, then the digital still camera 120C immediately ends the processing at step ST128.

On the other hand, if log information is not received at step ST129, then the digital still camera 120C decides at step ST134 whether or not a fixed period of time elapses after the personal identification information is transmitted to the server apparatus 130 at step ST127. If the fixed period of time does not elapse, then the digital still camera 120C immediately ends the processing at step ST128.

If the fixed period of time elapses at step ST134, then the digital still camera 120C sets the decision threshold value for the decision of the acceptability of the composition to a default value at step ST135 and then advances the processing to step ST131. In particular, such lapse of the fixed period of time signifies that log information of a composition evaluation value associated with the personal identification information is not stored in the database 303. Consequently, setting of a decision threshold value for the decision of the composition acceptability by analysis of log information of a composition evaluation value cannot be carried out. Therefore, in this instance, the decision threshold value for the decision of the composition acceptability is set to the default value, and then succeeding processes are executed.

It is to be noted that, in the information processing system 10C of FIG. 22, the digital still camera 120C analyzes log information of a composition evaluation value to set a decision threshold value for the decision of the composition acceptability with regard to a person or individual specified by the personal identification information. However, although detailed description is omitted herein, it is possible to use another configuration wherein such setting of a decision threshold value for the decision of the composition acceptability is carried out by the server apparatus 130 or the personal computer 110C which is a log information collection apparatus similarly as in the case of the setting of a threshold value for the smile by the information processing system 10A described hereinabove (refer to FIGS. 13 to 16).

In the information processing system 10C shown in FIG. 22, since a decision threshold value for the decision of the composition acceptability is set based on log information of a composition evaluation value associated with a person, the decision threshold value for the decision of the composition acceptability is automatically optimized for each user. Accordingly, each person can carry out still imaging by composition detection favorably at a timing at which a desired composition is obtained.

### Particular Example 4 of Information Process System

### Evaluation of Voice Emotion

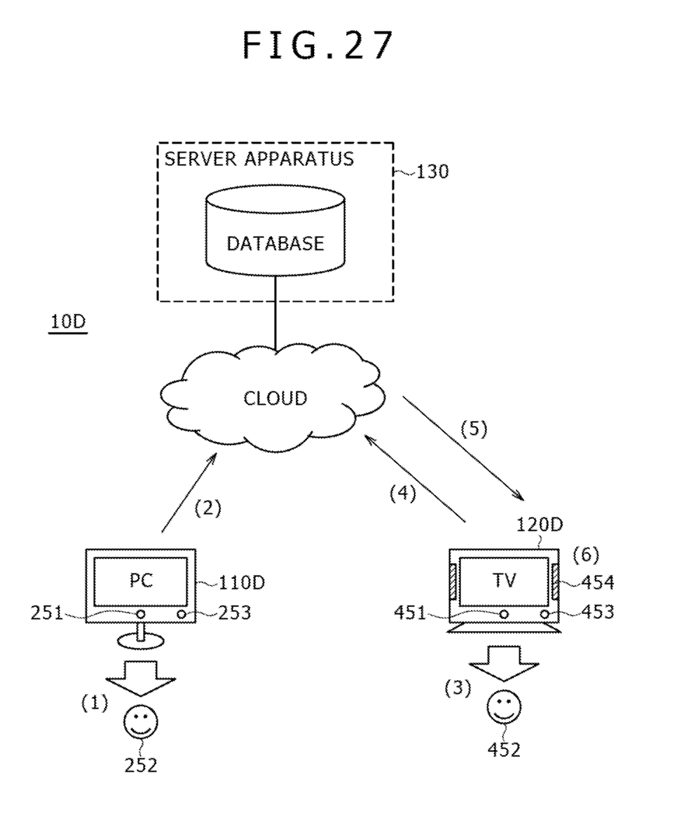

Now, a particular example 4 of the information processing system 10 is described. FIG. 27 shows an example of a configuration of an information processing system 10D wherein the log information collection apparatus is a personal computer (PC) 110D and the decision execution apparatus is a television receiver (TV) 120D. Further, in the present information processing system 10D, the evaluation information is voice information, and the voice evaluation information is information for evaluating the voice emotion of a person. The voice emotion includes “pleasure,” “sadness,” “anger,” “surprise,” “happiness” and so forth. In order to simplify, it is assumed that the voice emotion is “pleasure.”

Referring to FIG. 27, the information processing system 10D includes a personal computer 110D, a television receiver 120D, and a server apparatus 130. The server apparatus 130 exists on a cloud, namely, on a network. The personal computer 110D and the television receiver 120D can individually communicate with the server apparatus 130 on the cloud.

The personal computer 110D collects log information of a pleasure evaluation value associated with personal identification information. The personal computer 110D (1) images a person 252 by a camera 251 serving as an imaging section to obtain image information. The personal computer 110D detects a face image from the image information and carries out a personal identification process for the face image to obtain personal identification information.

Further, the personal computer 110D evaluates or estimates voice emotion, namely, the pleasure, of a sound signal or sound information obtained by catching voice of the person 252 by a microphone 253 to obtain a pleasure evaluation value. (2) The personal computer 110D sends the pleasure evaluation value to the server apparatus 130 on the cloud together with the personal identification information. The server apparatus 130 stores the pleasure evaluation value sent thereto from the personal computer 110D into a database in an associated relationship with the personal identification information.

The television receiver 120D (3) images a person 452 to obtain image information. The television receiver 120D detects the face from the image information and carries out a personal identification process for the face image to obtain personal identification information. (4) The television receiver 120D sends the personal identification information to the server apparatus 130 and (5) receives log information of a pleasure evaluation value stored in an associated relationship with the personal identification information in the server apparatus 130 from the server apparatus 130.

The television receiver 120D analyzes the log information to set a predetermined number of threshold values for distinguishing a degree of the pleasure. Further, the television receiver 120D evaluates or estimates voice emotion, namely, the pleasure, based on a voice signal, namely, voice information, obtained by catching the voice of the person 452 by a microphone 453 to obtain a pleasure evaluation value. Then, the television receiver 120D compares the pleasure evaluation value with the threshold values to decide to which one of the stages the pleasure belongs. (6) The television receiver 120D outputs sound corresponding to a result of the decision from a speaker 454.

For example, if the degree of the pleasure is at a high stage, then the television receiver 120D may output such speech as “Congratulations! It was good!” but if the degree of the pleasure is at such a low stage as is near to the sadness, then the television receiver 120D may output such speech as “Cheer up!” Or not words but music conforming to the stage of the pleasure may be outputted. Or, a sound output may not be used, but content, namely, a program, conforming to the stage of the pleasure, may be displayed as recommended content on the display section.

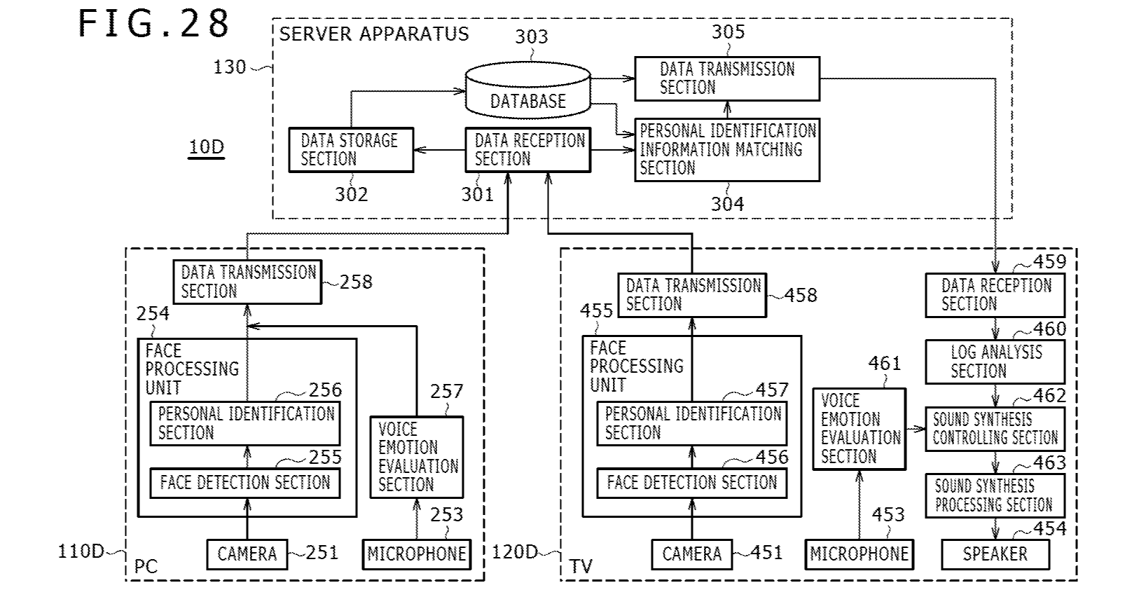

FIG. 28 shows an example of a block configuration of components of the information processing system 10D. Referring to FIG. 28, the personal computer 110D includes a camera 251 serving as an imaging section, a microphone 253, a face processing unit 254, a voice emotion evaluation section 257, and a data transmission section 258. The camera 251 images a person 252 to obtain image information as described hereinabove.

The face processing unit 254 includes a face detection section 255 and a personal identification section 256. In the face processing unit 254, the face detection section 255 detects the face from image information obtained by imaging by the camera 251. This face detection can be carried out using a method which is used in a general camera. For example, an example of a face detection method is disclosed in Japanese Patent Laid-Open No. 2008-42319.

Further, in the face processing unit 254, the personal identification section 256 carries out a personal identification process for the face image to obtain personal identification information. The personal identification section 256 outputs, for example, a feature value with which a person can be identified as the personal identification information. This personal identification can be carried out using a popular method as is used in the field of securities or by a function of a camera of identifying a person. For example, an example of the personal identification method is disclosed in Japanese Patent Laid-Open No. 2010-61465.

The microphone 253 catches the voice of the person 252 to obtain a sound signal, namely, sound information. The voice emotion evaluation section 257 evaluates or estimates the voice emotion, namely, the pleasure, of the sound signal or sound information, to obtain a pleasure evaluation value. An example of an estimation method of voice emotion is disclosed, for example, in Japanese Patent Laid-Open No. 2006-71936.

The data transmission section 258 sends the pleasure evaluation value obtained by the voice emotion evaluation section 257 to the server apparatus 130 together with the personal identification information obtained by the personal identification section 256 so as to be stored into a database. In this manner, the series of processes by the personal computer 110D after the imaging of the person 252 until the pleasure evaluation value is transmitted to the server apparatus 130 together with the personal identification information is carried out, for example, in response to an explicit operation of the user or automatically upon voice inputting of the person 252.

The server apparatus 130 includes a data reception section 301, a data storage section 302, a database 303, a personal identification information matching section 304, and a data transmission section 305. The data reception section 301 receives personal identification information and a pleasure evaluation value sent thereto from the personal computer 110D and receives personal identification information sent thereto from the television receiver 120D.

If the data reception section 301 receives personal identification information and a pleasure evaluation value from the personal computer 110D, then the data storage section 302 stores the pleasure evaluation value as log information into the database 303 in an associated relationship with the personal identification information. If the data reception section 301 receives personal identification information from the television receiver 120D, then the personal identification information matching section 304 carries out a matching process between the personal identification information and personal identification information stored in the database 303.

Then, the personal identification information matching section 304 searches the database 303 to detect whether or not log information of a pleasure evaluation value corresponding to the personal identification information from the television receiver 120D is stored in the database 303. If log information of a pleasure evaluation value corresponding to the personal identification information from the television receiver 120D is stored in the database 303, then the data transmission section 305 transmits the log information of the pleasure evaluation value to the television receiver 120D together with the personal identification information.

The television receiver 120D includes a camera 451 serving as an imaging section, a microphone 453, a speaker 454, a face processing unit 455 and a data transmission section 458. The television receiver 120D further includes a data reception section 459, a log analysis section 460, a voice emotion evaluation section 461, a sound synthesis controlling section 462 and a sound synthesis processing section 463.

The camera 451 images a person 452 to obtain image information as described hereinabove. The face processing unit 455 includes a face detection section 456 and a personal identification section 457. In the face processing unit 455, the face detection section 456 detects the face from image information obtained by imaging by the camera 451. The face detection section 456 is configured similarly to the face detection section 255 of the personal computer 110D described hereinabove and carries out the face detection using a method used in a general camera.

Further, in the face processing unit 455, the personal identification section 457 carries out a personal identification process for the face image to obtain personal identification information. The personal identification section 457 is configured similarly to the personal identification section 256 of the personal computer 110D described hereinabove and carries out the personal identification by such a general method as is used in the security field or by a function of a camera for identifying a person. The data transmission section 458 sends the personal identification information obtained by the personal identification section 457 to the server apparatus 130.

The data reception section 459 receives personal identification information and log information of a pleasure evaluation value sent thereto from the server apparatus 130 as described hereinabove. The log analysis section 460 analyzes the log information of the pleasure evaluation value to set a predetermined number of threshold values for distinguishing a degree of pleasure. The microphone 453 catches the voice of the person 452 to obtain a sound signal, namely, sound information. The voice emotion evaluation section 461 evaluates or estimates voice emotion, namely, the pleasure, of the sound signal or sound information to obtain a pleasure evaluation value. The voice emotion evaluation section 461 is configured similarly to the voice emotion evaluation section 257 of the personal computer 110D described hereinabove.

The sound synthesis controlling section 462 compares the pleasure evaluation value obtained by the voice emotion evaluation section 461 with the threshold values set by the log analysis section 460 to decide to which one of stages of the pleasure the pleasure belongs. Then, the sound synthesis controlling section 462 controls the sound synthesis processing section 463 based on a result of the decision. The sound synthesis processing section 463 synthesizes a sound signal for obtaining sound corresponding to a result of the decision regarding to which stage the pleasure belongs. The speaker 454 outputs sound based on the synthesized sound signal.

Operation of the information processing system 10D shown in FIG. 28 is described. First, operation upon log information collection is described. The camera 251 of the personal computer 110D images the person 252 to obtain image information. The face processing unit 254 detects the face from the image information by the face detection section 255. Then, the personal identification section 256 carries out a personal identification process for the face image to obtain personal identification information.

The voice of the person 252 is caught by the microphone 253 to obtain a sound signal, namely, sound information. The sound signal is supplied to the voice emotion evaluation section 257. The voice emotion evaluation section 257 evaluates or estimates the voice emotion, namely, the pleasure, of the sound signal or sound information to obtain a pleasure evaluation value. Then, the data transmission section 258 transmits the pleasure evaluation value obtained by the voice emotion evaluation section 257 as log information to the server apparatus 130 together with the personal identification information obtained by the personal identification section 256.

It is to be noted that the series of processes by the personal computer 110D after the imaging of the person 252 until the log information of the pleasure evaluation value is transmitted to the server apparatus 130 together with the personal identification information is carried out, for example, in response to an explicit operation of the user. In this instance, to the pleasure evaluation value, environment information and so forth may be added in addition to information of the date and time.

The personal identification information and the log information of the pleasure evaluation value sent from the personal computer 110D are received by the data reception section 301 of the server apparatus 130. Then, the server apparatus 130 stores the log information of the pleasure evaluation value received in this manner into the database 303 in an associated relationship with the personal identification information. In this manner, log information of the pleasure evaluation value corresponding to a predetermined number of persons is identifiably stored in the database 303 of the server apparatus 130.

Now, operation upon log information utilization is described. The camera 451 of the television receiver 120D images a person 452 to obtain image information. This image information is supplied to the face processing unit 455. The face processing unit 455 detects the face from the image information by the face detection section 456. Then, the personal identification section 457 carries out a personal identification process for the face image to obtain personal identification information. This personal identification information is sent to the server apparatus 130 by the data transmission section 458.

The personal identification information sent from the television receiver 120D is received by the data reception section 301 of the server apparatus 130 and sent to the personal identification information matching section 304. The personal identification information matching section 304 searches the database 303 to detect whether or not log information of a pleasure evaluation value corresponding to the personal identification information from the television receiver 120D is stored in the database 303. If corresponding log information of the pleasure evaluation value is stored, then the data transmission section 305 transmits the log information of the pleasure evaluation value to the television receiver 120D together with the personal identification information.

The personal identification information and the log information of the pleasure evaluation value sent from the server apparatus 130 are received by the data reception section 459 of the television receiver 120D. The personal identification information and the log information of the pleasure evaluation value are supplied to the log analysis section 460. The log analysis section 460 analyzes the log information of the pleasure evaluation value to set a predetermined number of threshold values for the distinction of the degree of the pleasure. The threshold values are supplied to the sound synthesis controlling section 462.

Meanwhile, voice of the person 452 is caught by the microphone 453 to obtain a sound signal, namely, sound information. This sound signal is supplied to the voice emotion evaluation section 461. The voice emotion evaluation section 461 evaluates or estimates the voice emotion, namely, the pleasure, of the sound signal or sound information to obtain a pleasure evaluation value. The pleasure evaluation value is supplied to the sound synthesis controlling section 462.

The sound synthesis controlling section 462 compares the pleasure evaluation value obtained from the voice emotion evaluation section 461 with the threshold value set by the log analysis section 460 to decide to which one of the stages the pleasure belongs. Then, the sound synthesis controlling section 462 controls the sound synthesis processing section 463 based on a result of the decision. The sound synthesis processing section 463 synthesizes a sound signal for obtaining voice corresponding to a result of the decision regarding to which one of the stages the pleasure belongs. Then, the synthesized sound signal is supplied to the speaker 454, from which voice based on the synthesized sound signal is outputted.

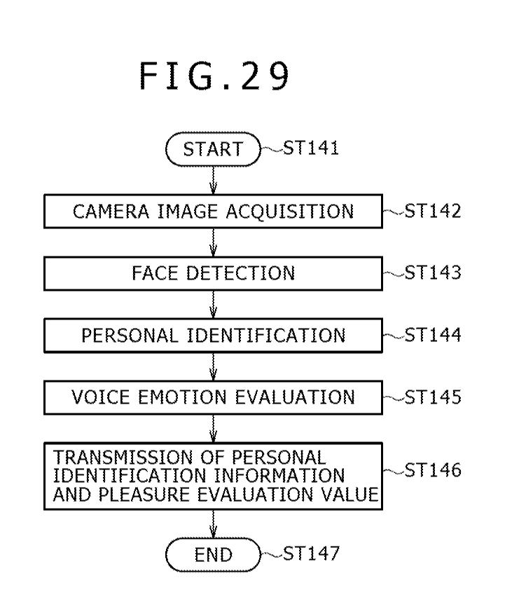

FIG. 29 illustrates an example of a processing flow of the personal computer 110D. Referring to FIG. 29, the personal computer 110D starts processing at step ST141 and then advances the processing to step ST142. The processing is started, for example, in response to an explicit operation of the user. At step ST142, the personal computer 110D images a person 252 by the camera 251.

Then at step ST143, the personal computer 110D detects the face from the image information by the personal identification section 256 of the face processing unit 254. Then at step ST144, the personal computer 110D carries out a personal identification process for the face image by the personal identification section 256 of the face processing unit 254 to obtain personal identification information, namely, a feature value.

Then at step ST145, the personal computer 110D evaluates or estimates, by the voice emotion evaluation section 257, a sound signal or sound information of the person 252 obtained by the microphone 253 to obtain a pleasure evaluation value. Then at step ST146, the personal computer 110D transmits the personal identification information obtained at step ST144 and the pleasure evaluation value obtained at step ST145 in a paired relationship with each other to the server apparatus 130. The personal computer 110D ends the processing at step ST147 after the process at step ST146.

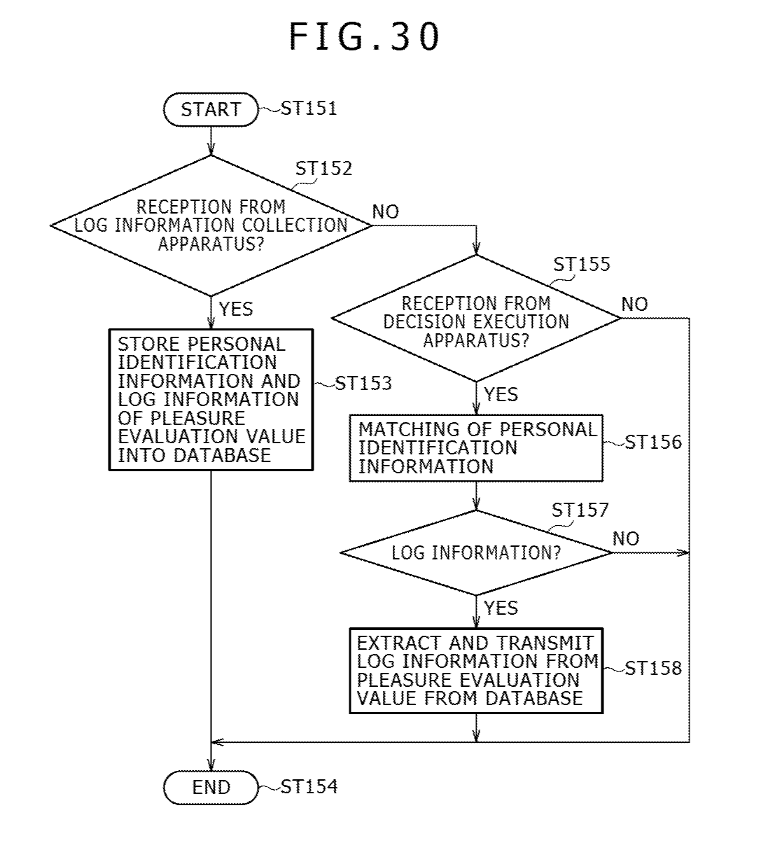

FIG. 30 illustrates an example of a processing flow of the server apparatus 130. The server apparatus 130 repetitively executes the processing flow after every predetermined interval of time. Referring to FIG. 30, the server apparatus 130 starts processing at step ST151 and then advances the processing to step ST152. At step ST152, the server apparatus 130 decides whether or not data is received from a log information collection apparatus, namely, from the personal computer 110D, by the data reception section 301.

If data is received, then the server apparatus 130 stores the received personal identification information and log information of the pleasure evaluation value into the database 303 by the data storage section 302 at step ST153. After the process at step ST153, the server apparatus 130 ends the processing at step ST154.

On the other hand, if data is not received at step ST152 described hereinabove, then the server apparatus 130 advances the processing to step ST155. At step ST155, the server apparatus 130 decides whether or not data is received from a decision execution apparatus, namely, from the television receiver 120D, by the data reception section 301. If data is not received, then the server apparatus 130 immediately ends the processing at step ST154.

On the other hand, if data is received at step ST155, then the server apparatus 130 advances the processing to step ST156. At step ST156, the server apparatus 130 carries out a matching process between the received personal identification information and the personal identification information stored in the database 303 by the personal identification information matching section 304 to search the database 303 to detect whether or not log information of a pleasure evaluation value corresponding to the personal identification information is stored in the database 303.

Then at step ST157, the server apparatus 130 decides based on a result of the search at step ST156 whether or not log information of a pleasure evaluation value corresponding to the received personal identification information is stored in the database 303. If such log information is stored, then the server apparatus 130 extracts the log information from the database 303 and transmits the log information to the television receiver 120D by the data transmission section 305 at step ST158.

The server apparatus 130 ends the processing at step ST154 after the process at step ST158. Further, if log information is not found at step ST157, then the server apparatus 130 immediately ends the processing at step ST154.

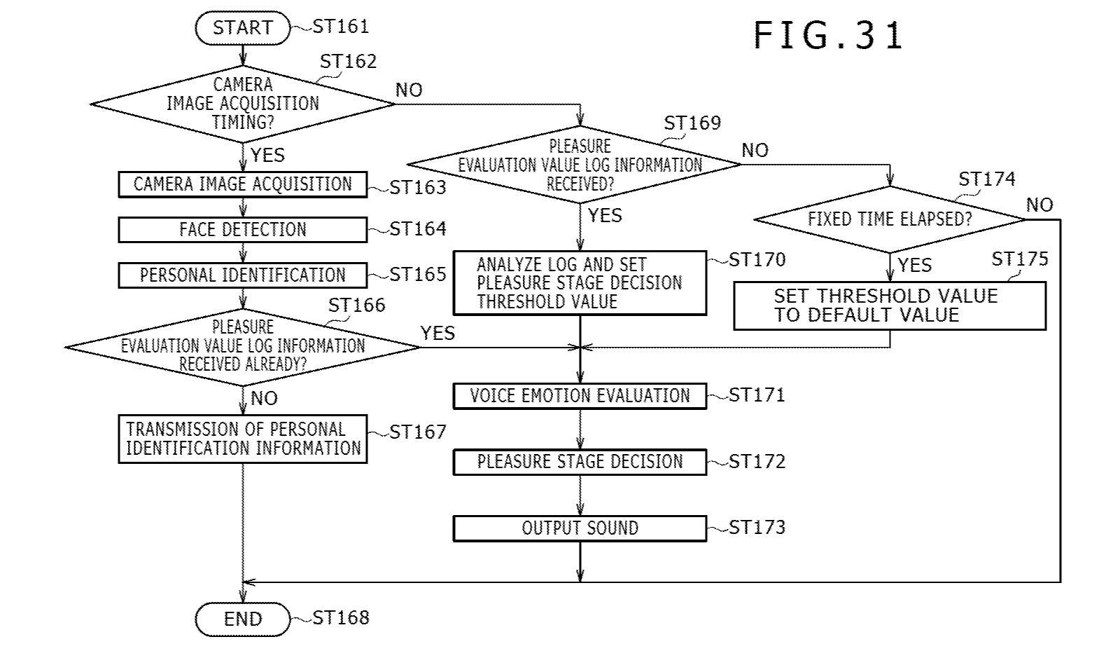

FIG. 31 illustrates an example of a processing flow of the television receiver 120D. The television receiver 120D repetitively executes the processing flow in a predetermined period. Referring to FIG. 31, the television receiver 120D starts processing at step ST161 and then advances the processing to step ST162.

At step ST162, the television receiver 120D decides whether or not the present point of time is an acquisition timing of a camera image, namely, of image information. The acquisition timing is provided, for example, in response to an explicit operation of the user. If the present point of time is an acquisition timing, then the television receiver 120D images a person 452 by the camera 451 to acquire a camera image, namely, image information, at step ST163.

Then at step ST164, the television receiver 120D detects the face from the image information by the face detection section 456 of the face processing unit 455. Then at step ST165, the television receiver 120D carries out a personal identification process for the face image by the personal identification section 457 of the face processing unit 455 to obtain personal identification information, namely, a feature value.

Then at step ST166, the television receiver 120D decides whether or not log information of a pleasure evaluation value corresponding to the personal identification information obtained at step ST165 is received already from the server apparatus 130. If such log information is not received, then the television receiver 120D transmits, at step ST167, the personal identification information obtained at step ST165 to the server apparatus 130 by the data transmission section 458. The television receiver 120D ends the processing at step ST168 after the process at step ST167.

On the other hand, if the present point of time is not an acquisition timing of a camera image at step ST162, then the television receiver 120D decides at step ST169 whether or not log information of a pleasure evaluation value associated with the personal identification information transmitted at step ST167 is received by the data reception section 459. If such log information is received, then the television receiver 120D analyzes, at step ST170, the log information of the pleasure evaluation value by the log analysis section 460 to set a predetermined number of threshold values for the distinction of a degree of the pleasure.

The television receiver 120D advances the processing to step ST171 after the process at step ST170. Also when log information is received already at step ST166 described hereinabove, the processing advances to step ST171. At step ST171, the television receiver 120D evaluates or estimates, by the voice emotion evaluation section 461, the sound signal, namely, sound information, of the person 452 obtained by the microphone 453 to obtain a pleasure evaluation value.

Then at step ST172, the television receiver 120D compares the pleasure evaluation value with the threshold values by the voice emotion evaluation section 461 to decide to which one of the stages the pleasure belongs. Then at step ST173, the television receiver 120D synthesizes a sound signal for obtaining sound of speech corresponding to a result of the decision by the sound synthesis controlling section 462 and outputs sound based on the synthesized sound signal from the speaker 454. It is to be noted that the sound based on the sound signal, which is prepared in advance, may be outputted without carrying out the sound synthesizing process.

The television receiver 120D ends the processing at step ST168 after the process at step ST173. Further, if log information is not received at step ST169, then the television receiver 120D decides, at step ST174, whether or not a fixed period of time elapses after the personal identification information is transmitted to the server apparatus 130 at step ST167. If the fixed interval of time does not elapse, then the television receiver 120D immediately ends the processing at step ST168.

On the other hand, if the fixed period of time elapses at step ST174, then the television receiver 120D sets a predetermined number of threshold values for the distinction of a degree of the pleasure to default values at step ST175. Thereafter, the processing advances to step ST171. In this instance, the lapse of the fixed period of time signifies that log information of a pleasure evaluation value associated with the personal identification information is not stored in the database 303, and setting of a threshold value by analysis of the log information of the pleasure evaluation value is impossible. Therefore, in this instance, the threshold values are set to the default values, and then succeeding processes are executed.

It is to be noted that, in the information processing system 10D of FIG. 27, the television receiver 120D analyzes log information of a pleasure evaluation value to set a predetermined number of threshold values for the distinction of a degree of the pleasure corresponding to a person or individual specified by the personal identification information. However, although detailed description is omitted herein, it is possible to use another configuration wherein such setting of a threshold value is carried out by the server apparatus 130 or the personal computer 110D, which is a log information collection apparatus, similarly as in the case of the setting of a threshold value for the smile by the information processing system 10A described hereinabove (refer to FIGS. 13 to 16).

In the information processing system 10D shown in FIG. 27, a predetermined number of threshold values for the distinction of a degree of the pleasure are set based on log information of a pleasure evaluation value associated with a person. In other words, the predetermined number of threshold values for the distinction of a degree of the pleasure are automatically optimized for each user. Accordingly, the stage of the pleasure can be decided appropriately and outputting of appropriate sound can be achieved without depending upon the personal difference in sound signal, namely, in sound information.

### Particular Example 5 of Information Process System

### Log Information Collection Apparatus and Decision Execution Apparatus are the Same Single Apparatus

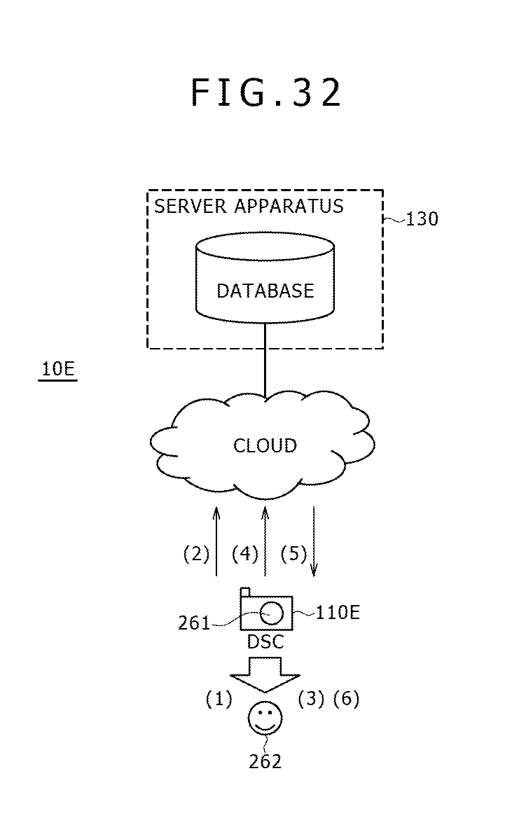

Now, a particular example 5 of the information processing system 10 is described. FIG. 32 shows an example of a configuration of an information processing system 10E wherein the log information collection apparatus and the decision execution apparatus are the same single apparatus and are a single digital still camera 110E. Further, in the present information processing system 10E, the evaluation information is image information and the image evaluation information is information for evaluating a smile of a person or individual similarly as in the information processing system 10A described hereinabove with reference to FIG. 5.

Referring to FIG. 32, the information processing system 10E is configured from the digital still camera 110E and a server apparatus 130. The server apparatus 130 exists on a cloud, namely, on a network. The digital still camera 110E is capable of communicating with the server apparatus 130 on the cloud.

The digital still camera 110E collects, upon log information collection, log information of the smile degree associated with personal identification information. The digital still camera 110E (1) images a person 262 by a camera 261 serving as an imaging section to obtain image information. The digital still camera 110E detects a face image from the image information and carries out a personal identification process for the face image to obtain personal identification information. Further, the digital still camera 110E carries out a smile recognition process for the face image to determine a smile degree.

(2) The digital still camera 110E sends the smile degree to the server apparatus 130 on the cloud together with the personal identification information. The server apparatus 130 stores the smile degree sent thereto from the digital still camera 110E into a database in an associated relationship with the personal identification information.

On the other hand, upon log information utilization, the digital still camera 110E (3) images the person 262 as an imaging object to obtain image information. The digital still camera 110E detects the face from the image information and carries out a personal identification process for the face image to obtain personal identification information. (4) The digital still camera 110E sends the personal identification information to the server apparatus 130 and (5) receives log information of a smile degree stored in an associated relationship with the personal identification information in the server apparatus 130.

The digital still camera 110E analyzes the log information to set an evaluation condition, namely, a threshold value for the smile. The digital still camera 110E carries out a smile recognition process for the face image described above to obtain a smile degree. Then, the digital still camera 110E evaluates the smile degree obtained in this manner based on the evaluation condition. (6) The digital still camera 110E decides that the facial expression is a smile when the smile degree is higher than the threshold value and then operates the shutter to carry out still imaging of the person 262 as an imaging object.

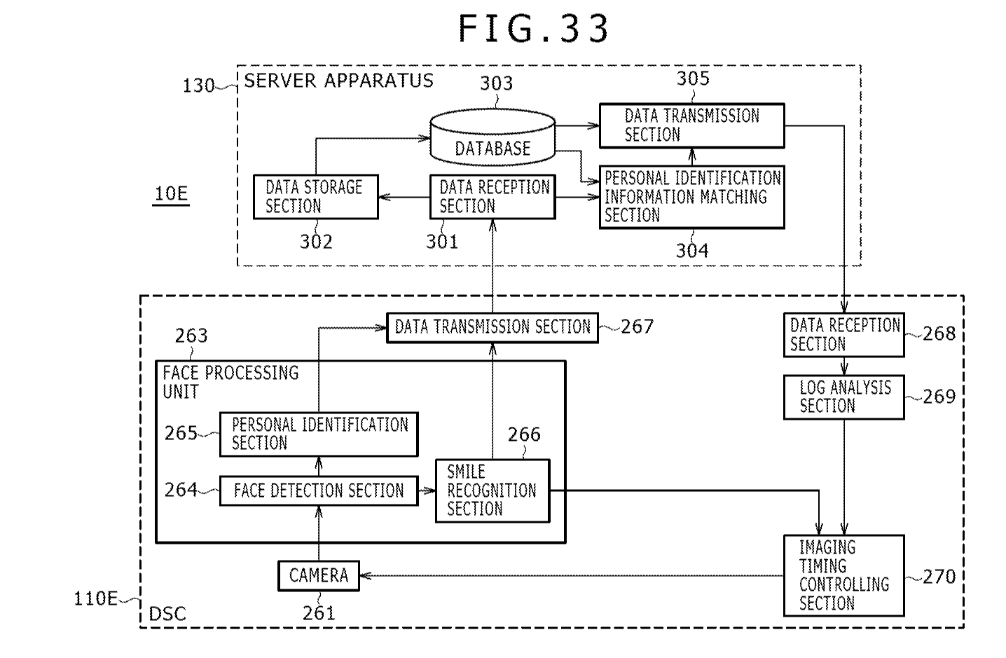

FIG. 33 shows an example of a block configuration of the components of the information processing system 10E. Referring to FIG. 33, the digital still camera 110E includes a camera 261 serving as an imaging section, a face processing unit 263 and a data transmission section 267. The digital still camera 110E further includes a data reception section 268, a log analysis section 269 and an imaging timing controlling section 270. The camera 261 picks up, upon log information collection, an image of a person 262 to obtain image information as an evaluation target, but images, upon log information utilization, the person 262 as an imaging object to obtain image information.

The face processing unit 263 is configured similarly to the face processing unit 402 of the digital still camera 120A of the information processing system 10A described hereinabove with reference to FIG. 6 and includes a face detection section 264, a personal identification section 265 and a smile recognition section 266.

The face detection section 264 detects the face from image information obtained by imaging by the camera 261. The personal identification section 265 carries out a personal identification process for the face image and outputs personal identification information, for example, a feature value with which a person can be distinguished. The smile recognition section 266 carries out a smile recognition process for the face image to obtain a smile degree, namely, a smile score, having a value within a range, for example, from 0 to 100.

Upon log information collection, the data transmission section 267 sends the smile degree obtained by the smile recognition section 266 as log information to the server apparatus 130 together with the personal identification information obtained by the personal identification section 265. The series of processes by the digital still camera 110E after the imaging of the person 262 until the smile degree is transmitted to the server apparatus 130 together with the personal identification information is carried out in response to an explicit operation of the user or automatically in response to recognition of the presence of the person 262. On the other hand, upon log information utilization, the data transmission section 267 sends only the personal identification information obtained by the personal identification section 265 to the server apparatus 130.

Upon log information utilization, the data reception section 268 receives personal identification information and log information of a smile degree sent thereto from the server apparatus 130. The log analysis section 269 analyzes the log information of the smile degree to set an evaluation condition, here, an optimum threshold value for the smile. The imaging timing controlling section 270 carries out shutter control of the camera 261 so that, upon log information utilization, when the smile degree obtained by the smile recognition section 266 exceeds the threshold value for the smile determined by the log analysis section 269, pickup of a still image may be carried out. Although detailed description is omitted herein, the log analysis section 269 and the imaging timing controlling section 270 are configured similarly to the log analysis section 408 and the imaging timing controlling section 409 of the digital still camera 120A of the information processing system 10A described hereinabove with reference to FIG. 6, respectively.

The server apparatus 130 includes a data reception section 301, a data storage section 302, a database 303, a personal identification information matching section 304 and a data transmission section 305. The data reception section 301 receives paired information of personal identification information and a smile degree sent thereto from the digital still camera 110E upon log information collection and receives personal identification information sent thereto from the digital still camera 110E upon log information utilization.

When the data reception section 301 receives personal identification information and log information of a smile degree from the digital still camera 110E, the data storage section 302 stores the smile degree into the database 303 in an associated relationship with the personal identification information. However, when the data reception section 301 receives only personal identification information from the digital still camera 110E, the personal identification information matching section 304 carries out a matching process of the personal identification information with personal identification information stored in the database 303.

Then, the personal identification information matching section 304 searches the database 303 by a matching process to detect whether or not log information of a smile degree corresponding to the personal identification information from the digital still camera 110E is stored in the database 303. If such log information of a smile degree corresponding to the personal identification information from the digital still camera 110E is stored in the database 303, then the data transmission section 305 transmits the log information of the smile degree to the digital still camera 110E together with the personal identification information.

Operation of the information processing system 10E shown in FIG. 33 is described. First, operation upon log information collection is described. The camera 201 of the digital still camera 110E images a person 262 which becomes a target of log information collection to obtain image information as an evaluation target. This image information is supplied to the face processing unit 263.

The face processing unit 263 detects the face from the image information by the face detection section 264. Then, the personal identification section 265 carries out a personal identification process for the face image to obtain personal identification information. Further, the smile recognition section 266 carries out a smile recognition process for the face image to obtain a smile degree, namely, a smile score. Then, the data transmission section 267 sends the smile degree as log information to the server apparatus 130 together with the personal identification information.

The personal identification information and the log information of the smile degree sent from the digital still camera 110E are received by the data reception section 301 of the server apparatus 130. The server apparatus 130 stores the log information of the smile degree received in this manner into the database 303 in an associated relationship with the personal identification information. In this manner, in the database 303 of the server apparatus 130, log information of the smile degree corresponding to a predetermined number of persons is identifiably stored (refer to FIGS. 7 to 9).

Now, operation upon log information utilization is described. The camera 261 of the digital still camera 110E images a person 262 as an imaging object to obtain image information as an evaluation target. This image information is supplied to the face processing unit 263. The face detection section 264 detects the face from the image information, and the personal identification section 265 carries out a personal identification process for the face image to obtain personal identification information. This personal identification information is sent to the server apparatus 130 by the data transmission section 267.

The personal identification information sent from the digital still camera 110E is received by the data reception section 301 of the server apparatus 130 and sent to the personal identification information matching section 304. The personal identification information matching section 304 searches the database 303 to detect whether or not log information of a smile degree corresponding to the personal identification information from the digital still camera 110E is included in the database 303. Then, such log information of a smile degree is extracted from the database 303 and transmitted to the digital still camera 110E by the data transmission section 305 together with the personal identification information.

The log information of the smile degree sent from the server apparatus 130 together with the personal identification information is received by the data reception section 268 of the digital still camera 110E and supplied to the log analysis section 269. The log analysis section 269 analyzes the log information of the smile degree to set, as an evaluation condition, an optimum threshold value for the smile corresponding to the person 262 as an imaging object. This threshold value for the smile is supplied to the imaging timing controlling section 270.

Further, in the face processing unit 263, the smile recognition section 266 carries out a smile recognition process for the face image to obtain a smile degree, namely, a smile score. This smile degree is supplied to the imaging timing controlling section 270. It is to be noted that, upon log information utilization, the camera 261 successively outputs image information, and consequently, the smile recognition section 266 successively carries out the process for obtaining a smile degree.

If the smile degree obtained by the smile recognition section 266 exceeds the threshold value set by the log analysis section 269, then the imaging timing controlling section 270 carries out shutter control of the camera 261 so that pickup of a still image is carried out. In this instance, the camera 261 carries out pickup of a still image of the person 262 as an imaging object and stores image information of the still image.

It is to be noted that the processing flow of the digital still camera 110E upon log information collection is similar to the processing flow illustrated in FIG. 10 of the television receiver 110A of the information processing system 10A described hereinabove with reference to FIG. 6. Further, the processing flow of the digital still camera 110E upon log information utilization is similar to the processing flow illustrated in FIG. 12 of the television receiver 110A of the information processing system 10A described hereinabove with reference to FIG. 6. Further, the processing flow of the server apparatus 130 is similar to the processing flow illustrated in FIG. 11 of the server apparatus 130 of the information processing system 10A described hereinabove with reference to FIG. 6.

In the information processing system 10E shown in FIG. 32, since a threshold value for the smile is set based on log information of a smile degree associated with a person, the threshold value for the smile is automatically optimized for each user. Accordingly, imaging by a smile detection shutter operation can be carried out favorably without depending upon a personal difference in facial expression recognition. It is to be noted that this similarly applies also when not a smile but another facial expression such as an angry or sad expression or an apparent age is detected to carry out shutter control.

### Particular Example 6 of Information Process System

### Use of Different User Collection Log Information

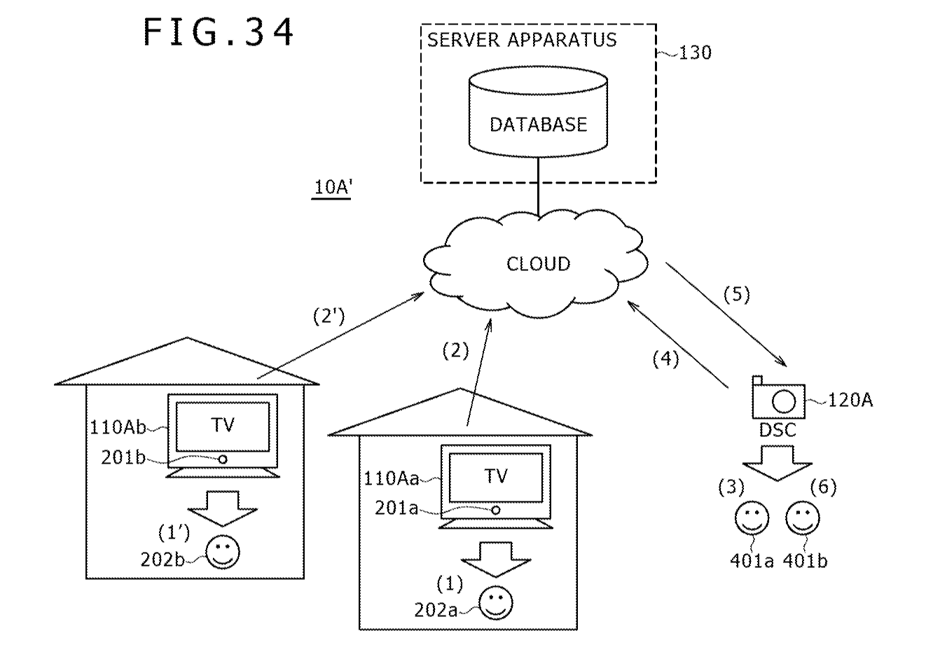

Now, a particular example 6 of the information processing system 10 is described. FIG. 34 shows an example of a configuration of an information processing system 10A′ wherein the log information collection apparatus is television receivers (TV) 110Aa and 110Ab and the decision execution apparatus is a digital still camera (DSC) 120A.

In the present configuration example, the user of the digital still camera 120A can utilize not only log information of the smile degree stored in the server apparatus 130 on the cloud by the user itself but also log information of the smile degree stored in the server apparatus 130 on the cloud by a different user. In the present information processing system 10A′, similarly to the information processing system 10A shown in FIG. 6, the evaluation information is image information and the image evaluation information is information for evaluating an expression of the face, here, a smile, of a person or individual.

Referring to FIG. 34, the information processing system 10A′ includes television receivers 110Aa and 110Ab, a digital still camera 120A and a server apparatus 130. The server apparatus 130 exists on a cloud, namely, on a network. The television receivers 110Aa and 110Ab and the digital still camera 120A are individually capable of communicating with the server apparatus 130 on the cloud. The television receivers 110Aa and 110Ab are configured similarly to the television receiver 110A of the information processing system 10A described hereinabove with reference to FIG. 6. The server apparatus 130 and the digital still camera 120A are configured similarly to the server apparatus 130 and the digital still camera 120A of the information processing system 10A described hereinabove with reference to FIG. 6, respectively.

The television receiver 110Aa is owned by a user U1 of the digital still camera 120A and collects log information of the smile degree associated with personal identification information. The television receiver 110Aa (1) images a person 202a by a camera 201a serving as an imaging section to obtain image information. The television receiver 110Aa detects a face image from the image information and carries out a personal identification process for the face image to obtain personal identification information. The television receiver 110Aa further carries out a smile recognition process for the face image to determine a smile degree. (2) The television receiver 110Aa sends the smile degree to the server apparatus 130 on the cloud together with the personal identification information. The server apparatus 130 stores the smile degree sent thereto from the television receiver 110Aa into a database in an associated relationship with the personal identification information.

Meanwhile the television receiver 110Ab is owned by a user U2 different from the user U1 of the digital still camera 120A and collects log information of the smile degree associated with personal identification information. The television receiver 110Ab (1′) images a person 202b by the camera 201b serving as an imaging section to obtain image information. The television receiver 110Ab detects a face image from the image information and carries out a personal identification process for the face image to obtain personal identification information. Further, the television receiver 110Ab carries out a smile recognition process for the face image to determine a smile degree. (2′) The television receiver 110Ab sends the smile degree to the server apparatus 130 on the cloud together with the personal identification information. The server apparatus 130 stores the smile degree sent thereto from the television receiver 110Ab into a database in an associated relationship with the personal identification information.

The digital still camera 120A (3) images persons 401a and 401b as an imaging object simultaneously to obtain image information. The digital still camera 120A detects the two faces from the image information and carries out a personal identification process for the face images to obtain personal identification information. (4) The digital still camera 120A sends the two pieces of personal identification information to the server apparatus 130 and (5) receives log information of the smile degrees stored in an associated relationship with the two pieces of personal identification information in the server apparatus 130 from the server apparatus 130.

In this instance, the log information is not limited to that collected by the user U1 of the digital still camera 120A, but may include log information collected by the different user. For example, as the log information of the smile degree corresponding to the person 401a, log information collected by the television receiver 110Aa may be utilized, and as the log information of the smile degree corresponding to the person 401b, log information collected by the television receiver 110Ab may be utilized.

The digital still camera 120A analyzes the log information to set evaluation conditions, namely, threshold values for the smile, for the individual persons. The digital still camera 120A carries out a smile recognition process for the face images of the persons to obtain smile degrees. Then, the digital still camera 120A evaluates the smile degrees of the persons obtained in this manner based on the evaluation conditions, namely, based on the threshold values for the smiles, of the persons. (6) The digital still camera 120A decides, for example, when the smile degrees of the persons are higher than the corresponding threshold values, that the persons have a smile, and operates the shutter to carry out pickup of a still image of the persons 401a and 401b.

### Conversion of Image Evaluation Information

For example, in the information processing system described hereinabove with reference to FIG. 1, such a situation may possibly occur that evaluation by the evaluation section 112 of the log information collection apparatus 110 and evaluation by the evaluation section 124 of the decision execution apparatus 120 are different from each other. For example, such a different may occur in the case where evaluation engines different from each other are used in the evaluation section 112 and the evaluation section 124 or in the case where, when a particular facial expression is evaluated from image information, the brightness in an imaging environment is different. Here, the “evaluation engine” signifies a mechanism, a function or a program for evaluating an inputted image utilizing a predetermined image process.

In this instance, the decision execution apparatus 120 may convert evaluation information such as image evaluation information and/or sound evaluation information sent thereto as log information from the server apparatus 130 into an appropriate value to be used based on information of an evaluation engine, environment information and so forth.

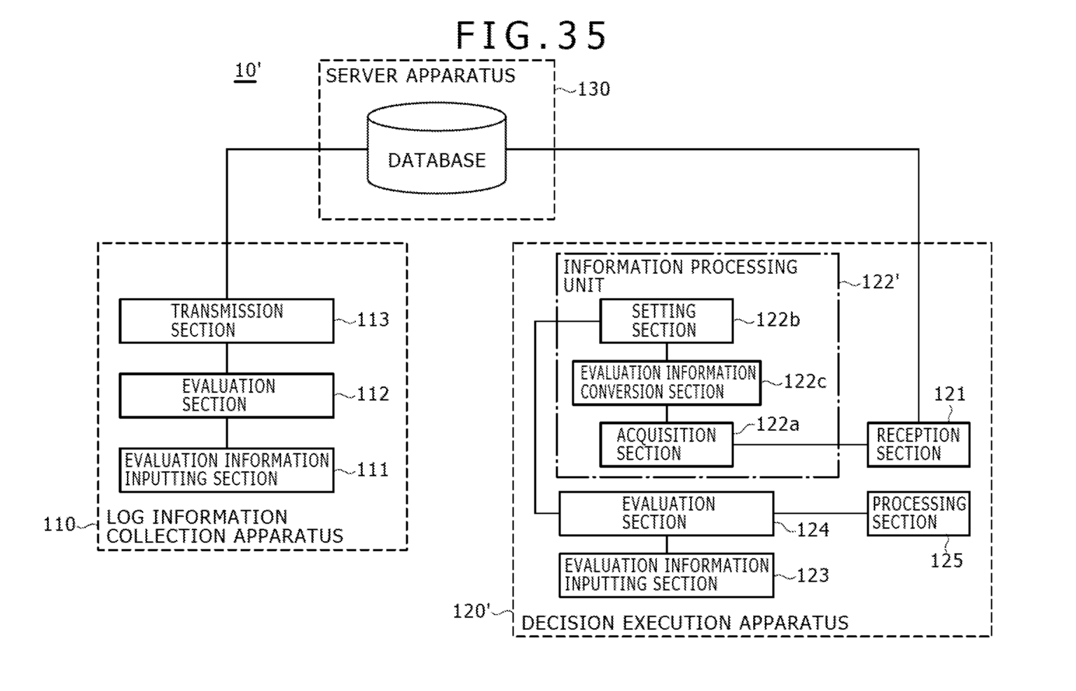

FIG. 35 shows an example of an information processing system 10′ in the case just described.

Referring to FIG. 35, the information processing system 10′ is configured from a log information collection apparatus 110, a decision execution apparatus 120′ and a server apparatus 130. An information processing unit 122′ of the decision execution apparatus 120′ includes an evaluation information conversion section 122c in addition to an acquisition section 122a and a setting section 122b. The evaluation information conversion section 122c is interposed between the acquisition section 122a and the setting section 122b.

The evaluation information conversion section 122c converts evaluation information, which is log information acquired by the acquisition section, into an appropriate value based on information of the evaluation engine, environment information and so forth. The setting section 122b sets an evaluation condition corresponding to a person specified by the personal identification information based on the log information of the display information after the conversion.

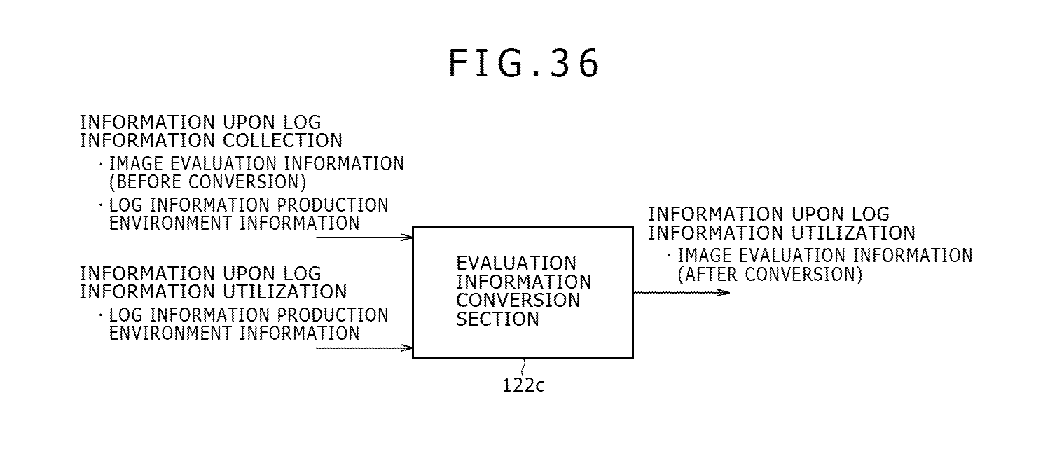

FIG. 36 shows an example of a configuration of the evaluation information conversion section 122c. Referring to FIG. 36, the evaluation information conversion section 122c is configured, for example, from a conversion table. The evaluation information conversion section 122c receives information upon log information collection and information upon log information utilization as inputs thereto and outputs information upon log information utilization.

The inputted information upon log information collection includes evaluation information Ia which is log information, log information production environment information, which is evaluation environment information conforming to an evaluation engine ID, the Exif and so forth. Meanwhile, the inputted information upon log information utilization includes log information utilization environment information, which is evaluation environment information conforming to the evaluation engine ID, the Exif and so forth. Further, the outputted information upon log information utilization includes evaluation information Ib which is log information after the conversion. Here, the “evaluation engine ID” is information for identifying the “evaluation engine.”

Although the evaluation information conversion section 122c essentially requires evaluation information which is log information as input information thereto, it can suitably and selectively use the other information. For example, only the evaluation engine ID may be used, or when image evaluation information is handled, only information of the brightness may be used or the evaluation engine ID may be used additionally.

A particular example of the conversion process by the evaluation information conversion section 122c is described. First, an example of a conversion process in the case where a correspondence between an image evaluation engine Ea upon log information collection and an image evaluation engine Eb used upon log information utilization is known is described.

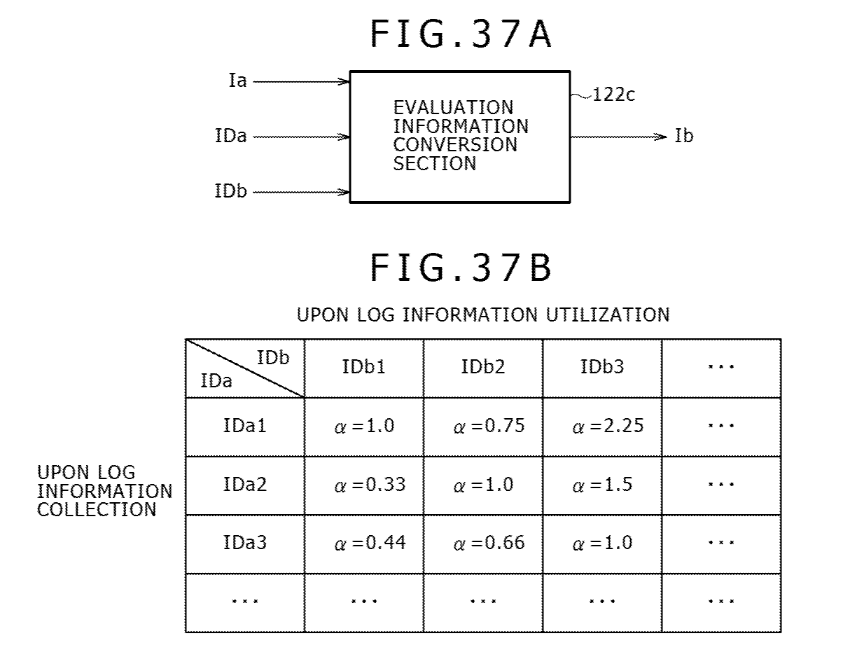

In this instance, to the evaluation information conversion section 122c, an identifier IDa of the image evaluation engine Ea and an identifier IDb of the image evaluation engine Eb are inputted in addition to the evaluation information Ia, for example, as seen in FIG. 37A. The evaluation information conversion section 122c uses a conversion coefficient α corresponding to the combination of the identifier IDa and the identifier IDb to convert the evaluation information Ia into the evaluation information Ib as represented by the following expression (1):

Ib=Ia*α (1)

FIG. 37B illustrates an example of the conversion coefficient α determined by the identifier IDa and the identifier IDb. For example, it is assumed that it is known that the image evaluation engine Ea (IDa=IDa1) has a tendency to evaluate the smile degree higher by 33% than the image evaluation engine Eb (Idb=IDb2). In this instance, since the conversion coefficient α is determined as α=0.75, the evaluation information Ia is converted into an appropriate value in accordance with the expression (1).

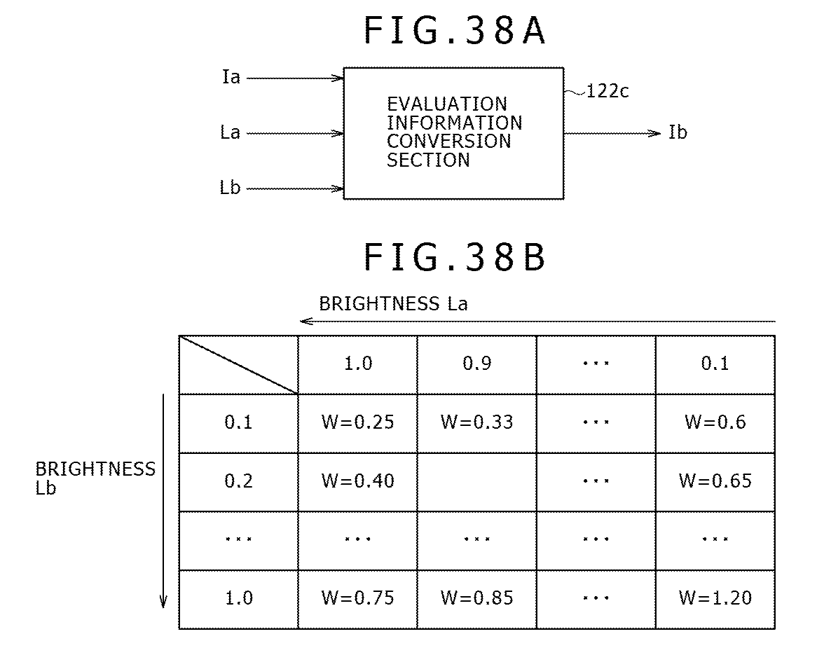

Now, an example of a conversion process in the case where the evaluation value varies in response to the brightness upon evaluation is described. In this instance, to the evaluation information conversion section 122c, brightness information La and brightness information Lb are inputted in addition to evaluation information Ia, for example, as seen in FIG. 38A. Then, the evaluation information conversion section 122c uses a conversion coefficient W corresponding to the combination of the identifier IDa and the identifier IDb to convert the evaluation information Ia into the evaluation information Ib as given by the following expression (2):

Ib=Ia*W (2)

Since the evaluation value of a smile sometimes differs depending upon the brightness, the conversion coefficient W is determined taking this into consideration. For example, a tendency that the degree of the smile is evaluated higher as the brightness becomes higher is known, and in the case where the brightness upon log utilization is higher than the brightness upon log collection, the conversion coefficient W is determined so as to raise the smile degree. On the contrary, a tendency that the degree of the smile is evaluated higher as the brightness becomes higher is known, and when the brightness upon log utilization is lower than the brightness upon log collection, the conversion coefficient W is determined so as to decrease the smile degree. FIG. 38B illustrates an example of the conversion coefficient W determined from the brightness information La and the brightness information Lb. For example, when La=0.1 and Lb=1.0, the conversion coefficient W is determined as W=1.2. Further, for example, when La=1.0 and Lb=0.1, the conversion coefficient W is determined as W=0.25.

It is to be noted that the conversion expression when the evaluation information conversion section 122c converts evaluation information based on both of the evaluation engine and the brightness is given as the following expression (3):

Ib=Ia*α*W (3)

Also it is possible to use log information as a set. Therefore, values of the conversion coefficients (individual) α and W included in the set are averaged to calculate conversion coefficients (set) α(ave) and W(ave) to be used for the conversion. The conversion expression in this instance is such as given by the following expression (4):

Ib=Ia(ave)α(ave)*W(ave) (4)

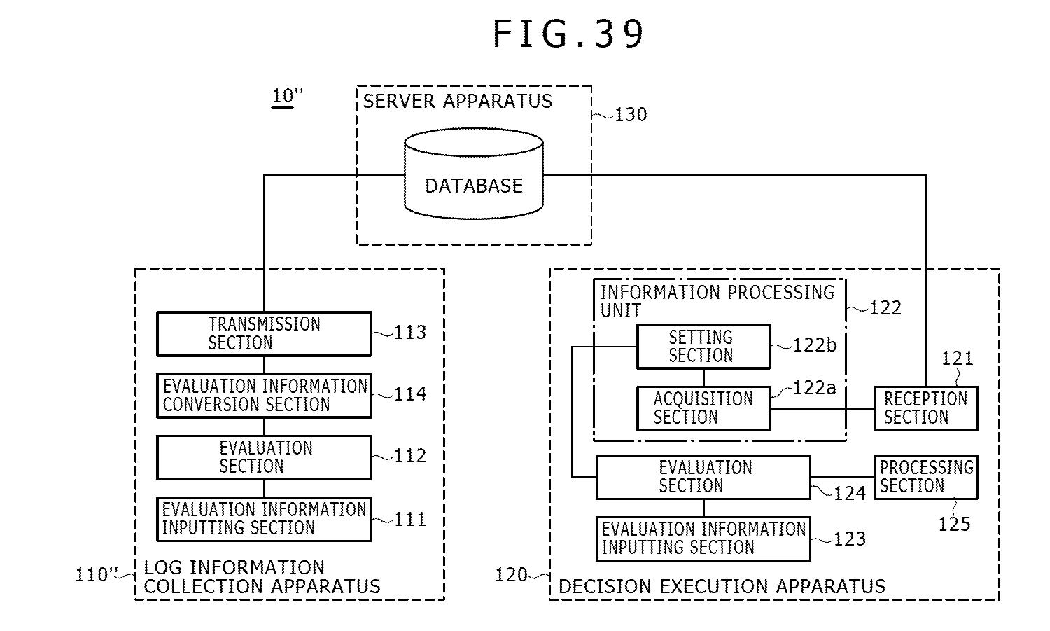

The information processing system 10′ shown in FIG. 35 is an example wherein the evaluation information conversion section is provided on the decision execution apparatus side. However, also it is possible to provide the evaluation information conversion section on the log information collection apparatus side. FIG. 39 shows an example of an information processing system 10″ in this instance.

Referring to FIG. 39, the information processing system 10″ is configured from a log information collection apparatus 110″, a decision execution apparatus 120 and a server apparatus 130. In the log information collection apparatus 110″, an evaluation information conversion section 114 is interposed between the evaluation section 112 and the transmission section 113. The evaluation information conversion section 114 converts evaluation information, which is log information acquired by the acquisition section, into an appropriate value based on the information of the evaluation engine, environment information and so forth. The transmission section 113 transmits the evaluation information obtained by the conversion by the evaluation information conversion section 114 to the server apparatus 130 so as to be stored.

### 2. Modification

It is to be noted that, while, in the embodiment described hereinabove, a television receiver, a digital still camera, a personal computer and so forth are described as particular examples of the log information collection apparatus 110, preferably the log information collection apparatus 110 is an apparatus which is viewed casually by a user. For example, the log information collection apparatus 110 may not be a television receiver, a digital still camera or a personal computer but be a TV phone, a surveillance camera, a photo frame or the like. Further, while, in the embodiment described hereinabove, a digital still camera, a television receiver and so forth are described as particular examples of the decision execution apparatus 120, the decision execution apparatus 120 may otherwise be a digital signage apparatus, a portable terminal or the like. For example, in a digital signage apparatus, a threshold value for a smile for which the present technology is used can be set to each of a plurality of viewers to carry out grasping of the number of smiling individuals or persons and so forth accurately.

Further, in the embodiment described hereinabove, log information of evaluation information is stored into the server apparatus 130 on the cloud. However, also it is possible to use a configuration wherein the decision execution apparatus, namely, the log information utilization apparatus, establishes wire or wireless connection to the log information collection apparatus such that log information is acquired directly. Further, where the log information collection apparatus and the decision execution apparatus are the same single apparatus, the log information may be stored in the apparatus itself.

Further, while, in the embodiment described hereinabove, log information of evaluation information of image information or sound information is handled, the present technology can be applied also where log information of other evaluation information is handled. For example, log information of evaluation information relating to the health of a person such as the heart rate or the body temperature may be handled such that the decision execution apparatus side carries out appropriate health decision for each person.

The present technology can take also such configurations as given below.

(1) An information processing apparatus, including:

an acquisition section configured to acquire personal identification information for identifying a person relating to first image information and image evaluation information produced by evaluating the first image information in accordance with an image of a main imaging object detected based on the first image information; and

a setting section configured to set an evaluation condition for evaluating second image information based on the personal identification information and the image evaluation information.

(2) The information processing apparatus according to (1), wherein

the image evaluation information acquired by the acquisition section has environment information upon evaluation added thereto, and

the setting section sets an evaluation condition for evaluating the second image information based on the image evaluation information produced by evaluation in a predetermined environment selected based on the environment information.

(3) The information processing apparatus according to (1) or (2), wherein

the image evaluation information is information for evaluating a facial expression of the person specified by the personal identification information when the person is viewing displayed content;

the image evaluation information acquired by the acquisition section has added thereto content identification information for identifying displayed content upon evaluation; and

the setting section sets an evaluation condition for evaluating the second image information based on the image evaluation information and the content identification information.

(4) The information processing apparatus according to any one of (1) to (3), further including

a conversion section configured to convert the image evaluation information acquired by the acquisition section in accordance with an evaluation engine upon the evaluation and an evaluation engine for evaluating the second image information,

the setting section setting an evaluation condition for evaluating the second image information based on the image evaluation information obtained by the conversion by the conversion section.

(5) The information processing apparatus according to any one of (1) to (4), further including

a conversion section configured to convert the image evaluation information acquired by the acquisition section in accordance with an environment upon the evaluation and an environment for evaluating the second image information,

the setting section setting an evaluation condition for evaluating the second image information based on the image evaluation information obtained by the conversion by the conversion section.

(6) The information processing apparatus according to any one of (1) to (5), wherein the image evaluation information is information for evaluating a facial expression of the person specified by the personal identification information.

(7) The information processing apparatus according to any one of (1) to (5), wherein the image evaluation information is information for evaluating a composition associated with the person specified by the personal identification information.

(8) The information processing apparatus according to any one of (1) to (5), wherein the image evaluation information is information for evaluating an interest degree in displayed content of the person specified by the personal identification information.

(9) An information processing method, including:

acquiring personal identification information for identifying a person relating to first image information and image evaluation information produced by evaluating the first image information in accordance with an image of a main imaging object detected based on the first image information; and

setting an evaluation condition for evaluating second image information based on the personal identification information and the image evaluation information.

(10) A program for causing a computer to function as:

acquisition means for acquiring personal identification information for identifying a person relating to first image information and image evaluation information produced by evaluating the first image information in accordance with an image of a main imaging object detected based on the first image information; and

setting means for setting an evaluation condition for evaluating second image information based on the personal identification information and the image evaluation information.

(11) An information processing apparatus, including:

an evaluation section configured to evaluate second image information based on an evaluation condition; and

a processing section configured to be controlled based on a result of the evaluation;

the evaluation condition being set based on personal identification information for identifying a person relating to first image information and image evaluation information produced by evaluating the first image information in accordance with an image of a main imaging object detected based on the first image information.

(12) The information processing apparatus according to (11), wherein

the processing section is an imaging section;

the second image information is obtained by the imaging section; and

a shutter timing of the imaging section is controlled based on a result of the evaluation.

(13) The information processing apparatus according to (12), wherein the image evaluation information is information for evaluating a facial expression of the person specified by the personal identification information.

(14) The information processing apparatus according to (12), wherein the image evaluation information is information for evaluating a composition associated with the person specified by the personal identification information.

(15) The information processing apparatus according to (11), wherein

the processing section is a display section;

the second image information is image information of displayed content which can be displayed on the display section; and

display of recommended content on the display section is controlled based on a result of the evaluation.

(16) An information processing method, including:

evaluating second image information based on an evaluation condition; and

controlling a processing section based on a result of the evaluation;

the evaluation condition being set based on personal identification information for identifying a person relating to first image information and image evaluation information produced by evaluating the first image information in accordance with an image of a main imaging object detected based on the first image information.

(17) A program for causing a computer to function as:

evaluation means for evaluating second image information based on an evaluation condition; and

processing means for being controlled based on a result of the evaluation;

the evaluation condition being set based on personal identification information for identifying a person relating to first image information and image evaluation information produced by evaluating the first image information in accordance with an image of a main imaging object detected based on the first image information.

(18) An information processing apparatus, including:

an acquisition section configured to acquire personal identification information for identifying a person relating to first sound information and sound evaluation information produced by evaluating the first sound information; and

a setting section configured to set an evaluation condition for evaluating second sound information based on the personal identification information and the sound evaluation information.

(19) An information processing apparatus, including:

an evaluation section configured to evaluate second sound information based on an evaluation condition; and

a processing section configured to be controlled based on a result of the evaluation;

the evaluation condition being set based on personal identification information for identifying a person relating to first sound information and sound evaluation information produced by evaluating the first sound information.

The present disclosure contains subject matter related to that disclosed in Japanese Priority Patent Application JP 2011-275269 filed in the Japan Patent Office on Dec. 16, 2011, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. An information processing apparatus, comprising:
an acquisition section configured to acquire personal identification information for identifying a person relating to first image information and image evaluation information produced by evaluating the first image information in accordance with an image of a main imaging object detected based on the first image information; and
a setting section configured to set an evaluation condition for evaluating second image information based on the personal identification information and the image evaluation information.

2. The information processing apparatus according to claim 1, wherein
the image evaluation information acquired by the acquisition section has environment information upon evaluation added thereto, and
the setting section sets an evaluation condition for evaluating the second image information based on the image evaluation information produced by evaluation in a predetermined environment selected based on the environment information.

3. The information processing apparatus according to claim 1, wherein
the image evaluation information is information for evaluating a facial expression of the person specified by the personal identification information when the person is viewing displayed content,
the image evaluation information acquired by the acquisition section has added thereto content identification information for identifying displayed content upon evaluation, and
the setting section sets an evaluation condition for evaluating the second image information based on the image evaluation information and the content identification information.

4. The information processing apparatus according to claim 1, further comprising
a conversion section configured to convert the image evaluation information acquired by the acquisition section in accordance with an evaluation engine upon the evaluation and an evaluation engine for evaluating the second image information,
the setting section setting an evaluation condition for evaluating the second image information based on the image evaluation information obtained by the conversion by the conversion section.

5. The information processing apparatus according to claim 1, further comprising
a conversion section configured to convert the image evaluation information acquired by the acquisition section in accordance with an environment upon the evaluation and an environment for evaluating the second image information,
the setting section setting an evaluation condition for evaluating the second image information based on the image evaluation information obtained by the conversion by the conversion section.

6. The information processing apparatus according to claim 1, wherein the image evaluation information is information for evaluating a facial expression of the person specified by the personal identification information.

7. The information processing apparatus according to claim 1, wherein the image evaluation information is information for evaluating a composition associated with the person specified by the personal identification information.

8. The information processing apparatus according to claim 1, wherein the image evaluation information is information for evaluating an interest degree in displayed content of the person specified by the personal identification information.

9. An information processing method, comprising:
acquiring personal identification information for identifying a person relating to first image information and image evaluation information produced by evaluating the first image information in accordance with an image of a main imaging object detected based on the first image information; and
setting an evaluation condition for evaluating second image information based on the personal identification information and the image evaluation information.

10. A program for causing a computer to function as:
acquisition means for acquiring personal identification information for identifying a person relating to first image information and image evaluation information produced by evaluating the first image information in accordance with an image of a main imaging object detected based on the first image information; and
setting means for setting an evaluation condition for evaluating second image information based on the personal identification information and the image evaluation information.

11. An information processing apparatus, comprising:
an evaluation section configured to evaluate second image information based on an evaluation condition; and
a processing section configured to be controlled based on a result of the evaluation;
the evaluation condition being set based on personal identification information for identifying a person relating to first image information and image evaluation information produced by evaluating the first image information in accordance with an image of a main imaging object detected based on the first image information.

12. The information processing apparatus according to claim 11, wherein
the processing section is an imaging section,
the second image information is obtained by the imaging section, and
a shutter timing of the imaging section is controlled based on a result of the evaluation.

13. The information processing apparatus according to claim 12, wherein the image evaluation information is information for evaluating a facial expression of the person specified by the personal identification information.

14. The information processing apparatus according to claim 12, wherein the image evaluation information is information for evaluating a composition associated with the person specified by the personal identification information.

15. The information processing apparatus according to claim 11, wherein
the processing section is a display section,
the second image information is image information of displayed content which can be displayed on the display section, and
display of recommended content on the display section is controlled based on a result of the evaluation.

16. An information processing method, comprising:
evaluating second image information based on an evaluation condition; and
controlling a processing section based on a result of the evaluation;
the evaluation condition being set based on personal identification information for identifying a person relating to first image information and image evaluation information produced by evaluating the first image information in accordance with an image of a main imaging object detected based on the first image information.

17. A program for causing a computer to function as:
evaluation means for evaluating second image information based on an evaluation condition; and
processing means for being controlled based on a result of the evaluation;
the evaluation condition being set based on personal identification information for identifying a person relating to first image information and image evaluation information produced by evaluating the first image information in accordance with an image of a main imaging object detected based on the first image information.

18. An information processing apparatus, comprising:
an acquisition section configured to acquire personal identification information for identifying a person relating to first sound information and sound evaluation information produced by evaluating the first sound information; and
a setting section configured to set an evaluation condition for evaluating second sound information based on the personal identification information and the sound evaluation information.

19. An information processing apparatus, comprising:
an evaluation section configured to evaluate second sound information based on an evaluation condition; and
a processing section configured to be controlled based on a result of the evaluation;
the evaluation condition being set based on personal identification information for identifying a person relating to first sound information and sound evaluation information produced by evaluating the first sound information.
